(19) United States
(12) Patent Application Publication
(10) Pub. No.: US 2024/0312130 A1
(43) Pub. Date: Sep. 19, 2024

(54) SYSTEMS, APPARATUS, ARTICLES OF MANUFACTURE, AND METHODS FOR LOCATION-AWARE VIRTUAL REALITY

(71) Applicant: Intel Corporation, Santa Clara, CA (US)

(72) Inventors: Stephen PALERMO, Chandler, AZ (US); Bhupesh AGRAWAL, Hillsboro, OR (US); Valerie PARKER, Portland, OR (US)

(21) Appl. No.: 18/571,146

(22) PCT Filed: Jan. 20, 2023
(86) PCT No.: PCT/US2023/011265

§ 371 Date: Dec. 15, 2023

Related U.S. Application Data
(60) Provisional application No. 63/301,325, filed on Jan. 20, 2022.

(51) Int. Cl. G06T 17/00; H04N 21/2187

(52) U.S. Cl. CPC G06T 17/00; H04N 21/2187

(57) ABSTRACT

Methods, apparatus, systems, and articles of manufacture are disclosed for location-aware virtual reality (VR). An example apparatus disclosed herein is to determine a first location of a first VR device and a second location of a second VR device. The disclosed example apparatus is to identify a preset guardian boundary corresponding to a VR live stream based on at least one of first credentials associated with the first VR device or second credentials associated with the second VR device. Additionally, the disclosed example apparatus is to, after a determination that the first location and the second location satisfy the preset guardian boundary, at least one of execute or instantiate an instance of a VR live stream application associated with the VR live steam based on the first location and the second location, the first VR device and the second VR device to be associated with the VR live stream application.

### RELATED APPLICATION

This patent claims the benefit of U.S. Provisional Patent Application No. 63/301,325, which was filed on Jan. 20, 2022. U.S. Provisional Patent Application No. 63/301,325 is hereby incorporated herein by reference in its entirety. Priority to U.S. Provisional Patent Application No. 63/301,325 is hereby claimed.

### FIELD OF THE DISCLOSURE

This disclosure relates generally to virtual reality and, more particularly, to systems, apparatus, articles of manufacture, and methods for location-aware virtual reality.

### BACKGROUND

The metaverse is a network of three-dimensional (3D) virtual worlds focused on social connection between users. The technologies that compose the metaverse may include augmented reality (AR) and virtual reality (VR). AR in the metaverse may be characterized by the combination of aspects of the digital and physical worlds. VR in the metaverse may be characterized by persistent virtual worlds that continue to exist even when a user is not accessing the metaverse. AR and/or VR may be realized and/or otherwise effectuated by AR and/or VR devices, such as headsets (e.g., head-mounted devices or displays), glasses (e.g., smart glasses), watches (e.g., smart watches), or any other type of wearable device.

### BRIEF DESCRIPTION OF THE DRAWINGS

FIG. 1 is an illustration of an example location and/or proximity-aware live casting system.

FIG. 2 is an illustration of an example multi-core computing environment including an example multi-core computing system that may implement augmented reality and/or virtual reality live-stream events.

FIG. 3 is an illustration of an example system for virtual reality live casting.

FIG. 4 is an illustration of another example system for virtual reality live casting.

FIG. 5 is an illustration of example location detection of a virtual reality device.

FIG. 6 is an illustration of example multi-tier location authorization based on custom local guardian boundaries.

FIG. 7 is an illustration of an example implementation of a virtual reality cross session.

FIG. 8 is a block diagram of example virtual reality live stream management circuitry to implement examples disclosed herein.

FIG. 9 illustrates an overview of an example edge cloud configuration for edge computing that may implement the examples disclosed herein.

FIG. 10 illustrates operational layers among example endpoints, an example edge cloud, and example cloud computing environments that may implement the examples disclosed herein.

FIG. 11 illustrates an example approach for networking and services in an edge computing system that may implement the examples disclosed herein.

FIG. 12 depicts an example edge computing system for providing edge services and applications to multi-stakeholder entities, as distributed among one or more client compute platforms, one or more edge gateway platforms, one or more edge aggregation platforms, one or more core data centers, and a global network cloud, as distributed across layers of the edge computing system.

FIG. 13 illustrates a drawing of a cloud computing network, or cloud, in communication with a number of Internet of Things (IoT) devices, according to an example.

FIG. 14 illustrates network connectivity in non-terrestrial (satellite) and terrestrial (mobile cellular network) settings, according to an example.

FIG. 15 is a flowchart representative of example machine-readable instructions and/or example operations that may be executed by example processor circuitry to implement an example cloud server, an example edge server, and/or the example virtual reality live stream management circuitry of FIG. 8 to at least one of execute or instantiate an instance of a virtual reality live stream application.

FIG. 16 is a flowchart representative of example machine-readable instructions and/or example operations that may be executed by example processor circuitry to implement an example cloud server, an example edge server, and/or the example virtual reality live stream management circuitry of FIG. 8 to instantiate hardware and/or software for virtual reality live streaming.

FIG. 17 is a flowchart representative of example machine-readable instructions and/or example operations that may be executed by example processor circuitry to implement an example cloud server, an example edge server, and/or the example virtual reality live stream management circuitry of FIG. 8 to effectuate multi-tier location authorization for virtual reality live streaming.

FIG. 18 is a flowchart representative of example machine-readable instructions and/or example operations that may be executed by example processor circuitry to implement an example cloud server, an example edge server, and/or the example virtual reality live stream management circuitry of FIG. 8 to effectuate access to a virtual reality live stream event.

FIG. 19 is a flowchart representative of example machine-readable instructions and/or example operations that may be executed by example processor circuitry to implement an example cloud server, an example edge server, and/or the example virtual reality live stream management circuitry of FIG. 8 to initiate a virtual reality live stream event.

FIG. 20 is a flowchart representative of example machine-readable instructions and/or example operations that may be executed by example processor circuitry to implement an example cloud server, an example edge server, and/or the example virtual reality live stream management circuitry of FIG. 8 to validate tokens from invitees.

FIG. 21 illustrates a block diagram for an example IoT processing system architecture upon which any one or more of the techniques (e.g., operations, processes, methods, and methodologies) discussed herein may be performed, according to an example.

FIG. 22 is a block diagram of an example processing platform including processor circuitry structured to execute the example machine-readable instructions and/or the example operations of FIGS. 15, 16, 17, 18, 19, and/or 20 to implement a cloud server, an edge server, and/or the virtual reality live stream management circuitry of FIG. 8.

FIG. 23 is a block diagram of an example implementation of the processor circuitry of FIGS. 21 and/or 22.

FIG. 24 is a block diagram of another example implementation of the processor circuitry of FIGS. 21 and/or 22.

FIG. 25 is a block diagram of an example software distribution platform (e.g., one or more servers) to distribute software (e.g., software corresponding to the example machine-readable instructions of FIGS. 15, 16, 17, 18, 19, and/or 20) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to real world conditions as will be understood by persons of ordinary skill in the art. For example, “approximately” and “about” may indicate such dimensions may be within a tolerance range of +/−10% unless otherwise specified in the below description and/or unless otherwise specified by a service level agreement (SLA) and/or other agreement between a user and a service provider. As used herein “substantially real time” and “substantially real-time” refer to occurrence in a near instantaneous manner recognizing there may be real-world delays for computing time, transmission, etc. Thus, unless otherwise specified, “substantially real time” and “substantially real-time” refer to being within a 1-second time frame of real time.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

The metaverse is a network of three-dimensional (3D) virtual worlds focused in some examples on social connection between users (e.g., human users, users implemented by software, machine users, automated users, etc.). The technologies that compose the metaverse can include augmented reality (AR) and virtual reality (VR). AR in the metaverse may be characterized by the combination of aspects of the digital and physical worlds. VR in the metaverse may be characterized by persistent virtual worlds that continue to exist even when a user is not accessing the metaverse. AR and/or VR may be realized and/or otherwise effectuated by AR and/or VR devices, such as headsets (e.g., head-mounted devices or displays), glasses (e.g., smart glasses), watches (e.g., smart watches), or any other type of wearable device. AR and/or VR may also be realized by sensors external to an AR and/or VR device, such as a camera, a light detection and ranging (LIDAR) system, a radio detection and ranging (RADAR) system, a microphone, a speaker, etc., that may be in the same environment as a user wearing the AR and/or VR device and are operated to monitor the user and effectuate the AR and/or VR experience of the user.

As metaverse VR casting (e.g., VR live casting) evolves beyond gaming applications into enterprise applications, the need to authenticate and authorize clients (e.g., client devices, client applications, etc.) to participate will increase, especially within private networks and/or private events. Typical authentication and/or authorization of clients may include security key exchanges or other attestation type of techniques. Private network, event, and/or enterprise casting, especially live casting, has the added complexities of handling a predetermined casting guardian boundary (CCGB), but also localized client guardian boundary (LCGB) conditions that are close in proximity For example, during a live casting, clients may move in and out of guardian boundaries and rely on different wireless data connectivity technologies including fifth or sixth generation cellular (i.e., 5G or 6G), Wireless Fidelity (Wi-Fi), and/or low-earth orbit (LEO) satellite. For example, a CCGB and/or a LCGB can be a virtual boundary or a virtualized boundary associated with an AR/VR device. For example, a CCGB may correspond to a virtual boundary representative of a geographic area (e.g., a neighborhood, a town, a city, a county, a state, a province, a region, a country, etc.) to which a live cast is to be streamed. Additionally, for example, a LCGB may correspond to a virtual boundary set (e.g., preset) by a user of the AR/VR device that is representative of a geographic area different than (e.g., smaller than, included in, overlapping, etc.) the CCGB, such as a space within a room of a house, within which the user will operate the AR/VR device.

Live VR casting also has the added complexities of maintaining a low latency user datagram protocol (UDP) experience to render real-life images, transposing the real-life images on top of other images, and delivering the transposed images to multiple clients (e.g., 2 clients, 50 clients, 1,000 clients, etc.). While a certain amount of jitter may be acceptable for a user experience, resurrecting and reconnecting client admit after unexpected outages considerations are also a concern especially for geographically disperse events with potentially tens of thousands of clients.

Multi-spectrum, multi-modal terrestrial and non-terrestrial sensors and/or communication connection technologies may be used to continuously determine locations of clients. For example, clients may be implemented by AR and/or VR devices and/or associated firmware and/or software (e.g., applications, services, virtual machines (VMs), containers, etc.) operated, executed, and/or instantiated by users. Examples disclosed herein leverage terrestrial techniques (e.g., time-of-arrival (TOA), time-difference-of-arrival (TDOA), angle-of-arrival (AOA), round-trip time (RTT), etc., based techniques) in cellular networks and/or non-terrestrial techniques (e.g., sync pulse generator (SPG), SPG, global navigation satellite system (GNSS), etc., based techniques) in satellite-based networks for AR and/or VR devices capable of different types of wireless connectivity. For example, such AR/VR devices can be cable of 5G or 6G, Wi-Fi, Bluetooth, Citizens Broadband Radio Service (CBRS), category 1 (CAT-1), category M (CAT-M), Narrowband Internet of Things (NB-IoT), etc., wireless connectivity.

In some disclosed examples, an AR/VR device can send, transmit, and/or cause transmission of sounding reference signals (SRS) and/or obtain and/or receive positioning resource signals (PRS) for location and/or positioning result calculation(s). In some examples, millimeter wave networks may use angle-based techniques whereas TDOA techniques are used for other networks. In some examples, the AR/VR device (e.g., user equipment (UE)) can have interface circuitry, such as a 5G modem, that uses 5G new radio (5gNR) radio access technology (RAT) that can connect to a 5gNR base station (e.g., a wireless base station, a wireless 5gNR base station, etc.), which is also called a gNB. For example, a gNB can configure the AR/VR device interface circuitry with specific parameters for a positioning SRS signal, which is different from a communication SRS signal.

In some examples, the AR/VR device becomes communicatively coupled to the gNB after a SIM card of the AR/VR device is authorized. For example, the SRS uplink data (commonly referred to as HIGH PHY or HIGH PHY data) is transmitted to the base station antennas and then forwarded to a radio access network (RAN) server. In some examples, the RAN server can repackage the SRS uplink data into a format acceptable and/or otherwise supported by a location engine and/or location management function (LMF) of the RAN server. In some examples, the LMF can select from a variety of positioning methods based on data sets available to the LMF. For example, the LMF can locate an AR/VR device based on TDOA techniques that measure the relative TOA from the AR/VR device SRS data from different base stations and even different antennas on the same base station (e.g., massive multiple-in, multiple-out (mMIMO)). Time synchronization between nodes is needed for TDOA whereas angle-based techniques (e.g., AOA) measure angles (e.g., x-, y-, and/or z-angles) of arriving SRS data from the AR/VR device. The LMF can compare the angles to a reference ground known direction to determine the AOA. In some examples, the LMF can combine position techniques (e.g., combination of RTT and TDOA techniques) to produce improved results such as using RTT (e.g., round-trip-time data) that can determine the radius of the AR/VR device by comparing the TDOA of another reference signal (e.g., a positioning reference signal (PRS)) that is received and reported by the AR/VR interface circuitry.

Examples disclosed herein address guardian boundaries by using network-based positioning and proximity for admittance to VR live stream events as well as local hazard avoidance (e.g., a user colliding with furniture or other physical objects in a physical environment) using cellular uplink time-difference-of-arrival (UL-TDOA), downlink time-difference-of-arrival, (DL-TDOA), uplink angle-of-arrival (UL-AOA), downlink angle-of-arrival (DL-AOA), round-trip time (RTT), etc., techniques. Examples disclosed herein address event resurrection using ephemeral virtual resources (e.g., VMs, containers, etc.) per client that each may have self-contained location management functions as well as coherent, persistent memory for fast re-admits to the VR live stream events. Examples disclosed herein reduce latencies between AR/VR devices (e.g., headsets, wearable devices, etc.) and edge/multi-access edge computing (MEC) and/or cloud systems by using a location result of a client on the AR/VR devices. For example, the location result can trigger co-located VM/container AR/VR instances that are co-located to the client for reduced latencies. Advantageously, examples disclosed herein can utilize a location determination technique based on at least one of an operator configuration at a time of the live-cast stream, an availability of edge and/or cloud resources, a bandwidth of edge and/or cloud resources, network access, a type of spectrum (e.g., mmWave, 5G, satellite, Wi-Fi, etc.) utilized for the live-cast stream, etc., and/or any combination(s) thereof.

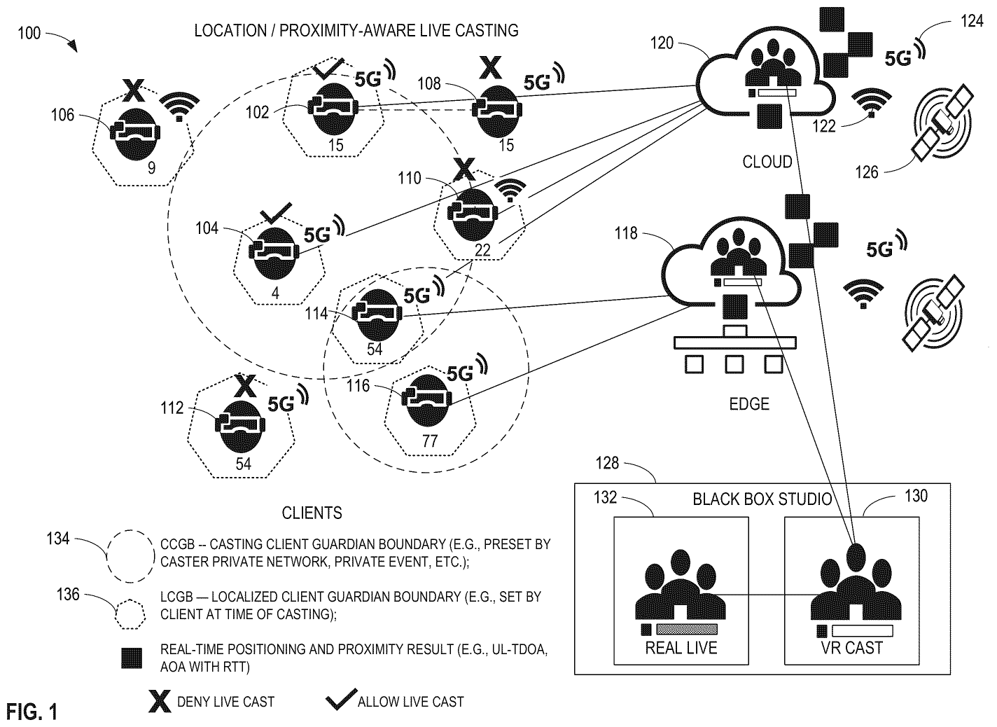

FIG. 1 is an illustration of an example location and/or proximity-aware live casting system 100. The system 100 includes example clients 102, 104, 106, 108, 110, 112, 114, 116, an example edge network 118, an example cloud network 120, and an example black box studio 128. In this example, the clients 102, 104, 106, 108, 110, 112, 114, 116 are augmented reality (AR) and/or virtual reality (VR) devices such as a headset (e.g., an AR/VR headset). Additionally and/or alternatively, one(s) of the clients 102, 104, 106, 108, 110, 112, 114, 116 may be any other type of device. In some examples, the clients 102, 104, 106, 108, 110, 112, 114, 116 may be implemented by application(s) (e.g., client application(s)). In some examples, the application(s) may be instantiated, created, generated, and/or otherwise implemented by virtual resource(s) such as VM(s), container(s), etc., and/or any combination(s) thereof.

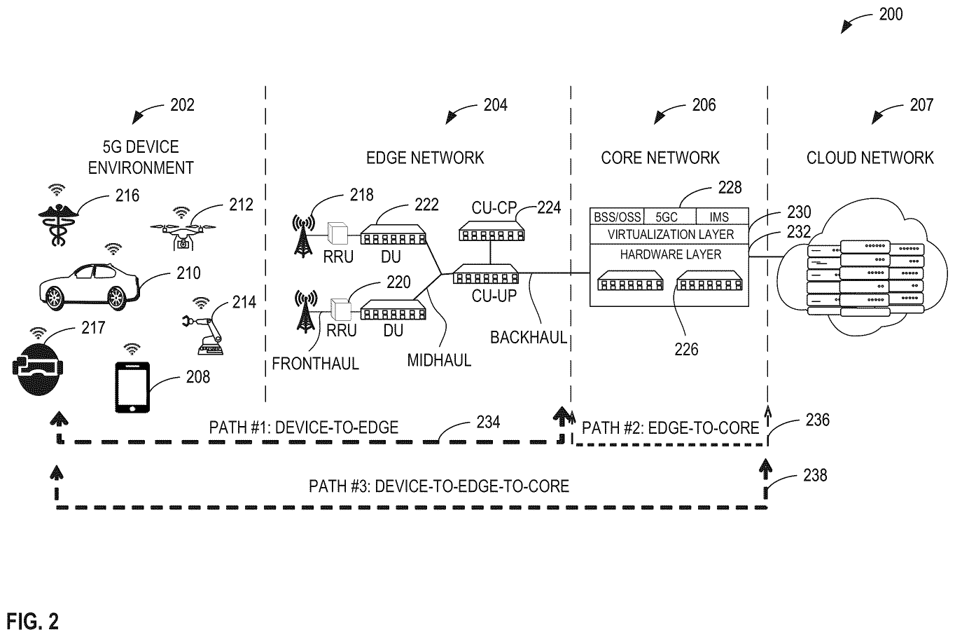

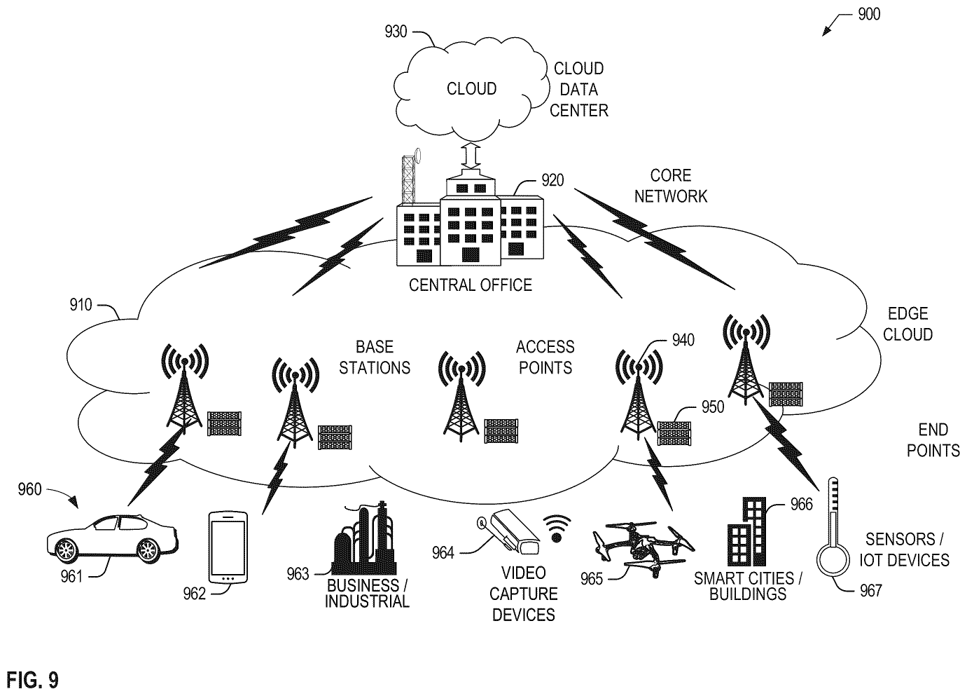

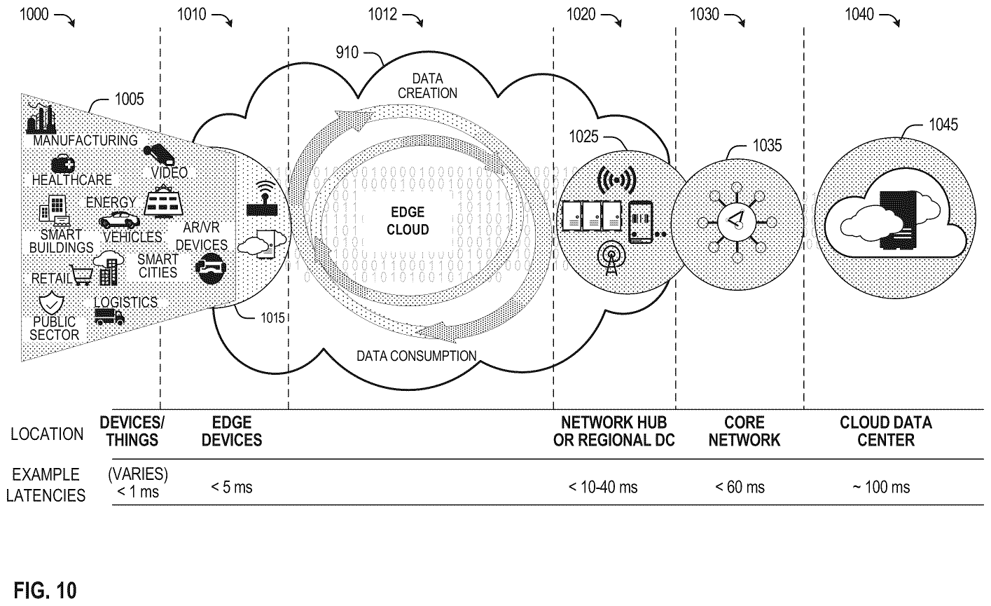

In the illustrated example, the edge network 118 may be implemented using one or more edge servers. For example, the edge network 118 may be implemented by the edge network 204 of FIG. 2, the edge cloud 910 of FIG. 9, etc. In this example, the cloud network 120 may be implemented using one or more cloud servers. For example, the cloud network 120 may be implemented by the cloud network 207 of FIG. 2, the cloud data center 930 of FIG. 9, the cloud data center 1045 of FIG. 10, etc. In example operation, the edge network 118 and/or the cloud network 120 may be in communication with one(s) of the clients 102, 104, 106, 108, 110, 112, 114, 116 via wireless technology such as Wi-Fi 122, 5G cellular 124 (or 6G cellular), or satellite 126 (e.g., low-earth orbit (LEO) satellite, geostationary (GEO) satellite, etc.). Additionally and/or alternatively, the edge network 118 and/or the cloud network 120 may be in communication with one(s) of the clients 102, 104, 106, 108, 110, 112, 114, 116 via any other wired and/or wireless communication and/or connectivity technology.

In the illustrated example, the black box studio 128 can be implemented using one or more servers to carry out an example VR cast 130 of an example real-live event 132. For example, the VR cast 130 can be a VR live stream that can be accessed by one(s) of the clients 102, 104, 106, 108, 110, 112, 114, 116. For example, the VR cast 130 can be and/or can implement a VR live-stream application that can be executed, instantiated, and/or rendered by one(s) of the clients 102, 104, 106, 108, 110, 112, 114, 116. In some examples, the VR cast 130 can implement the metaverse and/or portion(s) thereof. In some examples, the VR cast 130 can be a simulation, a VR rendering, etc., of the real-live event 132. For example, the real-live event 132 can be an entertainment event (e.g., a concert, a sporting event, etc.), a competition (e.g., a sporting event, a video game, etc.), a training event (e.g., a surgery to train surgical residents, a restaurant to train chefs, a laboratory to train students, etc.), a classroom (e.g., a trade school classroom, an elementary school classroom, a grade school classroom, a high school classroom, a college classroom, etc.), etc.

In example operation, the black box studio 128 generates the VR cast 130 and distributes (e.g., causes distribution and/or transmission of) the VR cast 130 to one(s) of the clients 102, 104, 106, 108, 110, 112, 114, 116 by way of at least one of the edge network 118 or the cloud network 120. In some examples, the edge network 118 and/or the cloud network 120 can authorize one(s) of the clients 102, 104, 106, 108, 110, 112, 114, 116 to interact with, engage with, and/or otherwise access the VR cast 130 based on a location of the one(s) of the clients 102, 104, 106, 108, 110, 112, 114, 116.

In some examples, the edge network 118 and/or the cloud network 120 can authorize the first client 102 and the second client 104 to obtain access to the VR cast 130 based on location data of the first client 102 and the second client 104. For example, the first client 102 can compile and/or package location data of the first client 102 and provide the location data to the cloud network 120 via a 5G cellular communication channel or link (e.g., a 5G cellular data communication or data link). In some examples, the location data is real-time positioning and proximity data, such as uplink time-difference-of-arrival (UL-TDOA) data, angle-of-arrival (AOA) with round-trip time (RTT) data, etc., and/or any combination(s) thereof. In some examples, the cloud network 120 can determine the location data (e.g., the UL-TDOA data, the AOA with RTT data, etc.) based on a synchronization of clocks (e.g., clock circuitry) maintained by the first client 102 and the cloud network 120. The cloud network 120 can determine that the location data is within an example casting client guardian boundary (CCGB) 134 by comparing portion(s) of the location data to location data associated with the CCGB 134 and determining that the location data is within the CCGB based on the comparison. The cloud network 120 can determine that the third client 106, the fourth client 108, the fifth client 110, and the sixth client 112 are not authorized to access the VR cast 130 because those clients have location data outside of and/or not included in the CCGB 134.

In the illustrated example, a data publisher that owns, operates, and/or otherwise manages the black box studio 128 can be referred to as a caster (e.g., an AR/VR caster). In some examples, the data publisher sets (e.g., presets) the CCGB 134 prior to and/or upon initialization of the VR cast 130. For example, a private network of the caster (e.g., the data publisher) can be used to preset the CCGB 134 in advance of the VR cast 130. In the illustrated example, the first client 102 and the second client 104 can set and/or configure an example localized client guardian boundary (LCGB) 136 at the time of accessing the VR cast 130. For example, a first user associated with the first client 102 can configure and/or generate the LCGB 136 to comport with an environment or physical surroundings of the first user.

Advantageously, the edge network 118 and the cloud network 120 can be used to achieve different levels or tiers of location accuracy. For example, the edge network 118 can be implemented using a plurality of cellular towers and corresponding cellular antennas. In some examples, the edge network 118 can receive location data from the second client 104 at a plurality of cellular antennas to output precise location data. For example, the precise location data can correspond to location data with relatively high accuracy and low latency with respect to location data provided to the cloud network 120. In some examples, the precise location data can include UL-TDOA and/or AOA data with RTT data. In some examples, the second client 104 can provide location data to the cloud network 120 that has relatively lower accuracy and higher latency with respect to the location data provided to the edge network 118 because the location data does not include AOA data with RTT data due to the uplink from the second client 104 to the cloud network 120.

FIG. 2 is an illustration of an example multi-core computing environment 200 that may implement AR/VR live-stream events. The multi-core computing environment 200 includes an example device environment 202, an example edge network 204, an example core network 206, and an example cloud network 207. In this example, the device environment 202 is a 5G device environment that facilitates the execution of computing tasks using a wireless network, such as a wireless network based on 5G (e.g., a 5G cellular network) or 6G (e.g., a 6G cellular network).

The device environment 202 includes example devices (e.g., computing devices) 208, 210, 212, 214, 216, 217. The devices 208, 210, 212, 214, 216, 217 include a first example device 208, a second example device 210, a third example device 212, a fourth example device 214, a fifth example device 216, and a sixth example device 217. The first device 208 is a 5G Internet-enabled smartphone. Alternatively, the first device 208 may be a tablet computer, an Internet-enabled laptop, an AR/VR device, etc. The second device 210 is a vehicle (e.g., a combustion engine vehicle, an electric vehicle, a hybrid-electric vehicle, etc.). For example, the second device 210 can be an electronic control unit or other hardware included the vehicle, which, in some examples, can be a self-driving, autonomous, or computer-assisted driving vehicle. In some examples, the second device 210 can be an AR/VR device operated by a person in the vehicle.

The third device 212 is an aerial vehicle. For example, the third device 212 can be a processor or other type of hardware included in an unmanned aerial vehicle (UAV) (e.g., an autonomous UAV, a human or user-controlled UAV, etc.), such as a drone. In some examples, the third device 212 can be an AR/VR device operated by a person in the aerial vehicle. For example, a pilot of the aerial vehicle can be wearing an AR/VR enabled heads-up display (HUD) or other wearable device (e.g., an AR/VR headset of any kind). The fourth device 214 is a robot. For example, the fourth device 214 can be a collaborative robot or other type of machinery used in assembly, lifting, manufacturing, etc., types of tasks. In some examples, the fourth device 214 can be an AR/VR device operated by a human or person (e.g., a human person) to control the collaborative robot or other type of machinery.

The fifth device 216 is a healthcare associated device. For example, the fifth device 216 can be a computer server that stores and/or processes health care records. In other examples, the fifth device 216 can be a medical device, such as an infusion pump, magnetic resonance imaging (MRI) machine, a surgical robot, a vital sign monitoring device, etc. For example, the fifth device 216 can be an AR/VR device worn by a medical professional to control a surgical robot (e.g., to participate in an actual surgery or a virtual surgery for medical training purposes). The sixth device 217 is an AR/VR device such as a head-mounted display (HMD) or the like.

In some examples, one or more of the devices 208, 210, 212, 214, 216, 217 may be a different type of computing device, such as a server, a personal computer, a workstation, a self-learning machine (e.g., a neural network), a mobile device (e.g., a cell phone, a smart phone, a tablet such as an iPad™), a personal digital assistant (PDA), an Internet appliance, a digital versatile disk (DVD) player, a compact disk (CD) player, a digital video recorder, a Blu-ray player, a gaming console, a personal video recorder, a set top box, a headset or other wearable device, or any other type of computing device. In some examples, there may be fewer or more devices than depicted in FIG. 2.

The devices 208, 210, 212, 214, 216, 217 and/or, more generally, the device environment 202, are in communication with the edge network 204 via first example networks 218. The first networks 218 are cellular networks (e.g., 5G cellular networks). For example, the first networks 218 can be implemented by and/or otherwise facilitated by antennas, radio towers, etc., and/or a combination thereof. Additionally or alternatively, one or more of the first networks 218 may be a Wireless Fidelity (Wi-Fi) network, an Ethernet connection, a digital subscriber line (DSL) connection, a telephone line connection, a coaxial cable system, a satellite system, a line-of-site (LOS) wireless system, a beyond-line-of-site (BLOS) wireless system, a cellular telephone system, etc., and/or a combination thereof.

In the illustrated example of FIG. 2, the edge network 204 includes the first networks 218, example remote radio units (RRUs) 220, example distributed units (DUs) 222, and example centralized units (CUs) 224. In this example, the DUs 222 and/or the CUs 224 are multi-core computing systems. For example, one or more of the DUs 222 and the CUs 224 can include a plurality of processors that each include a plurality of cores (e.g., processor cores). In some examples, the DUs 222 and/or the CUs 224 are edge servers (e.g., 5G edge servers), such as multi-core edge servers, that can effectuate the distribution of data flows (e.g., communication flows, packet flows, a flow of one or more data packets, etc.) through the edge network 204 to a different destination (e.g., the 5G device environment 202, the core network 206, etc.). In some examples, fewer or more of the first networks 218, the RRUs 220, the DUs 222, and/or the CUs 224 may be used than depicted in FIG. 2.

In this example, the RRUs 220 are radio transceivers (e.g., remote radio transceivers, also referred to as remote radio heads (RRHs)) in a radio base station. For example, the RRUs 220 are hardware that can include radiofrequency (RF) circuitry, analog-to-digital/digital-to-analog converters, and/or up/down power converters that connects to a network of an operator (e.g., a cellular operator or provider). In some examples, the RRUs 220 can convert a digital signal to an RF signal, amplify the RF signal to a desired power level, and radiate the amplified RF signal in air via an antenna. In some examples, the RRUs 220 can receive a desired band of signal from the air via the antenna and amplify the received signal. The RRUs 220 are termed as remote because the RRUs 220 are typically installed on a mast-top, or tower-top location that is physically distant from base station hardware, which is often mounted in an indoor rack-mounted location or installation.

In the illustrated example of FIG. 2, the RRUs 220 are coupled and/or otherwise in communication with a respective one of the DUs 222. In this example, the DUs 222 include hardware that implement real time Layer 1 (L1) scheduling functions (e.g., physical layer control) and/or Layer 2 (L2) scheduling functions (e.g., radio link control (RLC), medium access control (MAC), etc.). In this example, the CU 224 includes hardware that implements Layer 3 scheduling functions, such as packet data convergence control (PDCP) and/or radio resource control (RRC) functions. In this example, a first one of the CUs 224 is a centralized unit control plane (CU-CP) and a second one of the CUs 224 is a centralized unit user plane (CU-UP).

In some examples, the L1 data can correspond to L1 data of an Open Systems Interconnection (OSI) model. In some examples, the L1 data of an OSI model can correspond to the physical layer of the OSI model, L2 data of the OSI model can correspond to the data link layer of the OSI model, L3 data of the OSI model can correspond to the network layer of the OSI model, and so forth. In some examples, the L1 data can correspond to the transmitted raw bit stream over a physical medium (e.g., a wired line physical structure such as coax or fiber, an antenna, a receiver, a transmitter, a transceiver, etc.). In some examples, the L1 data can be implemented by signals, binary transmission, etc. In some examples, the L2 data can correspond to physical addressing of the data, which may include Ethernet data, MAC addresses, logical link control (LLC) data, etc. In some examples, the L3 data can correspond to the functional and procedural means of transferring variable-length data sequences from a source to a destination host via one or more networks, while maintaining the quality of service functions. For example, L3 data can correspond to PDCP and/or RRC functions.

In the example of FIG. 2, at least one of one or more of the DUs 222 and/or one or more of the CUs 224 implement a virtualized radio access network (vRAN). For example, one or more of the DUs 222 and/or one or more of the CUs 224 can execute, run, and/or otherwise implement virtualized baseband functions on vendor-agnostic hardware (e.g., commodity server hardware) based on the principles of Network Functions Virtualization (NFV). NFV is a network architecture concept that uses the technologies of infrastructure technology (IT) virtualization to virtualize entire classes of network node functions into building blocks that may be connected, or chained together, to create communication services.

In the illustrated example of FIG. 2, first connection(s) between the first networks 218 and the RRUs 220 implement(s) the fronthaul of the edge network 204. Second connection(s) between the DUs 222 and the CUs 224 implement(s) the midhaul of the edge network 204. Third connection(s) between the CUs 224 and the core network 206 implement(s) the backhaul of the edge network 204.

In the illustrated example of FIG. 2, the core network 206 includes example core devices 226. In this example, the core devices 226 are multi-core computing systems. For example, one or more of the core devices 226 can include a plurality of processors that each include a plurality of cores (e.g., processor cores). For example, one or more of the core devices 226 can be servers (e.g., physical servers, virtual servers, etc., and/or a combination thereof). In some examples, one or more of the core devices 226 can be implemented with the same hardware as the DUs 222, the CUs 224, etc. In some examples, one or more of the core devices 226 may be any other type of computing device.

The core network 206 is implemented by different logical layers including an example application layer 228, an example virtualization layer 230, and an example hardware layer 232. In some examples, the core devices 226 are core servers. In some examples, the application layer 228 or portion(s) thereof, the virtualization layer 230 or portion(s) thereof, or the hardware layer 232 or portion(s) thereof implement a core server. For example, a core server can be implemented by the application layer 228, the virtualization layer 230, and/or the hardware layer 232 associated with a first one of the core devices 226, a second one of the cores devices 226, etc., and/or a combination thereof. In this example, the application layer 228 can implement business support systems (BSS), operations supports systems (OSS), 5G core (5GC) systems, Internet Protocol multimedia core network subsystems (IMS), etc., in connection with operation of a telecommunications network, such as the multi-core computing environment 200 of FIG. 2. In this example, the virtualization layer 230 can be representative of virtualizations of the physical hardware resources of the core devices 226, such as virtualizations of processing resources (e.g., central processor units (CPUs), graphics processor units (GPUs), etc.), memory resources (e.g., non-volatile memory, volatile memory, etc.), storage resources (e.g., hard-disk drives, solid-state disk drives, etc.), network resources (e.g., network interface cards (NICs), gateways, routers, etc.)), etc. In this example, the virtualization layer 230 can control and/or otherwise manage the virtualizations of the physical hardware resources with a hypervisor that can run one or more virtual machines (VMs), containers, etc., built and/or otherwise composed of the virtualizations of the physical hardware resources.

The core network 206 is in communication with the cloud network 207. In this example, the cloud network 207 can be a private or public cloud services provider. For example, the cloud network 207 can be implemented using virtual and/or physical hardware, software, and/or firmware resources to execute computing tasks.

In the illustrated example of FIG. 2, multiple example communication paths 234, 236, 238 are depicted including a first example communication path 234, a second example communication path 236, and a third example communication path 238. In this example, the first communication path 234 is a device-to-edge communication path that corresponds to communication between one(s) of the devices 208, 210, 212, 214, 216, 217 of the 5G device environment 202 and one(s) of the first networks 218, RRUs 220, DUs 222, and/or CUs 224 of the edge network 204. The second communication path 236 is an edge-to-core communication path that corresponds to communication between one(s) of the first networks 218, RRUs 220, DUs 222, and/or CUs 224 of the edge network 204 and one(s) of the core devices 226 of the core network 206. The third communication path 238 is a device-to-edge-to-core communication path that corresponds to communication between one(s) of the devices 208, 210, 212, 214, 216, 217 and one(s) of the core devices 226 via one(s) of the first networks 218, RRUs 220, DUs 222, and/or CUs 224 of the edge network 204.

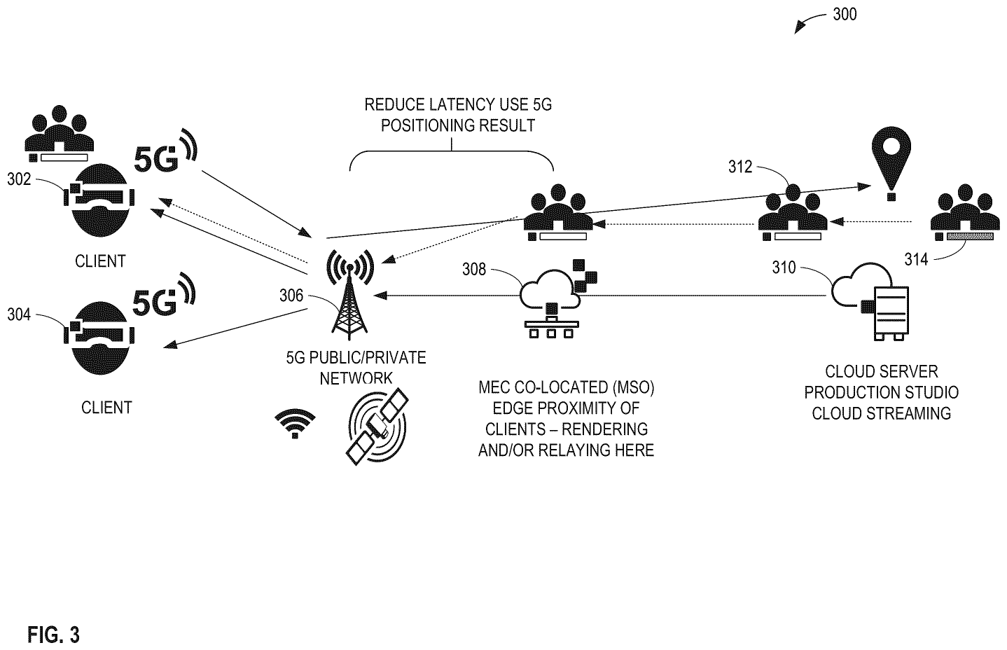

FIG. 3 is an illustration of an example system 300 for VR live casting. The system 300 includes example clients 302, 304, an example cellular network 306, an example edge/multi-access edge computing (MEC) network 308, and an example cloud network 310. In example operation, the cloud network 310 may be implemented by a cloud server associated with a production studio (e.g., a data producer, the black box studio 128 of FIG. 1, etc.) to effectuate cloud streaming of an example VR live cast 312 (or VR live casting) of a real-live event 314. In this example, the clients 302, 304 are implemented by AR/VR devices (e.g., AR/VR headsets) and/or client applications on the AR/VR devices. The cellular network 306 of the illustrated example is a 5G public/private network. Additionally and/or alternatively, a Wi-Fi network, a satellite network (e.g., one or more LEOs, GEOs, etc.), etc., and/or any combination(s) of terrestrial network(s) and/or non-terrestrial network(s) thereof may be used in the system 300. The MEC network 308 may be implemented using one or more edge servers that are co-located with the clients 302, 304. For example, the first client 302 may be in Chicago, Illinois, United States and the one or more edge servers may be in Chicago, Illinois, United States or a surrounding area (e.g., a surrounding city, state, etc.).

In example operation, the cloud server 310 initiates and/or configures cloud-optimized hardware, software, and/or firmware of the cloud server 310 to facilitate the VR live cast 312. The cloud server 310 can instantiate location-aware virtual resources (e.g., one or more VMs, one or more containers, etc.) of the cloud server 310 to render the VR live cast 312. In example operation, the cloud server 310 can distribute, push, and/or otherwise provide purpose-built cloud instances of the VR live cast 312 on at least one of the cloud server 310 or the MEC network 308. Advantageously, the clients 302, 304 may access the purpose-built cloud instances of the VR live cast 312 on the MEC network 308 for reduced latency and/or improved performance (e.g., reduced jitter). For example, the MEC network 308 can use location data, such as 5G location data from the cellular network 306, to determine a location of the clients 302, 304 for authorization of the clients 302, 304 to access the VR live cast 312. In some examples, the MEC network 308 can determine the location of the clients 302, 304 with increased accuracy based on the 5G location data with respect to location data provided to the cloud network 310. For example, the cloud network 310 may not receive AOA location data from the cellular network 306 while the MEC network 308 can receive AOA location data from the cellular network 306.

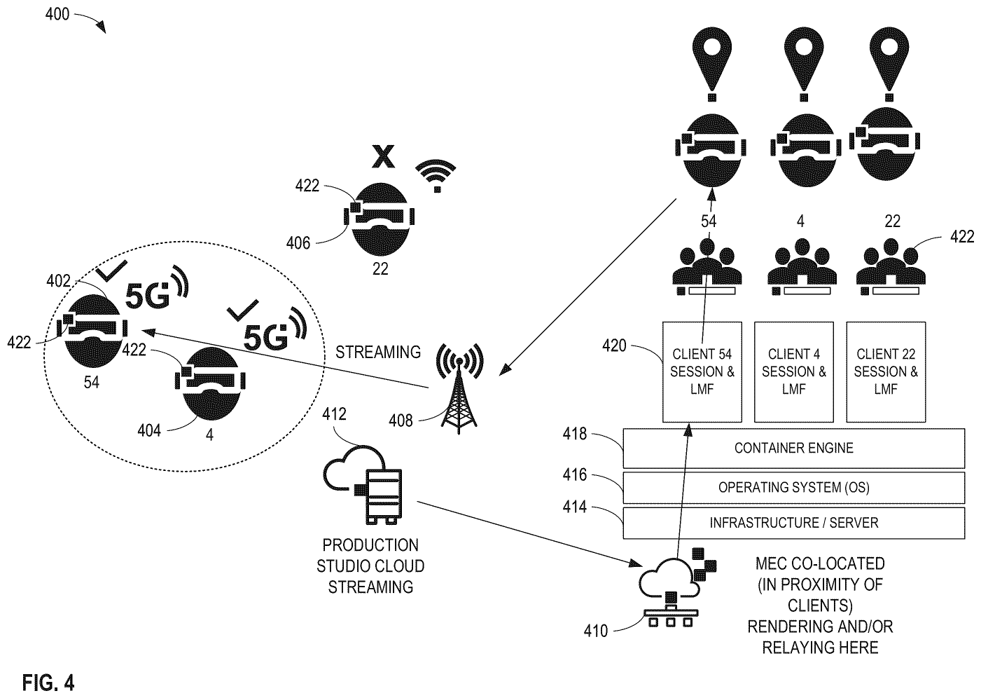

FIG. 4 is an illustration of a second example system 400 for virtual reality live casting. The system 400 includes example clients 402, 404, 406, an example cellular network 408, an example MEC network 410, and an example production studio 412. In the illustrated example, the MEC network 410 is implemented by example infrastructure 414, an example operating system (OS) 416, an example container engine 418, and an example location management function (LMF) 420 for respective ones of the clients 402, 404, 406. In some examples, the infrastructure 414 can be implemented by one or more hardware servers, which can include a plurality of hardware processors, memory, mass storage devices, interface circuitry, and the like. In some examples, the OS 416 can be implemented by software on which the container engine 418 is instantiated and/or executed. For example, the OS 416 can implement a conventional OS or a cloud hosted OS. In some examples, the container engine 418 can be implemented by a database, a repository, etc., that includes and/or stores one or more containers. For example, the container engine 418 can store a container that, when instantiated, executes the LMF 420 for the first client 402, which in this example is identified by client 54. Additionally and/or alternatively, the container engine 418 may be utilized with a VM engine to instantiate one or more VMs.

In example operation, the cloud network 410 can initiate the infrastructure 414 to render and/or relay an example VR live cast 422. In some examples, the infrastructure 414 can include cloud-optimized hardware, software, and/or firmware for the rendering and/or the relaying of the VR live cast 422. In example operation, the cloud network 410 can instantiate virtual resources (e.g., one or more containers) of the container engine 418 to render and/or relay the VR live cast 422 for respective ones of the clients 402, 404, 406. In some examples, the clients 402, 404, 406 can provide example location data 424 to the LMF 420 via the cellular tower 408 for authorization to access the VR live cast 422. In this manner, the cloud network 410 instantiates virtual resources to render and/or relay the VR live cast 422 based on as many co-located clients (e.g., “crowd sourced” clients). For example, if multiple clients are invited to a localized production (e.g., a VR live cast) of Desert Tails of Birds in Scottsdale, Arizona (e.g., the CCGB), the cloud network 410 instantiates virtual resources to render and/or relay the VR live cast 422 on one or more hardware servers of the infrastructure 414 such that the respective distances between the one or more hardware servers and the multiple invited clients (e.g., invitees) in Scottsdale, Arizona are reduced (e.g., minimized) for each invited client. For example, the cloud network 410 can instantiate virtual resources to render and/or relay the VR live cast 422 on one or more hardware servers of the infrastructure 414 that are approximately equidistant between the multiple invited clients (e.g., invitees) in Scottsdale, Arizona. In some examples, the LMF 420 can utilize the location data from the clients 402, 404, 406 to facilitate the engagement and/or placement of the clients 402, 404, 406 (e.g., a profile, persona, avatar, or other virtual representation of a user of the clients 402, 404, 406) with respect to other one(s) of the clients 402, 404, 406. In some examples, the location data can include and/or be generated based on UL-TDOA data and/or UL-AOA data with RTT data.

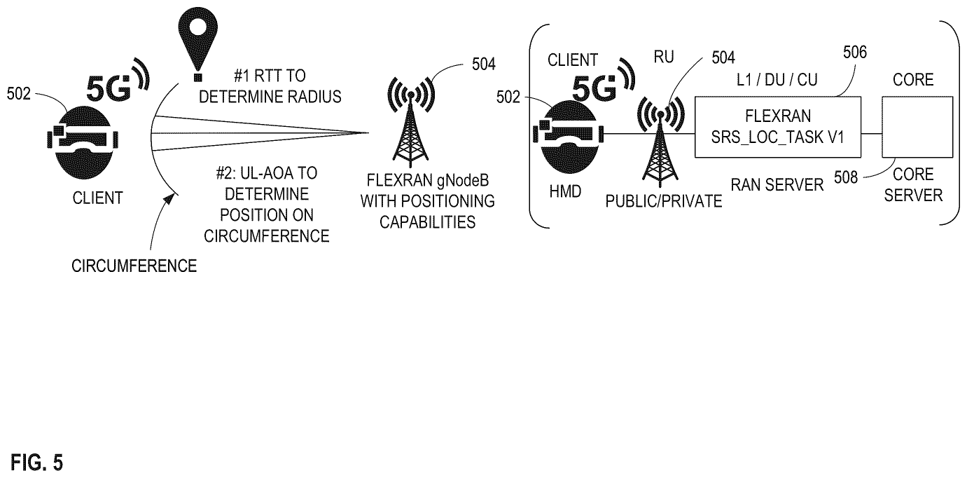

FIG. 5 is an illustration of example location detection of an example VR device 502. The VR device 502 of the illustrated example is an HMD. The VR device 502 provides location data to an example radio unit 504 via a cellular communication protocol (e.g., 5G/6G cellular). The radio unit 504 provides the location data to an example RAN server 506. For example, the RAN server 506 can be implemented by a Level 1 (L1) DU and/or CU. The RAN server 506 provides the location data to an example core server 508.

In example operation, the radio unit 504 can transmit data to the VR device 502 and the VR device 502 can transmit data back to the radio unit 504. The VR device 502 and the radio unit 504 can be time synchronized. For example, the radio unit 504 can determine a RTT of the data exchanged between the VR device 502 and the radio unit 504. In some examples, the radio unit 504 can determine UL-AOA data associated with the VR device 502. For example, the VR device 502 can transmit data, such as SRS data, to the radio unit 504. The transmitted data is UL data because it is transmitted via an UL link from the VR device 502 to the radio unit 504. The angle at which the SRS data (e.g., the RF signals that represent the SRS data) is received on antenna(s) of the radio unit 504 corresponds to the AOA data. In example operation, the radio unit 504 can provide the RTT data, the UL-AOA data, etc., to the RAN server 506. In some examples, the RAN server 506 can host, execute, and/or instantiate purpose-build cloud instances of a VR live cast and utilize the RTT data, the UL-AOA data, etc., to determine an access authorization, a placement, etc., of the VR device 502 with respect to the VR live cast. For example, the RAN server 506 can utilize the location data of the VR device 502 to determine whether the VR device 502 is authorized to enter a virtual event corresponding to the VR live cast. In some examples, the RAN server 506 can utilize the location data of the VR device 502 to determine a placement, a position, a location, etc., of the VR device 502 within a guardian boundary (e.g., a CCGB, an LCGB, etc.) associated with the VR device 502 and/or the VR live cast.

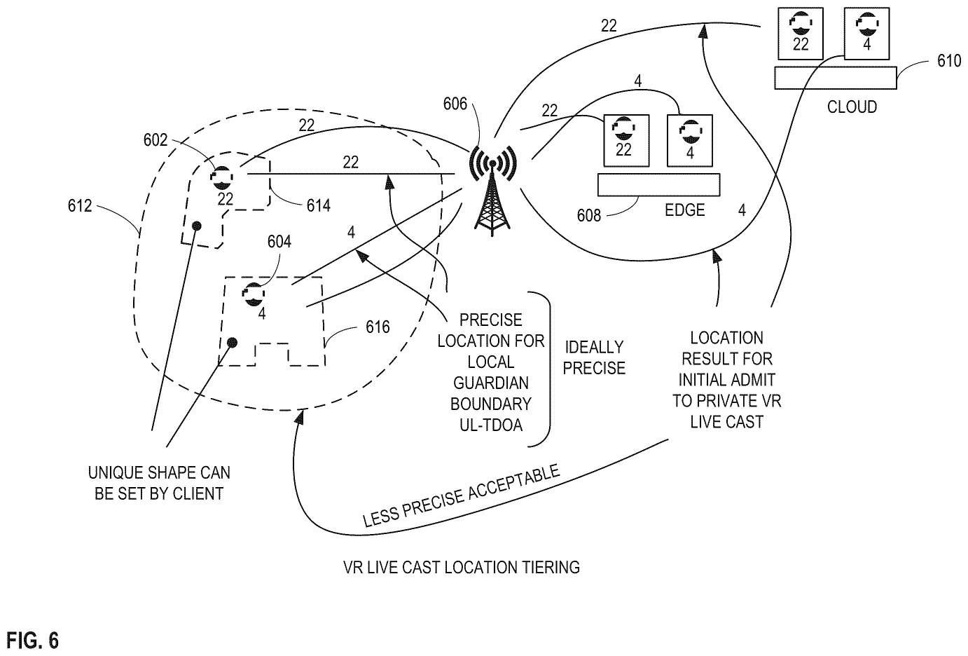

FIG. 6 is an illustration of example multi-tier location authorization based on custom local guardian boundaries. The illustrated example includes example clients 602, 604, an example cellular tower 606, an example edge server 608, and an example cloud server 610. In example operation, the edge server 608 can authorize (e.g., initially authorize) entry of the clients 602, 604 to a VR live cast (e.g., a VR live cast or casting implemented by a VR live cast application or VR live casting application). For example, the edge server 608 can receive a ticket, token, or any other type of credentials to be used to identify authorized access to the VR live cast from the clients 602, 604. The edge server 608 can receive location data associated with the clients 602, 604 from the cellular network 606. The edge server 608 can compare the credentials to the location data. For example, the edge server 608 can determine that the credentials are associated with a first location 612, such as a city, a state, a country, etc., and the location data is within and/or otherwise associated with the first location 612. In the illustrated example, the first location 612 is a CCGB, such as the CCGB 134 of FIG. 1.

In response to and/or after initially authorizing entry of the clients 602, 604 to the VR live cast based on the provided credentials and the location data, subsequent re-authorizations can be offloaded to the cloud server 610. For example, the cloud server 610 can utilize less precise location data associated with the clients 602, 604 from the cellular network 606 to periodically re-authorize the clients 602, 604 to increase the bandwidth of the edge network 608 to carry out other workloads, such as facilitating the VR live cast (e.g., executing a purpose-build cloud instance of the VR live cast).

In the illustrated example, in response to and/or after obtaining entry to the VR live cast, the clients 602, 604 can set up and/or configure example local guardian boundaries 614, 616 to improve the user experience of accessing and/or engaging with the VR live cast. For example, the first client 602 can generate a first local guardian boundary 614 with a custom or unique shape or outline based on an environment of the first client 602. For example, a user can use the first client 602 to generate the custom shape of the first local guardian boundary 614 to set up and/or configure a safe environment in which to engage with the VR live cast. In some examples, the safe environment can correspond to floor space free of obstacles or obstructions (e.g., furniture, appliances, walls, doors, etc.). Advantageously, the edge network 608 can utilize precise location data (e.g., location data with relatively high accuracy and low latency) to enforce and/or otherwise update a placement of the clients 602, 604 within their respective local guardian boundaries 614, 616. For example, the precise location data can be implemented using UL-TDOA location data, RTT data with AOA data, etc., and/or any combination(s) thereof.

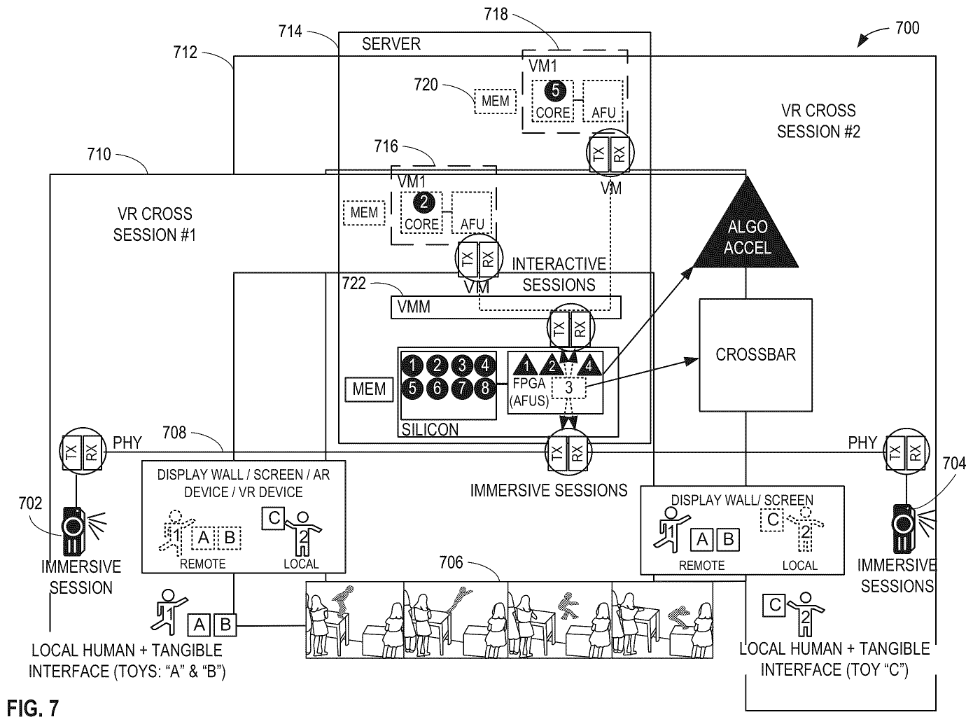

FIG. 7 is an illustration of an example implementation of an example VR cross session 700. The VR cross session 700 of the illustrated example is implemented by a first example immersive session 702 and a second example immersive session 704 for an application 706 (e.g., an AR/VR live stream application). The application 706 of the illustrated example is an AR/VR live stream application of an elementary classroom in which a first student in a first classroom in a first location can engage with a second student in a second classroom in a second location. For example, the first student and the second student can engage and/or interact with each other by wearing their own AR/VR device, such as an HMD. In some examples, the application 706 is representative of a projected or casted AR/VR device view (e.g., a projected or casted AR/VR scene or field-of-view). For example, the AR/VR live cast can be substantially simultaneously rendered to an AR/VR device and casted or projected to a wall, screen, or other surface.

In some examples, the immersive sessions 702, 704 can be implemented using other types of electronic devices, such as audio sensors (e.g., speakers, microphones, etc.), cameras, projectors, LIDAR systems, RADAR systems, etc., and the like. For example, a camera in the first classroom can capture an image; provide the image to a projector in the second classroom via an example network 708; and the projector can display the image in the second classroom to enable the second student to carry out an action (e.g., a part of a lesson plan or learning activity).

The first immersive session 702 can correspond to a first VR cross session 710 and the second immersive session 704 can correspond to a second VR cross session 712. Additionally or alternatively, the first immersive session 702 can correspond to a first AR cross session and the second immersive session 704 can correspond to a second VR cross session. In example operation, an example server 714, which can be implemented by an edge or cloud server, can implement the VR cross sessions 710, 712. For example, the server 714 can instantiate first example virtual resources 716 to implement the first VR cross session 710 and second example virtual resources 718 to implement the second VR cross session 712. In this example, the virtual resources 716, 718 are VMs instantiated by virtualizations of compute resources (e.g., one or more cores of processor circuitry) and/or accelerator resources (e.g., one or more accelerator (ACCEL) functional units (AFUs)). For example, the accelerator resources can include acceleration hardware, software, and/or firmware that assists the location/positioning techniques as disclosed herein.

The virtual resources 716, 718 have access to virtualizations of memory 720. Advantageously, the coherent memory links depicted in FIG. 7 achieve direct CPU cache-to-VR device interactions (e.g., haptics) to occur in substantially real-time according to different sessions physically located in different areas/locations. The virtual resources 716, 718 are in communication with a virtual machine manager (VMM) 722. The VMM 722 is instantiated by physical hardware, such as memory, one or more cores of a CPU, one or more AFUs of an FPGA, one or more AFUs of an ASIC, etc. The example AFUs of the FPGA and/or the example AFUs of the ASIC can effectuate and/or otherwise achieve algorithmic acceleration to improve the operation of the immersive sessions 702, 704 for the benefit of the users (e.g., the human users). For example, the one or more AFUs improve rendering of the immersive sessions 702, 704 and can be instantiated and/or de-instantiated depending on the demand associated with the AR/VR live casts. Accordingly, in some examples, the VMM 722 operates as a crossbar to connect one or more receivers associated with the first immersive session 702 to one or more transmitters associated with the second immersive session 704 and vice versa to decrease network latency between the immersive sessions 702, 704 and improve performance of multiple interactive immersive sessions occurring contemporaneously.

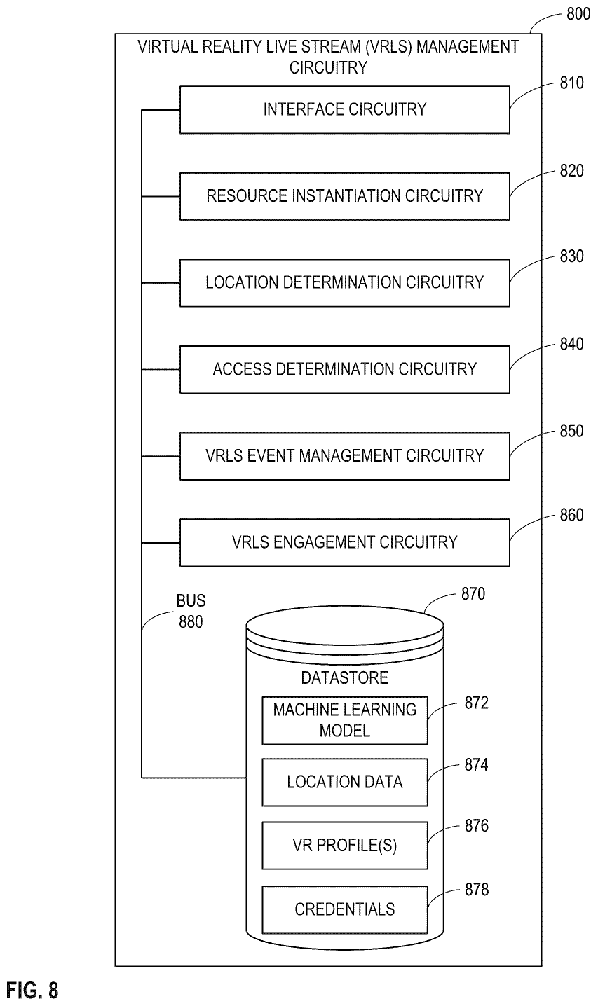

FIG. 8 is a block diagram of virtual reality live stream (VRLS) management circuitry 800 to effectuate access to and/or engagement with a VR live stream or cast. For example, the VRLS management circuitry 800 can implement a VRLS manager or location engine as disclosed herein. In some examples, the VRLS management circuitry 800 can be included in and/or implemented by an AR/VR device, such as one(s) of the clients 102, 104, 106, 108, 110, 112, 114, 116 of FIG. 1, the clients 302, 304 of FIG. 3, etc. In some examples, the VRLS management circuitry 800 can be included in and/or implemented by an edge server (e.g., the MEC network 410 of FIG. 4, the edge server 608 of FIG. 6, etc.). In some examples, the VRLS management circuitry 800 can be included in and/or implemented by a RAN server (e.g., the RAN server 506 of FIG. 5). In some examples, the VRLS management circuitry 800 can be included in and/or implemented by a core server (e.g., the core server 508 of FIG. 5). In some examples, the VRLS management circuitry 800 can be included in and/or implemented by a cloud server (e.g., the cloud network 610 of FIG. 6).

The VRLS management circuitry 800 of FIG. 8 may be instantiated (e.g., creating an instance of, bring into being for any length of time, materialize, implement, etc.) by processor circuitry such as a central processing unit executing instructions. Additionally or alternatively, the VRLS management circuitry 800 of FIG. 8 may be instantiated (e.g., creating an instance of, bring into being for any length of time, materialize, implement, etc.) by an ASIC or an FPGA structured to perform operations corresponding to the instructions. It should be understood that some or all of the VRLS management circuitry 800 of FIG. 8 may, thus, be instantiated at the same or different times. Some or all of the VRLS management circuitry 800 may be instantiated, for example, in one or more threads executing concurrently on hardware and/or in series on hardware. Moreover, in some examples, some or all of the VRLS management circuitry 800 of FIG. 8 may be implemented by one or more virtual machines and/or containers executing on the microprocessor.

The VRLS management circuitry 800 of the illustrated example includes example interface circuitry 810, example resource instantiation circuitry 820, example location determination circuitry 830, example access determination circuitry 840, example VRLS event management circuitry 850, example VRLS engagement circuitry 860, an example datastore 870, and an example bus 880. The datastore 870 of the illustrated example includes an example machine learning model 872, example location data 874, example VR profile(s) 876, and example credentials 878. In the illustrated example of FIG. 8, the interface circuitry 810, the resource instantiation circuitry 820, the location determination circuitry 830, the access determination circuitry 840, the VRLS event management circuitry 850, the VRLS engagement circuitry 860, and the datastore 870 are in communication with one(s) of each other via the bus 880. For example, the bus 880 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 880 can be implemented by any other type of computing or electrical bus.

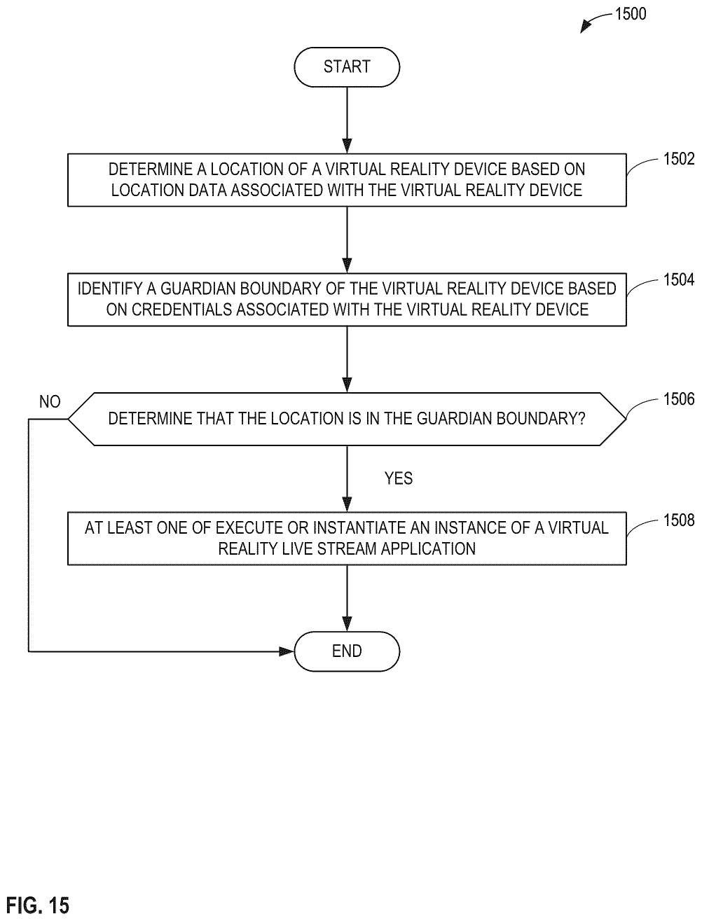

The VRLS management circuitry 800 of the illustrated example includes the interface circuitry 810 to transmit and/or receive data. For example, the interface circuitry 810 can transmit and/or receive data via any wired and/or wireless communication protocol as disclosed herein. In some examples, the interface circuitry 810 can transmit and/or receive location data associated with an AR/VR device. In some examples, the interface circuitry 810 is instantiated by processor circuitry executing interface instructions and/or configured to perform operations such as those represented by the flowcharts of one(s) of FIGS. 15, 16, 17, 18, 19, and/or 20.

In some examples, the interface circuitry 810 stores received and/or transmitted data in the datastore 870 as the location data 874. For example, the interface circuitry 810 can transmit and/or receive wireless data of any type, such as cellular data (e.g., 4G LTE, 5G, 6G, etc., data), satellite data (e.g., beyond line of site data, line of site data, etc.), Wi-Fi data, Bluetooth data, optical data, etc., and/or any combination(s) thereof.

In some examples, the interface circuitry 810 can receive data from one(s) of the devices 208, 210, 212, 214, 216, 217 the first networks 218, the RRUs 220, the DUs 222, the CUs 224, the core devices 226, 5G device environment 202, the edge network 204, the core network 206, the cloud network 207, etc., of FIG. 2. In some examples, the interface circuitry 810 can transmit data to one(s) of the devices 208, 210, 212, 214, 216, 217 the first networks 218, the RRUs 220, the DUs 222, the CUs 224, the core devices 226, 5G device environment 202, the edge network 204, the core network 206, the cloud network 207, etc., of FIG. 2.

In some examples, the interface circuitry 810 can be implemented by hardware in accordance with any type of interface standard, such as an Ethernet interface, a universal serial bus (USB) interface, a BLUETOOTH® interface, a near field communication (NFC) interface, a PCI interface, a PCIe interface, an SPG interface, a GNSS interface, a 4G/5G/6G interface, a CBRS interface, a CAT-1 interface, a CAT-M interface, an NB-IoT interface, etc., and/or any combination(s) thereof. In some examples, the interface circuitry 810 can be implemented by one or more communication devices such as one or more receivers, one or more transceivers, one or more modems, one or more gateways (e.g., residential, commercial, or industrial gateways), one or more wireless access points (WAPs), and/or one or more network interfaces to facilitate exchange of data with external machines (e.g., computing devices of any kind) by a network, such as the 5G device environment 202, the edge network 204, the core network 206, the cloud network 207, the first networks 218, etc., of FIG. 2. In some examples, the interface circuitry 810 can implement the communication by, for example, an Ethernet connection, a DSL connection, a telephone line connection, a coaxial cable system, a satellite system or network (e.g., a LOS satellite system or network, a BLOS satellite system or network, etc.), a cellular telephone system, an optical connection, etc., and/or any combination(s) thereof.

The VRLS management circuitry 800 of the illustrated example includes the resource instantiation circuitry 820 to instantiate resources on hardware, such as a server. In some examples, the resource instantiation circuitry 820 is instantiated by processor circuitry executing resource instantiation instructions and/or configured to perform operations such as those represented by the flowcharts of one(s) of FIGS. 15, 16, 17, 18, 19, and/or 20.

In some examples, the resource instantiation circuitry 820 can instantiate a virtual resource such as a VM, a container, or a virtualization of a physical hardware resource. For example, the resource instantiation circuitry 820 can initiate cloud-optimized hardware associated with a data producer, a production studio, etc., such as the black box studio 128 of FIG. 1. In some examples, the resource instantiation circuitry 820 can instantiate location-aware virtual resources on the cloud-optimized hardware to render VR live streams.

In some examples, the resource instantiation circuitry 820 can initiate edge-optimized hardware to implement an edge server. In some examples, the resource instantiation circuitry 820 can instantiate location-aware virtual resources on the edge-optimized hardware to relay the VR live streams to an AR/VR device or render VR live streams locally in proximity (e.g., close proximity (e.g., within 1 geographical mile, within 5 geographical miles, etc.)) to the AR/VR device.

In some examples, the resource instantiation circuitry 820 can initiate and/or instantiate native hardware and/or software on an AR/VR device. For example, the resource instantiation circuitry 820 can initiate and/or instantiate hardware and/or software on the first client 102 of FIG. 1 to prepare the first client 102 to join the VR cast 130 of FIG. 1.

In some examples, the resource instantiation circuitry 820 can instantiate purpose-built cloud instances of a VR live stream on at least one of the cloud-optimized hardware or the edge-optimized hardware. For example, the resource instantiation circuitry 820 can install, spin-up, and/or launch a cloud instance of the VR cast 130 on at least one of an edge server of the edge 118 or a cloud server of the cloud 120 of FIG. 1.

The VRLS management circuitry 800 of the illustrated example includes the location determination circuitry 830 to determine a location of an AR/VR device. In some examples, the location determination circuitry 830 is instantiated by processor circuitry executing location determination instructions and/or configured to perform operations such as those represented by the flowcharts of one(s) of FIGS. 15, 16, 17, 18, 19, and/or 20.

In some examples, the location determination circuitry 830 can generate, produce, and/or otherwise output a location result, which can be implemented as part of an LMF that can exist on the AR/VR device itself, on the edge server (e.g., an edge server servicing the AR/VR device) and/or the black box studio server (e.g., a cloud server servicing the black box studio 128). In some examples, the location determination circuitry 830 can implement the LMF. For example, the location determination circuitry 830 can receive measurements and signal information from the AR/VR device via the RAN including downlink positioning reference signal (PRS) and/or uplink sounding resource signals (SRS). Each signal type can be specifically designed to deliver the necessary data to produce the highest possible positioning, location, and/or directional proximity information to ensure uninterrupted coverage and to avoid gaps in coverage avoiding indoor or other inferences. In some examples, the location determination circuitry 830 can ingest PRS and/or SRS data. In some examples, the location determination circuitry 830 can utilize and/or otherwise invoke positioning techniques such as time-of-arrival (TOA), TDOA, UL-TDOA, AOA and/or any combination(s) thereof, based on data transmitted between an AR/VR device and a cellular network (e.g., an antenna of a radio unit). In some examples, the location determination circuitry 830 can determine a location of the AR/VR device based on the TOA data (e.g., UL-TOA data), UL-TDOA data, the AOA data, the RTT data, etc., and/or any combination(s) thereof. In some examples, the location determination circuitry 830 can determine whether an AR/VR device is within a CCGB, a LCGB, etc., based on the location data.

As used herein, “time-of-arrival” and “TOA” refer to the time instant (e.g., the absolute time instant) when a signal (e.g., a radio signal, an electromagnetic signal, an acoustic signal, an optical signal, etc.) emanating from a transmitter (e.g., interface circuitry, transmitter circuitry, transmitter interface circuitry, etc.) reaches a remote receiver (e.g., interface circuitry, a transmission reception point, remote receiver circuitry, receiver interface circuitry, etc.). For example, the location determination circuitry 830 can determine a TOA of portion(s) of wireless data obtained from an AR/VR device.

In some examples, the location determination circuitry 830 can determine the TOA based on the time span that has elapsed since the time-of-transmission (TOT). In some examples, the time span that has elapsed since the TOT is referred to as the time-of-flight (TOF). For example, the location determination circuitry 830 can determine the TOA of data received by a first base station of the first networks 218 (e.g., the interface circuitry 810 can be implemented by the first base station) based on a first time (e.g., a timestamp) at which a signal is sent from the sixth device 217, a second time (e.g., a timestamp) at which the signal is received at the first base station, and the speed at which the signal travels (e.g., the speed of light). In some examples, the first time and the second time is TOA data. In some examples, a difference (e.g., a time difference) between the first time and the second time and/or a data association of the difference and the sixth device 217 is/are TOA measurements. In some examples, the location determination circuitry 830 can store the TOA data, the TOA measurements, etc., and/or any combination(s) thereof, in the datastore 870 as the location data 874.

In some examples, the location determination circuitry 830 determines a TDOA associated with TOA data, or portion(s) thereof. As used herein, “time-difference-of-arrival” and “TDOA” refer to a difference of times (e.g., time values, timestamps, time signatures, etc.) at which signals (e.g., radio signals, electromagnetic signals, acoustic signals, optical signals, etc.) emanating from a transmitter (e.g., interface circuitry, transmitter circuitry, transmitter interface circuitry, etc.) reach different remote receivers (e.g., multiple instances of interface circuitry, remote receiver circuitry, receiver interface circuitry, base stations, anchor devices, etc.). By way of example, the sixth device 217 of FIG. 2 can transmit cellular data, such as 5G NR SRS data, to at least three different 5G cellular base stations (e.g., ones of the first networks 218 of FIG. 2, base stations of and/or implemented by the first networks 218, etc.). In some examples, the at least three different 5G cellular base stations are synchronized in time to capture the corresponding cellular data from the sixth device 217. In some examples, the location determination circuitry 830 can shift the time signature of each set of cellular data received by the at least three different 5G cellular base stations to generate a set of curved lines, parabolas, curves, etc., that represent solutions to distance equations. For example, the actual location of the sixth device 217 can sit and/or otherwise be located or positioned at the intersection of the set of curved lines, parabolas, curves, etc.

In some examples, the location determination circuitry 830 can determine TDOA between individual elements of a sensing array (e.g., an antenna array) of the same base station (e.g., the TDOA between multiple antennas of the same one of the first networks 218, the TDOA between multiple antennas of the same base station of the first networks 218, etc.). For example, the location determination circuitry 830 can measure the difference in received phase at element(s) in the sensing array, and convert the delay of arrival at the element(s) to TDOA measurement(s). In some examples, the location determination circuitry 830 can store the TDOA data in the datastore 870 as the location data 874.

In some examples, the time signatures of each set of cellular data is TDOA data. In some examples, first difference(s) between the time signatures and/or data association(s) of the first difference(s) and the device is/are TDOA measurements. In some examples, second difference(s) between the received phase(s) and/or data association(s) of the second difference(s) and the device is/are TDOA measurements. In some examples, the location determination circuitry 830 can store the TDOA data, the TDOA measurements, etc., in the datastore 870 as the location data 874.

In some examples, the location determination circuitry 830 can determine TDOA based on TOA data from different base stations and/or from different antennae of the same base station. For example, the location determination circuitry 830 can obtain (i) a first TOA measurement associated with the sixth device 217 of FIG. 2, from a first base station, such as a first one of the first networks 218 of FIG. 2, (ii) a second TOA measurement associated with the sixth device 217 from a second base station, such as a second one of the first networks 218 of FIG. 2, and (iii) a third TOA measurement associated with the sixth device 217 from a third base station, such as a third one of the first networks 218 of FIG. 2. In some examples, the location determination circuitry 830 can determine a TDOA based on the first through third TOA measurements.

In some examples, the location determination circuitry 830 can obtain (i) a first TOA measurement associated with a client device, such as the sixth device 217, from a first antenna of a base station, such as a first antenna of a first one of the first networks 218 of FIG. 2, (ii) a second TOA measurement associated with the client device from a second antenna of the base station, and a third TOA measurement associated with the client device from a third antenna of the base station. In some examples, the location determination circuitry 830 can determine a TDOA based on the first through third TOA measurements.

In some examples, the location determination circuitry 830 determines an AOA associated with data, or portion(s) thereof. As used herein, the “angle-of-arrival” and “AOA” of a signal refer to the direction from which the signal (e.g., a radio signal, an electromagnetic signal, an acoustic signal, an optical signal, etc.) is received. In some examples, the location determination circuitry 830 can determine the AOA of a signal based on a determination of the direction of propagation of the signal incident on a sensing array (e.g., an antenna array). In some examples, the location determination circuitry 830 can determine the AOA of a signal based on a signal strength (e.g., a maximum signal strength) during antenna rotation. In some examples, the location determination circuitry 830 can determine the AOA of a signal based on a TDOA between individual elements of a sensing array. In some examples, the location determination circuitry 830 can measure the difference in received phase at each element in the sensing array, and convert the delay of arrival at each element to an AOA measurement.

In some examples, the direction of propagation of a signal incident on a sensing array, a signal strength measurement, etc., is/are AOA data. In some examples, the AOA of a signal, a TDOA between individual elements of a sensing array, a difference in received phase of element(s) in a sensing array, etc., is/are AOA measurements. In some examples, data association(s) of (i) AOA data, or portion(s) thereof, (ii) AOA measurement(s), or portion(s) thereof, and/or (iii) a device that transmitted cellular data leading to the AOA data and/or the AOA measurements is/are AOA measurements. In some examples, the location determination circuitry 830 can store the AOA data, the AOA measurements, etc., in the datastore 870 as the location data 874.

The VRLS management circuitry 800 of the illustrated example includes the access determination circuitry 840 to determine whether to grant access for an AR/VR device to a VRLS. In some examples, the access determination circuitry 840 is instantiated by processor circuitry executing access determination instructions and/or configured to perform operations such as those represented by the flowcharts of one(s) of FIGS. 15, 16, 17, 18, 19, and/or 20.

In some examples, the access determination circuitry 840 can determine to grant access to the first client 102 of FIG. 1 based on location data associated with the first client 102, such as whether the first client 102 is within the CCGB 134 and/or the LCGB 136. For example, the access determination circuitry 840 can obtain a location result, such as a location (e.g., a geographical location) and/or position (e.g., a geographical position), of the first client 102 based on the location data 874 (e.g., TOA data, AOA data, RTT data, TDOA data, etc.). In some examples, after a first determination that the location result indicates that the first client 102 is not included in the CCGB 134 and/or the LCGB 136, the access determination circuitry 840 can reject access of the first client 102 to the VR cast 130. In some examples, after a second determination that the first client 102 already accessed and/or otherwise is already engaging in the VR cast 130 and the location result indicates that the first client 102 is not included in the CCGB 134 and/or the LCGB 136, the access determination circuitry 840 can disconnect and/or otherwise cease access of the first client 102 from the VR cast 130.

In some examples, the access determination circuitry 840 can determine to grant access of the first client 102 of FIG. 1 to the VR cast 130 based on a ticket (e.g., a virtual or virtualized ticket), a token (e.g., a virtual token or virtualized token, a cryptographic token, etc.). For example, the access determination circuitry 840 can obtain a virtual ticket from the first client 102 to enter the VR cast 130. In some examples, the access determination circuitry 840 can look up location data in the location data 874 that corresponds to and/or is associated with the virtual ticket. For example, the access determination circuitry 840 can determine that the location data 874 corresponds to the CCGB 134 of FIG. 1. In some examples, after a first determination that the first client 102 is not included in the CCGB 134 that corresponds to the provided virtual ticket, the access determination circuitry 840 can reject access of the first client 102 to the VR cast 130. In some examples, after a second determination that the first client 102 already accessed and/or otherwise is already engaging in the VR cast 130 and the first client 102 is not included in the CCGB 134 that corresponds to the virtual ticket, the access determination circuitry 840 can disconnect and/or otherwise cease access of the first client 102 from the VR cast 130. In some examples, after a third determination that the first client 102 is included in the CCGB 134 that corresponds to the provided virtual ticket, the access determination circuitry 840 can grant access of the first client 102 to the VR cast 130.

The VRLS management circuitry 800 of the illustrated example includes the VRLS event management circuitry 850 to manage a VRLS. In some examples, the VRLS event management circuitry 850 is instantiated by processor circuitry executing VRLS event management instructions and/or configured to perform operations such as those represented by the flowcharts of one(s) of FIGS. 15, 16, 17, 18, 19, and/or 20.

In some examples, the VRLS event management circuitry 850 can manage admissions, re-admissions, denials of entry, etc., of the clients 102, 104, 106, 108, 110, 112, 114, 116 to a VRLS based on location data, access or event credentials, etc., and/or any combination(s) thereof. For example, the VRLS event management circuitry 850 can manage the VRLS event based on the location data 874, the VR profile(s) 876, the credentials 878, etc., associated with the one(s) of the clients 102, 104, 106, 108, 110, 112, 114, 116. In some examples, the VR profile(s) 876 can include user data such as a user name and/or password or passcode, an avatar or other virtual representation of a user (e.g., a virtual representation of an entirety or full body of the user, or portion(s) thereof), etc., demographic information such as a name, a gender, a sex, a date of birth, an address (e.g., a home address, a business address, etc.), etc. In some examples, the credentials 878 can include a ticket (e.g., a virtual ticket, a ticket to a VRLS, etc.), a token (e.g., a virtual and/or cryptographic token, an authorization token to gain access to a VRLS, a cryptographically or electronically signed datum, etc.), or any other type of access credentials.

The VRLS management circuitry 800 of the illustrated example includes the VRLS engagement circuitry 860 to effectuate the VRLS and/or, more generally, the engagement of one(s) of the clients 102, 104, 106, 108, 110, 112, 114, 116 with each other in the VRLS. In some examples, the VRLS engagement circuitry 860 is instantiated by processor circuitry executing VRLS engagement instructions and/or configured to perform operations such as those represented by the flowcharts of one(s) of FIGS. 15, 16, 17, 18, 19, and/or 20.

In some examples, the VRLS engagement circuitry 860 can instantiate a purpose-built cloud instance of the VRLS (e.g., the VR cast 130 of FIG. 1) and change placements of the one(s) of the clients 102, 104, 106, 108, 110, 112, 114, 116 on virtualized resources based on changes in their respective location data 874, carry out actions based on AR/VR gestures made by users controlling the one(s) of the clients 102, 104, 106, 108, 110, 112, 114, 116, etc., and/or any combination(s) thereof. For example, the VRLS engagement circuitry 860 can initiate the VRLS and carry out the VRLS based on actions of the one(s) of the clients 102, 104, 106, 108, 110, 112, 114, 116 that are engaging with the VRLS. In some examples, the VRLS engagement circuitry 860 can execute and/or instantiate the machine learning model 872 to execute and/or otherwise carry out the VRLS. For example, the machine learning model 872 can be any type of AI/ML model, such as a neural network (e.g., an artificial neural network, a convolution neural network, etc.), a reinforcement learning model, etc.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the machine learning model 872 may be trained with data to recognize patterns and/or associations and follow such patterns and/or associations when processing input data such that other input(s) result in output(s) consistent with the recognized patterns and/or associations.

Many different types of machine-learning models and/or machine-learning architectures exist. In some examples, the VRLS management circuitry 800 generates the machine learning model 872 as one or more neural network models. The VRLS management circuitry 800 can invoke the interface circuitry 810 to transmit the machine learning model 872 to one(s) of the clients 102, 104, 106, 108, 110, 112, 114, 116. Using a neural network model enables the VRLS management circuitry 800 to execute an AI/ML workload. In general, machine-learning models/architectures that are suitable to use in the example approaches disclosed herein include recurrent neural networks. However, other types of machine learning models could additionally or alternatively be used such as supervised learning ANN models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine or network, Naive Bayes, etc. In some examples, the VRLS management circuitry 800 can compile, generate, and/or otherwise output one(s) of the machine learning model 872 as lightweight machine-learning model(s).

In general, implementing an ML/AI system involves two phases, a learning/training phase and an inference phase. In the learning/training phase, a training algorithm is used to train the machine learning model 872 to operate in accordance with patterns and/or associations based on, for example, training data. In general, the machine learning model 872 includes internal parameters that guide how input data is transformed into output data, such as through a series of nodes and connections within the machine learning model 872 to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, the VRLS management circuitry 800 can invoke supervised training to use inputs and corresponding expected (e.g., labeled) outputs to select parameters (e.g., by iterating over combinations of select parameters) for the machine learning model 872 that reduce model error. As used herein, “labeling” refers to an expected output of the machine learning model (e.g., a classification, an expected output value, etc.). Alternatively, the VRLS management circuitry 800 can invoke unsupervised training (e.g., used in deep learning, a subset of machine learning, etc.) that involves inferring patterns from inputs to select parameters for the machine learning model 872 (e.g., without the benefit of expected (e.g., labeled) outputs).

In some examples, the VRLS management circuitry 800 trains the machine learning model 872 using unsupervised clustering of operating observables. However, the VRLS management circuitry 800 may additionally or alternatively use any other training algorithm such as stochastic gradient descent, Simulated Annealing, Particle Swarm Optimization, Evolution Algorithms, Genetic Algorithms, Nonlinear Conjugate Gradient, etc.

In some examples, the VRLS management circuitry 800 can train the machine learning model 872 until the level of error is no longer reducing. In some examples, the VRLS management circuitry 800 can train the machine learning model 872 locally on the VRLS management circuitry 800 and/or remotely at an external computing communicatively coupled to the VRLS management circuitry 800. In some examples, the VRLS management circuitry 800 trains the machine learning model 872 using hyperparameters that control how the learning is performed (e.g., a learning rate, a number of layers to be used in the machine learning model, etc.). In some examples, the VRLS management circuitry 800 can use hyperparameters that control model performance and training speed such as the learning rate and regularization parameter(s). The VRLS management circuitry 800 can select such hyperparameters by, for example, trial and error to reach an optimal model performance. In some examples, the VRLS management circuitry 800 utilizes Bayesian hyperparameter optimization to determine an optimal and/or otherwise improved or more efficient network architecture to avoid model overfitting and improve the overall applicability of the machine learning model 872. Alternatively, the VRLS management circuitry 800 may use any other type of optimization. In some examples, the VRLS management circuitry 800 may perform re-training The VRLS management circuitry 800 can execute such re-training in response to override(s) by a user of the VRLS management circuitry 800, a receipt of new training data, etc.

In some examples, the VRLS management circuitry 800 facilitates the training of the machine learning model 872 using training data. In some examples, the VRLS management circuitry 800 utilizes training data that originates from locally generated data. In some examples, the VRLS management circuitry 800 utilizes training data that originates from externally generated data. In some examples where supervised training is used, the VRLS management circuitry 800 can label the training data. Labeling is applied to the training data by a user manually or by an automated data pre-processing system. In some examples, the VRLS management circuitry 800 can pre-process the training data using, for example, an interface (e.g., the interface circuitry 810) to effectuate a VRLS event. In some examples, the VRLS management circuitry 800 sub-divides the training data into a first portion of data for training the machine learning model 872, and a second portion of data for validating the machine learning model 872.

Once training is complete, the VRLS management circuitry 800 can deploy the machine learning model 872 for use as an executable construct that processes an input and provides an output based on the network of nodes and connections defined in the machine learning model 872. The VRLS management circuitry 800 can store the machine learning model 872 in the datastore 870.

Once trained, the deployed machine learning model 872 may be operated in an inference phase to process data. In the inference phase, data to be analyzed (e.g., live data) is input to the machine learning model 872, and the machine learning model 872 execute(s) to create an output. This inference phase can be thought of as the AI “thinking” to generate the output based on what it learned from the training (e.g., by executing the machine learning model 872 to apply the learned patterns and/or associations to the live data). In some examples, input data undergoes pre-processing before being used as an input to the machine learning model 872. Moreover, in some examples, the output data may undergo post-processing after it is generated by the machine learning model 872 to transform the output into a useful result (e.g., a display of data, a rendering of an AR/VR live stream, a detection and/or identification of an object, an instruction to be executed by a machine, etc.).

In some examples, output of the deployed machine learning model 872 may be captured and provided as feedback. By analyzing the feedback, an accuracy of the deployed machine learning model 872 can be determined. If the feedback indicates that the accuracy of the deployed model is less than a threshold or other criterion, training of an updated model can be triggered using the feedback and an updated training data set, hyperparameters, etc., to generate an updated, deployed model.

The VRLS management circuitry 800 of the illustrated example includes the datastore 870 to record data, such as the machine learning model 872, the location data 874, the VR profile(s) 876, the credentials 878, etc. In some examples, the datastore 870 is instantiated by processor circuitry executing datastore instructions and/or configured to perform operations such as those represented by the flowcharts of one(s) of FIGS. 15, 16, 17, 18, 19, and/or 20.

The datastore 870 of this example may be implemented by a volatile memory and/or a non-volatile memory (e.g., flash memory). The datastore 870 may additionally or alternatively be implemented by one or more double data rate (DDR) memories, such as DDR, DDR2, DDR3, DDR4, mobile double data rate (mDDR), etc. The datastore 870 may additionally or alternatively be implemented by one or more mass storage devices such as hard disk drive(s) (HDD(s)), CD drive(s), DVD drive(s), solid-state disk (SSD) drive(s), etc. While in the illustrated example the datastore 870 is illustrated as a single datastore, the datastore 892 may be implemented by any number and/or type(s) of datastores. Furthermore, the data stored in the datastore 870 may be in any data format such as, for example, binary data, comma delimited data, tab delimited data, structured query language (SQL) structures, an executable (e.g., an executable binary, a machine learning configuration image, etc.), etc.

As used herein, “data” is information in any form that may be ingested, processed, interpreted and/or otherwise manipulated by processor circuitry to produce a result. The produced result may itself be data.

As used herein, a “threshold” is expressed as data such as a numerical value represented in any form, that may be used by processor circuitry as a reference for a comparison operation.

As used herein, a “model” is a set of instructions and/or data that may be ingested, processed, interpreted and/or otherwise manipulated by processor circuitry to produce a result. Often, a model is operated using input data to produce output data in accordance with one or more relationships reflected in the model. The model may be based on training data.

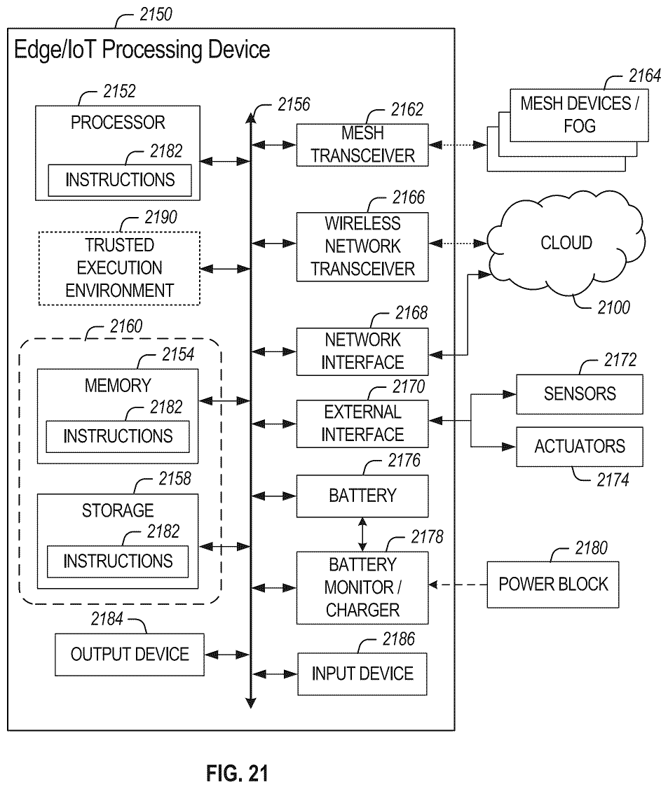

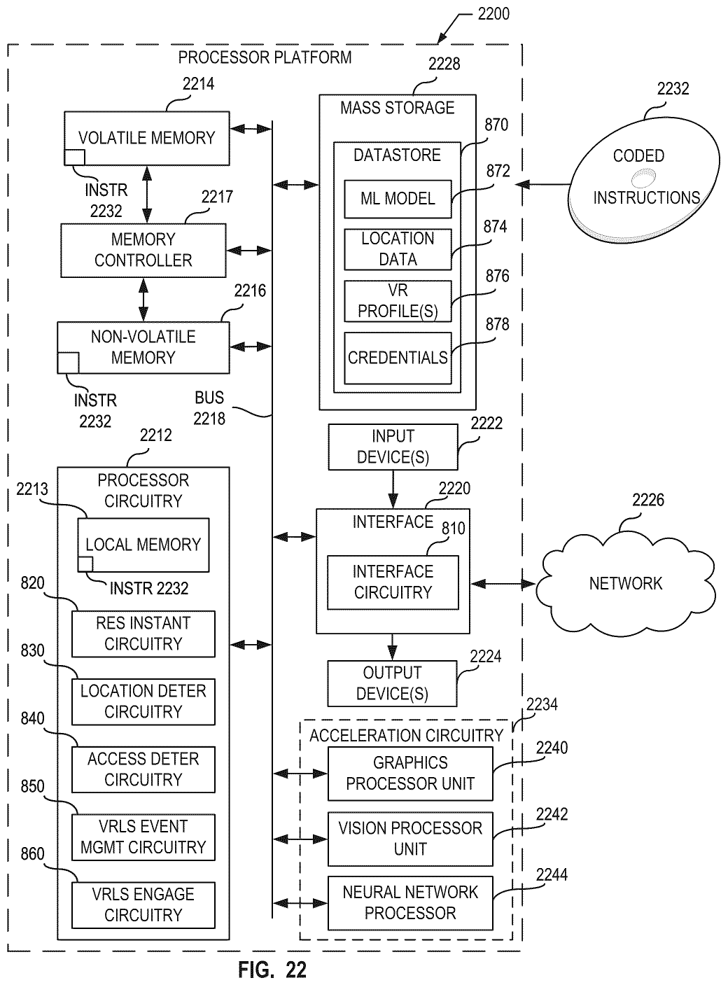

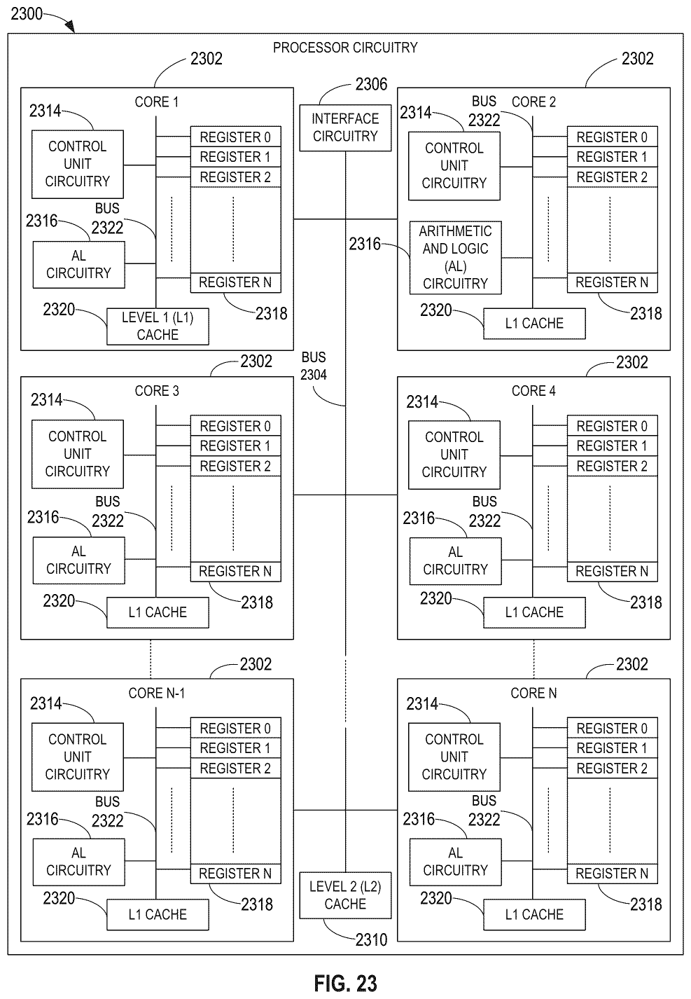

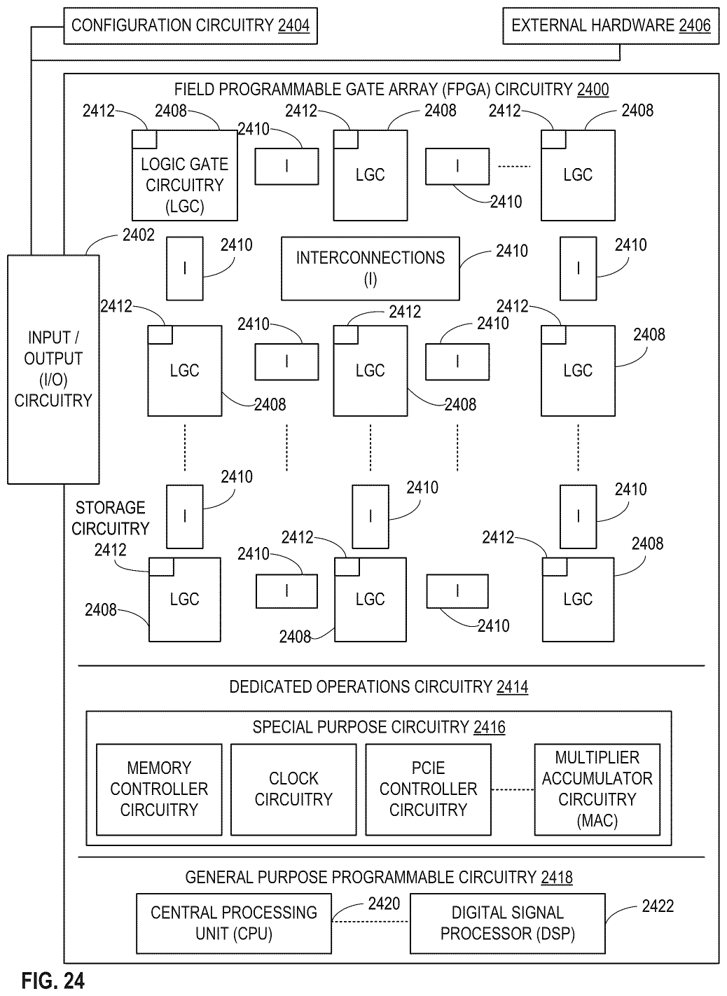

In some examples, the VRLS management circuitry 800 includes means for receiving data and/or means for transmitting data. For example, the means for receiving and/or the means for transmitting may be implemented by the interface circuitry 810. In some examples, the interface circuitry 810 may be instantiated by processor circuitry such as the example processor 2152 of FIG. 21, the example processor circuitry 2212 of FIG. 22, the example processor circuitry 2300 of FIG. 23, and/or the FPGA 2400 of FIG. 24. For instance, the interface circuitry 810 may be instantiated by the example microprocessor 2300 of FIG. 23 executing machine executable instructions such as those implemented by one or more blocks of one(s) of FIGS. 15-20. In some examples, the interface circuitry 810 may be instantiated by hardware logic circuitry, which may be implemented by an ASIC, XPU, or the FPGA circuitry 2400 of FIG. 24 structured to perform operations corresponding to the machine-readable instructions. Additionally or alternatively, the interface circuitry 810 may be instantiated by any other combination of hardware, software, and/or firmware. For example, the interface circuitry 810 may be implemented by at least a transmitter, a receiver, a transceiver, a modem, a residential gateway, a WAP, a network interface, one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine-readable instructions and/or to perform some or all of the operations corresponding to the machine-readable instructions without executing software or firmware, but other structures are likewise appropriate.

In some examples, the VRLS management circuitry 800 includes means for initializing a resource and/or means for instantiating a resource. For example, the means for initializing and/or the means for instantiating may be implemented by the resource instantiation circuitry 820. In some examples, the resource instantiation circuitry 820 may be instantiated by processor circuitry such as the example processor 2152 of FIG. 21, the example processor circuitry 2212 of FIG. 22, the example processor circuitry 2300 of FIG. 23, and/or the FPGA 2400 of FIG. 24. For instance, the resource instantiation circuitry 820 may be instantiated by the example microprocessor 2300 of FIG. 23 executing machine executable instructions such as those implemented by one or more blocks of one(s) of FIGS. 15-20. In some examples, the resource instantiation circuitry 820 may be instantiated by hardware logic circuitry, which may be implemented by an ASIC, XPU, or the FPGA circuitry 2400 of FIG. 24 structured to perform operations corresponding to the machine-readable instructions. Additionally or alternatively, the resource instantiation circuitry 820 may be instantiated by any other combination of hardware, software, and/or firmware. For example, the resource instantiation circuitry 820 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine-readable instructions and/or to perform some or all of the operations corresponding to the machine-readable instructions without executing software or firmware, but other structures are likewise appropriate.

In some examples, the VRLS management circuitry 800 includes means for determining a location (e.g., a location of a device, a client, etc.). For example, the means for determining may be implemented by the location determination circuitry 830. In some examples, the location determination circuitry 830 may be instantiated by processor circuitry such as the example processor 2152 of FIG. 21, the example processor circuitry 2212 of FIG. 22, the example processor circuitry 2300 of FIG. 23, and/or the FPGA 2400 of FIG. 24. For instance, the location determination circuitry 830 may be instantiated by the example microprocessor 2300 of FIG. 23 executing machine executable instructions such as those implemented by one or more blocks of one(s) of FIGS. 15-20. In some examples, the location determination circuitry 830 may be instantiated by hardware logic circuitry, which may be implemented by an ASIC, XPU, or the FPGA circuitry 2400 of FIG. 24 structured to perform operations corresponding to the machine-readable instructions. Additionally or alternatively, the location determination circuitry 830 may be instantiated by any other combination of hardware, software, and/or firmware. For example, the location determination circuitry 830 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine-readable instructions and/or to perform some or all of the operations corresponding to the machine-readable instructions without executing software or firmware, but other structures are likewise appropriate.

In some examples, the VRLS management circuitry 800 includes means for granting access to a VRLS. For example, the means for granting may be implemented by the access determination circuitry 840. In some examples, the access determination circuitry 840 may be instantiated by processor circuitry such as the example processor 2152 of FIG. 21, the example processor circuitry 2212 of FIG. 22, the example processor circuitry 2300 of FIG. 23, and/or the FPGA 2400 of FIG. 24. For instance, the access determination circuitry 840 may be instantiated by the example microprocessor 2300 of FIG. 23 executing machine executable instructions such as those implemented by one or more blocks of one(s) of FIGS. 15-20. In some examples, the access determination circuitry 840 may be instantiated by hardware logic circuitry, which may be implemented by an ASIC, XPU, or the FPGA circuitry 2400 of FIG. 24 structured to perform operations corresponding to the machine-readable instructions. Additionally or alternatively, the access determination circuitry 840 may be instantiated by any other combination of hardware, software, and/or firmware. For example, the access determination circuitry 840 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine-readable instructions and/or to perform some or all of the operations corresponding to the machine-readable instructions without executing software or firmware, but other structures are likewise appropriate.

In some examples, the VRLS management circuitry 800 includes means for managing a VRLS event. For example, the means for managing may be implemented by the VRLS event management circuitry 850. In some examples, the VRLS event management circuitry 850 may be instantiated by processor circuitry such as the example processor 2152 of FIG. 21, the example processor circuitry 2212 of FIG. 22, the example processor circuitry 2300 of FIG. 23, and/or the FPGA 2400 of FIG. 24. For instance, the VRLS event management circuitry 850 may be instantiated by the example microprocessor 2300 of FIG. 23 executing machine executable instructions such as those implemented by one or more blocks of one(s) of FIGS. 15-20. In some examples, the VRLS event management circuitry 850 may be instantiated by hardware logic circuitry, which may be implemented by an ASIC, XPU, or the FPGA circuitry 2400 of FIG. 24 structured to perform operations corresponding to the machine-readable instructions. Additionally or alternatively, the VRLS event management circuitry 850 may be instantiated by any other combination of hardware, software, and/or firmware. For example, the VRLS event management circuitry 850 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine-readable instructions and/or to perform some or all of the operations corresponding to the machine-readable instructions without executing software or firmware, but other structures are likewise appropriate.

In some examples, the VRLS management circuitry 800 includes means for engaging with a VRLS. For example, the means for engaging may be implemented by the VRLS engagement circuitry 860. In some examples, the VRLS engagement circuitry 860 may be instantiated by processor circuitry such as the example processor 2152 of FIG. 21, the example processor circuitry 2212 of FIG. 22, the example processor circuitry 2300 of FIG. 23, and/or the FPGA 2400 of FIG. 24. For instance, the VRLS engagement circuitry 860 may be instantiated by the example microprocessor 2300 of FIG. 23 executing machine executable instructions such as those implemented by one or more blocks of one(s) of FIGS. 15-20. In some examples, the VRLS engagement circuitry 860 may be instantiated by hardware logic circuitry, which may be implemented by an ASIC, XPU, or the FPGA circuitry 2400 of FIG. 24 structured to perform operations corresponding to the machine-readable instructions. Additionally or alternatively, the VRLS engagement circuitry 860 may be instantiated by any other combination of hardware, software, and/or firmware. For example, the VRLS engagement circuitry 860 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine-readable instructions and/or to perform some or all of the operations corresponding to the machine-readable instructions without executing software or firmware, but other structures are likewise appropriate.

In some examples, the VRLS management circuitry 800 includes means for storing data. For example, the means for storing may be implemented by the datastore 870. In some examples, the datastore 870 may be instantiated by processor circuitry such as the example processor 2152 of FIG. 21, the example processor circuitry 2212 of FIG. 22, the example processor circuitry 2300 of FIG. 23, and/or the FPGA 2400 of FIG. 24. For instance, the datastore 870 may be instantiated by the example microprocessor 2300 of FIG. 23 executing machine executable instructions such as those implemented by one or more blocks of one(s) of FIGS. 15-20. In some examples, the datastore 870 may be instantiated by hardware logic circuitry, which may be implemented by an ASIC, XPU, or the FPGA circuitry 2400 of FIG. 24 structured to perform operations corresponding to the machine-readable instructions. Additionally or alternatively, the datastore 870 may be instantiated by any other combination of hardware, software, and/or firmware. For example, the datastore 870 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine-readable instructions and/or to perform some or all of the operations corresponding to the machine-readable instructions without executing software or firmware, but other structures are likewise appropriate.

While an example manner of implementing the clients, edge servers, cloud servers, etc., of FIGS. 1-7 is illustrated in FIG. 8, one or more of the elements, processes, and/or devices illustrated in FIG. 8 may be combined, divided, re-arranged, omitted, eliminated, and/or implemented in any other way. Further, the interface circuitry 810, the resource instantiation circuitry 820, the location determination circuitry 830, the access determination circuitry 840, the VRLS event management circuitry 850, the VRLS engagement circuitry 860, the datastore 870, the machine learning model 872, the location data 874, the VR profile(s) 876, the credentials 878, the bus 880, and/or, more generally, the example clients, edge servers, cloud servers, etc., of FIGS. 1-7, may be implemented by hardware alone or by hardware in combination with software and/or firmware. Thus, for example, any of the interface circuitry 810, the resource instantiation circuitry 820, the location determination circuitry 830, the access determination circuitry 840, the VRLS event management circuitry 850, the VRLS engagement circuitry 860, the datastore 870, the machine learning model 872, the location data 874, the VR profile(s) 876, the credentials 878, the bus 880, and/or, more generally, the example clients, edge servers, cloud servers, etc., could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example clients, edge servers, cloud servers, etc., of FIGS. 1-7 may include one or more elements, processes, and/or devices in addition to, or instead of, those illustrated in FIG. 8, and/or may include more than one of any or all of the illustrated elements, processes and devices.

FIG. 9 is a block diagram 900 showing an overview of a configuration for edge computing, which includes a layer of processing referred to in many of the following examples as an “edge cloud”. As shown, the edge cloud 910 is co-located at an edge location, such as an access point or base station 940, a local processing hub 950, or a central office 920, and thus may include multiple entities, devices, and equipment instances. The edge cloud 910 is located much closer to the endpoint (consumer and producer) data sources 960 (e.g., autonomous vehicles 961, user equipment 962, business and industrial equipment 963, video capture devices 964, drones 965, smart cities and building devices 966, sensors and Internet-of-Things (IoT) devices 967, augmented and/or virtual reality (AR/VR) devices, etc.) than the cloud data center 930. Compute, memory, and storage resources that are offered at the edges in the edge cloud 910 are critical to providing ultra-low latency response times for services and functions used by the endpoint data sources 960 as well as reduce network backhaul traffic from the edge cloud 910 toward cloud data center 930 thus improving energy consumption and overall network usages among other benefits.

In some examples, the central office 920, the cloud data center 930, and/or portion(s) thereof, may implement one or more location engines, one or more virtual reality live stream (VRLS) managers (e.g., VRLS managers implemented by the VRLS management circuitry 800 of FIG. 8), etc., for use in VRLS management. For example, the one or more location engines, the one or more VRLS managers, etc., can locate and/or otherwise identify positions of devices of the endpoint (consumer and producer) data sources 960 (e.g., autonomous vehicles 961, user equipment 962, business and industrial equipment 963, video capture devices 964, drones 965, smart cities and building devices 966, sensors and Internet-of-Things (IoT) devices 967, AR/VR devices, etc.). In some such examples, the central office 920, the cloud data center 930, and/or portion(s) thereof, may implement one or more location engines, one or more VRLS managers, etc., to execute location detection operations with improved accuracy and reduced latency to effectuate VRLS events. In some examples, the user equipment 962 may be implemented with AR/VR devices.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 9, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, etc., and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage and processing as well as remote cloud datacenter based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud datacenter. At a more generic level, an edge computing system may be described to encompass any number of deployments operating in the edge cloud 910, which provide coordination from client and distributed computing devices.

FIG. 10 illustrates operational layers among endpoints, an edge cloud, and cloud computing environments. Specifically, FIG. 10 depicts examples of computational use cases 1005, utilizing the edge cloud 910 of FIG. 9 among multiple illustrative layers of network computing. The layers begin at an endpoint (devices and things) layer 1000, which accesses the edge cloud 910 to conduct data creation, analysis, and data consumption activities. The edge cloud 910 may span multiple network layers, such as an edge devices layer 1010 having gateways, on-premise servers, or network equipment (nodes 1015) located in physically proximate edge systems; a network access layer 1020, encompassing base stations, radio processing units, network hubs, regional data centers (DC), or local network equipment (equipment 1025); and any equipment, devices, or nodes located therebetween (in layer 1012, not illustrated in detail). The network communications within the edge cloud 910 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1000, under 5 ms at the edge devices layer 1010, to even between 10 to 40 ms when communicating with nodes at the network access layer 1020. Beyond the edge cloud 910 are core network 1030 and cloud data center 1032 layers, each with increasing latency (e.g., between 50-60 ms at the core network layer 1030, to 100 or more ms at the cloud data center layer 1040). As a result, operations at a core network data center 1035 or a cloud data center 1045, with latencies of at least 50 to 100 ms or more, will not be able to accomplish many time-critical functions of the use cases 1005. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1035 or a cloud data center 1045, a central office or content data network may be considered as being located within a “near edge” layer (“near” to the cloud, having high latency values when communicating with the devices and endpoints of the use cases 1005), whereas an access point, base station, on-premise server, or network gateway may be considered as located within a “far edge” layer (“far” from the cloud, having low latency values when communicating with the devices and endpoints of the use cases 1005). It will be understood that other categorizations of a particular network layer as constituting a “close”, “local”, “near”, “middle”, or “far” edge may be based on latency, distance, number of network hops, or other measurable characteristics, as measured from a source in any of the network layers 1000-1040.

The various use cases 1005 may access resources under usage pressure from incoming streams, due to multiple services utilizing the edge cloud. For example, location detection of devices associated with such incoming streams of the various use cases 1005 is desired and may be achieved with example location engines, example VRLS managers (e.g., VRLS management circuitry that implements one or more VRLS managers), etc., as described herein. To achieve results with low latency, the services executed within the edge cloud 910 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 910 may provide the ability to serve and respond to multiple applications of the use cases 1005 (e.g., object tracking, location detection, video surveillance, connected cars, etc.) in real-time or near real-time, and meet ultra-low latency requirements for these multiple applications. These advantages enable a whole new class of applications (VNFs), Function-as-a-Service (FaaS), Edge-as-a-Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 910 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 910 (network layers 1010-1030), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 910.

As such, the edge cloud 910 is formed from network components and functional features operated by and within edge gateway nodes, edge aggregation nodes, or other edge compute nodes among network layers 1010-1030. The edge cloud 910 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 910 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 910 may be servers, multi-tenant servers, appliance computing devices, and/or any other type of computing devices. For example, the edge cloud 910 may include an appliance computing device that is a self-contained electronic device including a housing, a chassis, a case or a shell. In some examples, the edge cloud 910 may include an appliance to be operated in harsh environmental conditions (e.g., extreme heat or cold ambient temperatures, strong wind conditions, wet or frozen environments, and the like). In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, light emitting diodes (LEDs), speakers, I/O ports (e.g., universal serial bus (USB)), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include IoT devices. The appliance computing device may include hardware and software components to manage local issues such as device temperature, vibration, resource utilization, updates, power issues, physical and network security, etc. The example processor systems of at least FIGS. 21 and/or 22 illustrate example hardware for implementing an appliance computing device. The edge cloud 910 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

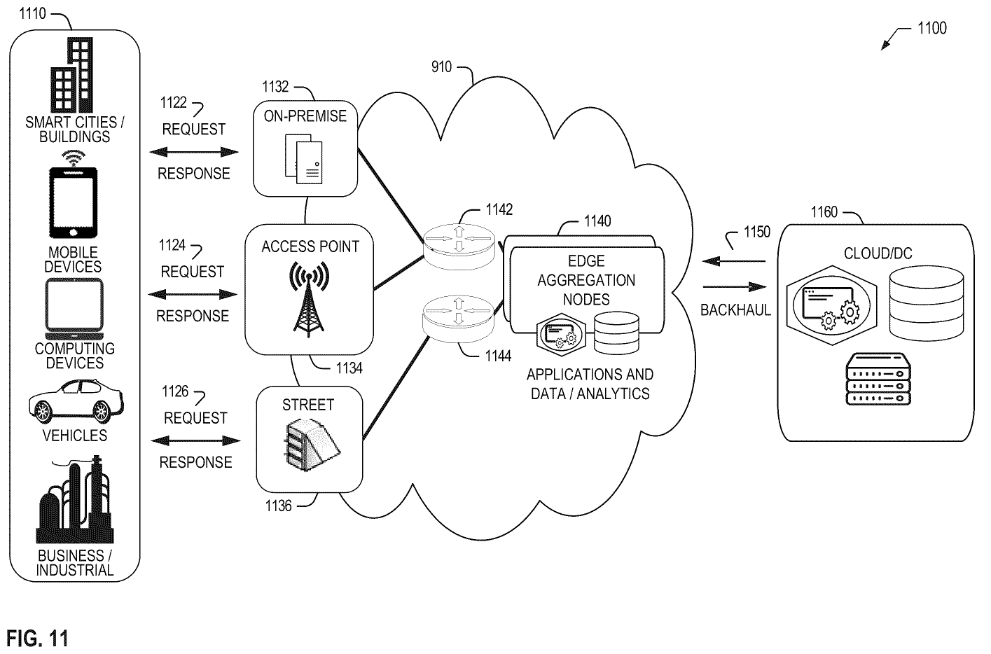

In FIG. 11, various client endpoints 1110 (in the form of mobile devices, computers, autonomous vehicles, business computing equipment, industrial processing equipment, and/or AR/VR devices in smart cities/buildings, vehicles, business/industrial environments, etc.) exchange requests and responses that are specific to the type of endpoint network aggregation. For instance, client endpoints 1110 may obtain network access via a wired broadband network, by exchanging requests and responses 1122 through an on-premise network system 1132. Some client endpoints 1110, such as mobile computing or electronic devices (e.g., AR/VR devices), may obtain network access via a wireless broadband network, by exchanging requests and responses 1124 through an access point 1134. For example, the access point 1134 may be implemented using a cellular network tower (e.g., a cellular network tower to implement a logical 5G radio node (gNB)), a Wi-Fi access point (e.g., a Wi-Fi router or gateway), etc., and/or any combination(s) thereof. Some client endpoints 1110, such as autonomous vehicles may obtain network access for requests and responses 1126 via a wireless vehicular network through a street-located network system 1136. However, regardless of the type of network access, the TSP may deploy aggregation points 1142, 1144 within the edge cloud 910 of FIG. 9 to aggregate traffic and requests. Thus, within the edge cloud 910, the TSP may deploy various compute and storage resources, such as at edge aggregation nodes 1140, to provide requested content. The edge aggregation nodes 1140 and other systems of the edge cloud 910 are connected to a cloud or data center (DC) 1160, which uses a backhaul network 1150 to fulfill higher-latency requests from a cloud/data center for websites, applications, database servers, etc. Additional or consolidated instances of the edge aggregation nodes 1140 and the aggregation points 1142, 1144, including those deployed on a single server framework, may also be present within the edge cloud 910 or other areas of the TSP infrastructure. Advantageously, example location engines, VRLS managers, etc., as described herein may detect and/or otherwise determine locations of the client endpoints 1110 with improved performance and accuracy and reduced latency.

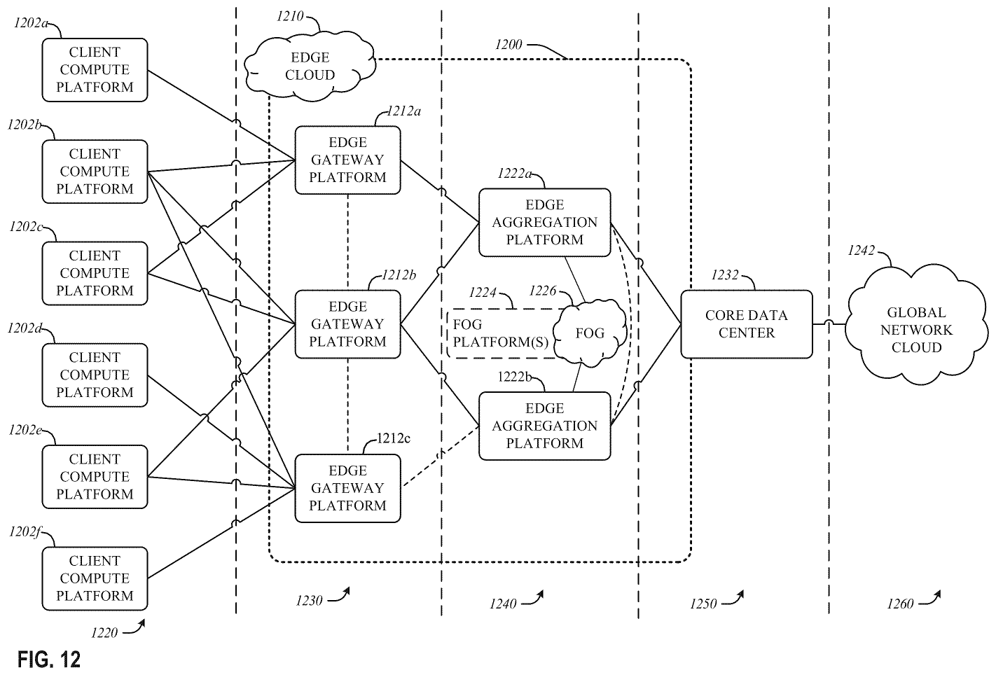

FIG. 12 depicts an example edge computing system 1200 for providing edge services and applications to multi-stakeholder entities, as distributed among one or more client compute platforms 1202, one or more edge gateway platforms 1212, one or more edge aggregation platforms 1222, one or more core data centers 1232, and a global network cloud 1242, as distributed across layers of the edge computing system 1200. For example, the edge computing system 1200 may provide edge services and applications to implement a VRLS event (e.g., an event in which one or more AR/VR devices share and/or otherwise engage in a common live stream). The implementation of the edge computing system 1200 may be provided at or on behalf of a telecommunication service provider (“telco”, or “TSP”), internet-of-things service provider, cloud service provider (CSP), enterprise entity, or any other number of entities. Various implementations and configurations of the edge computing system 1200 may be provided dynamically, such as when orchestrated to meet service objectives.

Individual platforms or devices of the edge computing system 1200 are located at a particular layer corresponding to layers 1220, 1230, 1240, 1250, and 1260. For example, the client compute platforms 1202a, 1202b, 1202c, 1202d, 1202e, 1202f are located at an endpoint layer 1220, while the edge gateway platforms 1212a, 1212b, 1212c are located at an edge devices layer 1230 (local level) of the edge computing system 1200. Additionally, the edge aggregation platforms 1222a, 1222b (and/or fog platform(s) 1224, if arranged or operated with or among a fog networking configuration 1226) are located at a network access layer 1240 (an intermediate level). Fog computing (or “fogging”) generally refers to extensions of cloud computing to the edge of an enterprise's network or to the ability to manage transactions across the cloud/edge landscape, typically in a coordinated distributed or multi-node network. Some forms of fog computing provide the deployment of compute, storage, and networking services between end devices and cloud computing data centers, on behalf of the cloud computing locations. Some forms of fog computing also provide the ability to manage the workload/workflow level services, in terms of the overall transaction, by pushing certain workloads to the edge or to the cloud based on the ability to fulfill the overall service level agreement.

Fog computing in many scenarios provides a decentralized architecture and serves as an extension to cloud computing by collaborating with one or more edge node devices, providing the subsequent amount of localized control, configuration and management, and much more for end devices. Furthermore, fog computing provides the ability for edge resources to identify similar resources and collaborate to create an edge-local cloud which can be used solely or in conjunction with cloud computing to complete computing, storage or connectivity related services. Fog computing may also allow the cloud-based services to expand their reach to the edge of a network of devices to offer local and quicker accessibility to edge devices. Thus, some forms of fog computing provide operations that are consistent with edge computing as discussed herein; the edge computing aspects discussed herein are also applicable to fog networks, fogging, and fog configurations. Further, aspects of the edge computing systems discussed herein may be configured as a fog, or aspects of a fog may be integrated into an edge computing architecture.

The core data center 1232 is located at a core network layer 1250 (a regional or geographically central level), while the global network cloud 1242 is located at a cloud data center layer 1260 (a national or world-wide layer). The use of “core” is provided as a term for a centralized network location-deeper in the network-which is accessible by multiple edge platforms or components; however, a “core” does not necessarily designate the “center” or the deepest location of the network. Accordingly, the core data center 1232 may be located within, at, or near the edge cloud 1210. Although an illustrative number of client compute platforms 1202a, 1202b, 1202c, 1202d, 1202e, 1202f; edge gateway platforms 1212a, 1212b, 1212c; edge aggregation platforms 1222a, 1222b; edge core data centers 1232; and global network clouds 1242 are shown in FIG. 12, it should be appreciated that the edge computing system 1200 may include any number of devices and/or systems at each layer. Devices at any layer can be configured as peer nodes and/or peer platforms to each other and, accordingly, act in a collaborative manner to meet service objectives. For example, in additional or alternative examples, the edge gateway platforms 1212a, 1212b, 1212c can be configured as an edge of edges such that the edge gateway platforms 1212a, 1212b, 1212c communicate via peer to peer connections. In some examples, the edge aggregation platforms 1222a, 1222b and/or the fog platform(s) 1224 can be configured as an edge of edges such that the edge aggregation platforms 1222a, 1222b and/or the fog platform(s) communicate via peer to peer connections. Additionally, as shown in FIG. 12, the number of components of respective layers 1220, 1230, 1240, 1250, and 1260 generally increases at each lower level (e.g., when moving closer to endpoints (e.g., client compute platforms 1202a, 1202b, 1202c, 1202d, 1202e, 1202f)). As such, one edge gateway platforms 1212a, 1212b, 1212c may service multiple ones of the client compute platforms 1202a, 1202b, 1202c, 1202d, 1202e, 1202f, and one edge aggregation platform (e.g., one of the edge aggregation platforms 1222a, 1222b) may service multiple ones of the edge gateway platforms 1212a, 1212b, 1212c.

Consistent with the examples provided herein, a client compute platform (e.g., one of the client compute platforms 1202a, 1202b, 1202c, 1202d, 1202e, 1202f) may be implemented as any type of endpoint component, device, appliance, or other thing capable of communicating as a producer or consumer of data (e.g., AR/VR devices). For example, a client compute platform can include a mobile phone, a laptop computer, a desktop computer, a processor platform in an autonomous vehicle, an AR/VR device, etc. In additional or alternative examples, a client compute platform can include a camera, a sensor, etc. Further, the label “platform,” “node,” and/or “device” as used in the edge computing system 1200 does not necessarily mean that such platform, node, and/or device operates in a client or slave role; rather, any of the platforms, nodes, and/or devices in the edge computing system 1200 refer to individual entities, platforms, nodes, devices, and/or subsystems which include discrete and/or connected hardware and/or software configurations to facilitate and/or use the edge cloud 1210. Advantageously, example location engines, VRLS managers, etc., as described herein may detect and/or otherwise determine locations of the client compute platforms 1202a, 1202b, 1202c, 1202d, 1202e, 1202f with improved performance and accuracy as well as with reduced latency.

As such, the edge cloud 1210 is formed from network components and functional features operated by and within the edge gateway platforms 1212a, 1212b, 1212c and the edge aggregation platforms 1222a, 1222b of layers 1230, 1240, respectively. The edge cloud 1210 may be implemented as any type of network that provides edge computing and/or storage resources which are proximately located to radio access network (RAN) capable endpoint devices (e.g., mobile computing devices, IoT devices, smart devices, etc.), which are shown in FIG. 12 as the client compute platforms 1202a, 1202b, 1202c, 1202d, 1202e, 1202f. In other words, the edge cloud 1210 may be envisioned as an “edge” which connects the endpoint devices and traditional network access points that serves as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

In some examples, the edge cloud 1210 may form a portion of, or otherwise provide, an ingress point into or across a fog networking configuration 1226 (e.g., a network of fog platform(s) 1224, not shown in detail), which may be implemented as a system-level horizontal and distributed architecture that distributes resources and services to perform a specific function. For instance, a coordinated and distributed network of fog platform(s) 1224 may perform computing, storage, control, or networking aspects in the context of an IoT system arrangement. Other networked, aggregated, and distributed functions may exist in the edge cloud 1210 between the core data center 1232 and the client endpoints (e.g., client compute platforms 1202a, 1202b, 1202c, 1202d, 1202e, 1202f). Some of these are discussed in the following sections in the context of network functions or service virtualization, including the use of virtual edges and virtual services which are orchestrated for multiple tenants.

As discussed in more detail below, the edge gateway platforms 1212a, 1212b, 1212c and the edge aggregation platforms 1222a, 1222b cooperate to provide various edge services and security to the client compute platforms 1202a, 1202b, 1202c, 1202d, 1202e, 1202f. Furthermore, because a client compute platforms (e.g., one of the client compute platforms 1202a, 1202b, 1202c, 1202d, 1202e, 1202f) may be stationary or mobile, a respective edge gateway platform 1212a, 1212b, 1212c may cooperate with other edge gateway platforms to propagate presently provided edge services, relevant service data, and security as the corresponding client compute platforms 1202a, 1202b, 1202c, 1202d, 1202e, 1202f moves about a region. To do so, the edge gateway platforms 1212a, 1212b, 1212c and/or edge aggregation platforms 1222a, 1222b may support multiple tenancy and multiple tenant configurations, in which services from (or hosted for) multiple service providers, owners, and multiple consumers may be supported and coordinated across a single or multiple compute devices.

In examples disclosed herein, edge platforms in the edge computing system 1200 include meta-orchestration functionality. For example, edge platforms at the far-edge (e.g., edge platforms closer to edge users, the edge devices layer 1230, etc.) can reduce the performance or power consumption of orchestration tasks associated with far-edge platforms so that the execution of orchestration components at far-edge platforms consumes a small fraction of the power and performance available at far-edge platforms.

The orchestrators at various far-edge platforms participate in an end-to-end orchestration architecture. Examples disclosed herein anticipate that the comprehensive operating software framework (such as, open network automation platform (ONAP) or similar platform) will be expanded, or options created within it, so that examples disclosed herein can be compatible with those frameworks. For example, orchestrators at edge platforms implementing examples disclosed herein can interface with ONAP orchestration flows and facilitate edge platform orchestration and telemetry activities. Orchestrators implementing examples disclosed herein act to regulate the orchestration and telemetry activities that are performed at edge platforms, including increasing or decreasing the power and/or resources expended by the local orchestration and telemetry components, delegating orchestration and telemetry processes to a remote computer and/or retrieving orchestration and telemetry processes from the remote computer when power and/or resources are available.

The remote devices described above are situated at alternative locations with respect to those edge platforms that are offloading telemetry and orchestration processes. For example, the remote devices described above can be situated, by contrast, at a near-edge platforms (e.g., the network access layer 1240, the core network layer 1250, a central office, a mini-datacenter, etc.). By offloading telemetry and/or orchestration processes at a near edge platforms, an orchestrator at a near-edge platform is assured of (comparatively) stable power supply, and sufficient computational resources to facilitate execution of telemetry and/or orchestration processes. An orchestrator (e.g., operating according to a global loop) at a near-edge platform can take delegated telemetry and/or orchestration processes from an orchestrator (e.g., operating according to a local loop) at a far-edge platform. For example, if an orchestrator at a near-edge platform takes delegated telemetry and/or orchestration processes, then at some later time, the orchestrator at the near-edge platform can return the delegated telemetry and/or orchestration processes to an orchestrator at a far-edge platform as conditions change at the far-edge platform (e.g., as power and computational resources at a far-edge platform satisfy a threshold level, as higher levels of power and/or computational resources become available at a far-edge platform, etc.).

A variety of security approaches may be utilized within the architecture of the edge cloud 1210. In a multi-stakeholder environment, there can be multiple loadable security modules (LSMs) used to provision policies that enforce the stakeholder's interests including those of tenants. In some examples, other operators, service providers, etc. may have security interests that compete with the tenant's interests. For example, tenants may prefer to receive full services (e.g., provided by an edge platform) for free while service providers would like to get full payment for performing little work or incurring little costs. Enforcement point environments could support multiple LSMs that apply the combination of loaded LSM policies (e.g., where the most constrained effective policy is applied, such as where if any of A, B or C stakeholders restricts access then access is restricted). Within the edge cloud 1210, each edge entity can provision LSMs that enforce the Edge entity interests. The cloud entity can provision LSMs that enforce the cloud entity interests. Likewise, the various fog and IoT network entities can provision LSMs that enforce the fog entity's interests.

In these examples, services may be considered from the perspective of a transaction, performed against a set of contracts or ingredients, whether considered at an ingredient level or a human-perceivable level. Thus, a user who has a service agreement with a service provider, expects the service to be delivered under terms of the SLA. Although not discussed in detail, the use of the edge computing techniques discussed herein may play roles during the negotiation of the agreement and the measurement of the fulfillment of the agreement (e.g., to identify what elements are required by the system to conduct a service, how the system responds to service conditions and changes, and the like).

Additionally, in examples disclosed herein, edge platforms and/or orchestration components thereof may consider several factors when orchestrating services and/or applications in an edge environment. These factors can include next-generation central office smart network functions virtualization and service management, improving performance per watt at an edge platform and/or of orchestration components to overcome the limitation of power at edge platforms, reducing power consumption of orchestration components and/or an edge platform, improving hardware utilization to increase management and orchestration efficiency, providing physical and/or end to end security, providing individual tenant quality of service and/or service level agreement satisfaction, improving network equipment-building system compliance level for each use case and tenant business model, pooling acceleration components, and billing and metering policies to improve an edge environment.

A “service” is a broad term often applied to various contexts, but in general, it refers to a relationship between two entities where one entity offers and performs work for the benefit of another. However, the services delivered from one entity to another must be performed with certain guidelines, which ensure trust between the entities and manage the transaction according to the contract terms and conditions set forth at the beginning, during, and end of the service.

An example relationship among services for use in an edge computing system is described below. In scenarios of edge computing, there are several services, and transaction layers in operation and dependent on each other—these services create a “service chain”. At the lowest level, ingredients compose systems. These systems and/or resources communicate and collaborate with each other in order to provide a multitude of services to each other as well as other permanent or transient entities around them. In turn, these entities may provide human-consumable services. With this hierarchy, services offered at each tier must be transactionally connected to ensure that the individual component (or sub-entity) providing a service adheres to the contractually agreed to objectives and specifications. Deviations at each layer could result in overall impact to the entire service chain.

One type of service that may be offered in an edge environment hierarchy is Silicon Level Services. For instance, Software Defined Silicon (SDSi)-type hardware provides the ability to ensure low level adherence to transactions, through the ability to intra-scale, manage and assure the delivery of operational service level agreements. Use of SDSi and similar hardware controls provide the capability to associate features and resources within a system to a specific tenant and manage the individual title (rights) to those resources. Use of such features is among one way to dynamically “bring” the compute resources to the workload.

For example, an operational level agreement and/or service level agreement could define “transactional throughput” or “timeliness”—in case of SDSi, the system and/or resource can sign up to guarantee specific service level specifications (SLS) and objectives (SLO) of a service level agreement (SLA). For example, SLOs can correspond to particular key performance indicators (KPIs) (e.g., frames per second, floating point operations per second, latency goals, etc.) of an application (e.g., service, workload, etc.) and an SLA can correspond to a platform level agreement to satisfy a particular SLO (e.g., one gigabyte of memory for 10 frames per second). SDSi hardware also provides the ability for the infrastructure and resource owner to empower the silicon component (e.g., components of a composed system that produce metric telemetry) to access and manage (add/remove) product features and freely scale hardware capabilities and utilization up and down. Furthermore, it provides the ability to provide deterministic feature assignments on a per-tenant basis. It also provides the capability to tie deterministic orchestration and service management to the dynamic (or subscription based) activation of features without the need to interrupt running services, client operations or by resetting or rebooting the system.

At the lowest layer, SDSi can provide services and guarantees to systems to ensure active adherence to contractually agreed-to service level specifications that a single resource has to provide within the system. Additionally, SDSi provides the ability to manage the contractual rights (title), usage and associated financials of one or more tenants on a per component, or even silicon level feature (e.g., SKU features). Silicon level features may be associated with compute, storage or network capabilities, performance, determinism or even features for security, encryption, acceleration, etc. These capabilities ensure not only that the tenant can achieve a specific service level agreement, but also assist with management and data collection, and assure the transaction and the contractual agreement at the lowest manageable component level.

At a higher layer in the services hierarchy, Resource Level Services, includes systems and/or resources which provide (in complete or through composition) the ability to meet workload demands by either acquiring and enabling system level features via SDSi, or through the composition of individually addressable resources (compute, storage and network). At yet a higher layer of the services hierarchy, Workflow Level Services, is horizontal, since service-chains may have workflow level requirements. Workflows describe dependencies between workloads in order to deliver specific service level objectives and requirements to the end-to-end service. These services may include features and functions like high-availability, redundancy, recovery, fault tolerance or load-leveling (we can include lots more in this). Workflow services define dependencies and relationships between resources and systems, describe requirements on associated networks and storage, as well as describe transaction level requirements and associated contracts in order to assure the end-to-end service. Workflow Level Services are usually measured in Service Level Objectives and have mandatory and expected service requirements.

At yet a higher layer of the services hierarchy, Business Functional Services (BFS) are operable, and these services are the different elements of the service which have relationships to each other and provide specific functions for the customer. In the case of Edge computing and within the example of Autonomous Driving, business functions may be composing the service, for instance, of a “timely arrival to an event”—this service would require several business functions to work together and in concert to achieve the goal of the user entity: GPS guidance, RSU (Road Side Unit) awareness of local traffic conditions, Payment history of user entity, Authorization of user entity of resource(s), etc. Furthermore, as these BFS(s) provide services to multiple entities, each BFS manages its own SLA and is aware of its ability to deal with the demand on its own resources (Workload and Workflow). As requirements and demand increases, it communicates the service change requirements to Workflow and resource level service entities, so they can, in-turn provide insights to their ability to fulfill. This step assists the overall transaction and service delivery to the next layer.

At the highest layer of services in the service hierarchy, Business Level Services (BLS), is tied to the capability that is being delivered. At this level, the customer or entity might not care about how the service is composed or what ingredients are used, managed, and/or tracked to provide the service(s). The primary objective of business level services is to attain the goals set by the customer according to the overall contract terms and conditions established between the customer and the provider at the agreed to a financial agreement. BLS(s) are comprised of several Business Functional Services (BFS) and an overall SLA.

This arrangement and other service management features described herein are designed to meet the various requirements of edge computing with its unique and complex resource and service interactions. This service management arrangement is intended to inherently address several of the resource basic services within its framework, instead of through an agent or middleware capability. Services such as: locate, find, address, trace, track, identify, and/or register may be placed immediately in effect as resources appear on the framework, and the manager or owner of the resource domain can use management rules and policies to ensure orderly resource discovery, registration and certification.

Moreover, any number of edge computing architectures described herein may be adapted with service management features. These features may enable a system to be constantly aware and record information about the motion, vector, and/or direction of resources as well as fully describe these features as both telemetry and metadata associated with the devices. These service management features can be used for resource management, billing, and/or metering, as well as an element of security. The same functionality also applies to related resources, where a less intelligent device, like a sensor, might be attached to a more manageable resource, such as an edge gateway. The service management framework is made aware of change of custody or encapsulation for resources. Since nodes and components may be directly accessible or be managed indirectly through a parent or alternative responsible device for a short duration or for its entire lifecycle, this type of structure is relayed to the service framework through its interface and made available to external query mechanisms.

Additionally, this service management framework is always service aware and naturally balances the service delivery requirements with the capability and availability of the resources and the access for the data upload the data analytics systems. If the network transports degrade, fail or change to a higher cost or lower bandwidth function, service policy monitoring functions provide alternative analytics and service delivery mechanisms within the privacy or cost constraints of the user. With these features, the policies can trigger the invocation of analytics and dashboard services at the edge ensuring continuous service availability at reduced fidelity or granularity. Once network transports are re-established, regular data collection, upload and analytics services can resume.

The deployment of a multi-stakeholder edge computing system may be arranged and orchestrated to enable the deployment of multiple services and virtual edge instances, among multiple edge platforms and subsystems, for use by multiple tenants and service providers. In a system example applicable to a cloud service provider (CSP), the deployment of an edge computing system may be provided via an “over-the-top” approach, to introduce edge computing platforms as a supplemental tool to cloud computing. In a contrasting system example applicable to a telecommunications service provider (TSP), the deployment of an edge computing system may be provided via a “network-aggregation” approach, to introduce edge computing platforms at locations in which network accesses (from different types of data access networks) are aggregated. However, these over-the-top and network aggregation approaches may be implemented together in a hybrid or merged approach or configuration.

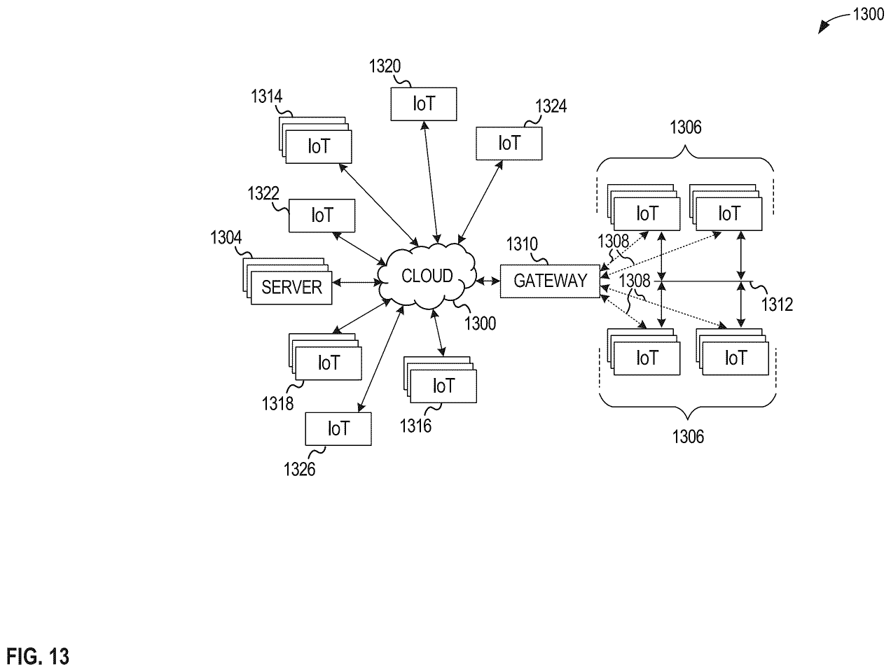

FIG. 13 illustrates a drawing of a cloud computing network, or cloud 1300, in communication with a number of Internet of Things (IoT) devices. The cloud 1300 may represent the Internet, or may be a local area network (LAN), or a wide area network (WAN), such as a proprietary network for a company. The IoT devices may include any number of different types of devices, grouped in various combinations. For example, a traffic control group 1306 may include IoT devices along streets in a city. These IoT devices may include stoplights, traffic flow monitors, cameras, weather sensors, and the like. The traffic control group 1306, or other subgroups, may be in communication with the cloud 1300 through wired or wireless links 1308, such as LPWA links, and the like. Further, a wired or wireless sub-network 1312 may allow the IoT devices to communicate with each other, such as through a local area network, a wireless local area network, and the like. The IoT devices may use another device, such as a gateway 1310 or 1328 to communicate with remote locations such as the cloud 1300; the IoT devices may also use one or more servers 1330 to facilitate communication with the cloud 1300 or with the gateway 1310. For example, the one or more servers 1330 may operate as an intermediate network node to support a local Edge cloud or fog implementation among a local area network. Further, the gateway 1328 that is depicted may operate in a cloud-to-gateway-to-many Edge devices configuration, such as with the various IoT devices 1314, 1320, 1324 being constrained or dynamic to an assignment and use of resources in the cloud 1300.

Other example groups of IoT devices may include remote weather stations 1314, local information terminals 1316, alarm systems 1318, automated teller machines 1320, alarm panels 1322, or moving vehicles, such as emergency vehicles 1324 or other vehicles 1326, among many others. Each of these IoT devices may be in communication with other IoT devices, with servers 1304, with another IoT fog device, or a combination therein. The groups of IoT devices may be deployed in various residential, commercial, and industrial settings (including in both private or public environments). Advantageously, example VRLS managers as described herein may achieve location detection of one(s) of the IoT devices of the traffic control group 1306, one(s) of the IoT devices 1314, 1316, 1318, 1320, 1322, 1324, 1326, etc., and/or a combination thereof with improved performance, improved accuracy, and/or reduced latency. In some examples, the one(s) of the IoT devices 1314, 1316, 1318, 1320, 1322, 1324, 1326 may be an AR/VR device. Advantageously, example VRLS managers as described herein may achieve a live stream of an AR/VR event with improved performance (e.g., reduced jitter), improved accuracy (e.g., increase in location and/or position precision of the AR/VR device), and/or reduced latency.

As may be seen from FIG. 13, a large number of IoT devices may be communicating through the cloud 1300. This may allow different IoT devices to request or provide information to other devices autonomously. For example, a group of IoT devices (e.g., the traffic control group 1306) may request a current weather forecast from a group of remote weather stations 1314, which may provide the forecast without human intervention. Further, an emergency vehicle 1324 may be alerted by an automated teller machine 1320 that a burglary is in progress. As the emergency vehicle 1324 proceeds towards the automated teller machine 1320, it may access the traffic control group 1306 to request clearance to the location, for example, by lights turning red to block cross traffic at an intersection in sufficient time for the emergency vehicle 1324 to have unimpeded access to the intersection.

Clusters of IoT devices, such as the remote weather stations 1314 or the traffic control group 1306, may be equipped to communicate with other IoT devices as well as with the cloud 1300. This may allow the IoT devices to form an ad-hoc network between the devices, allowing them to function as a single device, which may be termed a fog device or system (e.g., as described above with reference to FIG. 12). In some examples in which ones of the IoT devices 1314, 1316, 1318, 1320, 1322, 1324, 1326 are AR/VR devices, the AR/VR devices may form an ad-hoc network between themselves and/or in coordination with edge server(s), cloud server(s), etc., and/or any combination(s) thereof, allowing the AR/VR devices to implement a single live stream for collaborative or collective engagement and/or interaction.

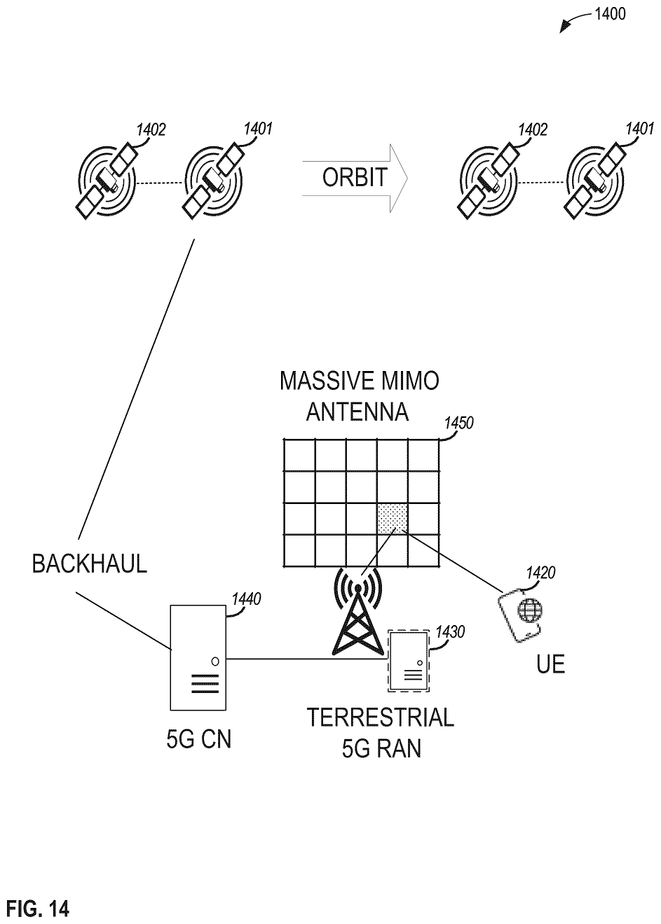

FIG. 14 illustrates network connectivity in non-terrestrial (satellite) and terrestrial (mobile cellular network) settings, according to an example. As shown, a satellite constellation may include multiple satellites 1401, 1402, which are connected to each other and to one or more terrestrial networks. Specifically, the satellite constellation is connected to a backhaul network, which is in turn connected to a 5G core network 1440 (identified by 5G CN). The 5G core network is used to support 5G communication operations at the satellite network and at a terrestrial 5G radio access network (RAN) 1430.

FIG. 14 also depicts the use of the terrestrial 5G RAN 1430, to provide radio connectivity to a user equipment (UE) 1420 via a massive multiple input, multiple output (MIMO) antenna 1450. For example, the UE 1420 may be implemented using an AR/VR device capable of communicating with another device using or more different types of wireless technologies (e.g., 5G/6G cellular, Wi-Fi, satellite, etc.). It will be understood that a variety of network communication components and units are not depicted in FIG. 14 for purposes of simplicity. With these basic entities in mind, the following techniques describe ways in which terrestrial and satellite networks can be extended for various Edge computing scenarios such as facilitating VRLS events. Alternatively, the illustrated example of FIG. 14 may be applicable to other cellular technologies (e.g., 6G and the like).

Flowcharts representative of example hardware logic circuitry, machine-readable instructions, hardware implemented state machines, and/or any combination thereof for implementing the VRLS event management circuitry 800 of FIG. 8 are shown in FIGS. 15-20. The machine-readable instructions may be one or more executable programs or portion(s) of an executable program for execution by processor circuitry, such as the processor 2152 shown in the example processing device 2150 discussed below in connection with FIG. 21, the processor circuitry 2212 shown in the example processor platform 2200 discussed below in connection with FIG. 22, and/or the example processor circuitry discussed below in connection with FIGS. 23 and/or 24. The program may be embodied in software stored on one or more non-transitory computer-readable storage media such as a compact disk (CD), a floppy disk, a hard disk drive (HDD), a solid-state drive (SSD), a DVD, a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a RAN gateway that may facilitate communication between a server and an endpoint client hardware device). Similarly, the non-transitory computer-readable storage media may include one or more mediums located in one or more hardware devices. Further, although the example program is described with reference to the flowcharts illustrated in FIGS. 15-20, many other methods of implementing the example VRLS management circuitry 800 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 15-20 may be implemented using executable instructions (e.g., computer and/or machine-readable instructions) stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer-readable medium and non-transitory computer-readable storage medium are expressly defined to include any type of computer-readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 15 is a flowchart representative of example machine-readable instructions and/or example operations 1500 that may be executed and/or instantiated by processor circuitry to at least one of execute or instantiate an instance of a virtual reality live stream application. The example machine-readable instructions and/or the example operations 1500 of FIG. 15 begin at block 1502, at which the VRLS management circuitry 800 determines a location of a virtual reality device based on location data associated with the virtual reality device. For example, the location determination circuitry 830 (FIG. 8) can determine a location of the first client 102 of FIG. 1 based on the location data 874 associated with the first client 102, which can include at least one of TOA data, AOA data, RTT data, or TDOA data associated with the first client 102.

At block 1504, the VRLS management circuitry 800 identifies a guardian boundary of the virtual reality device based on credentials associated with the virtual reality device. For example, credentials associated with a virtual reality device can include a token (e.g., a virtual and/or cryptographic token, an authorization token to gain access to a VRLS event, a cryptographically or electronically signed datum, etc.) indicating a CCGB and/or an LCGB corresponding to the VRLS event. In such examples, the access determination circuitry 840 can obtain tokens associated with virtual reality devices requesting access to the VRLS event and look up location data that corresponds to and/or is associated with the token. For example, the access determination circuitry 840 (FIG. 8) can determine that the location data 874 corresponds to and/or is associated with the CCGB 134 of FIG. 1 corresponding to the VRLS event.

At block 1506, the VRLS management circuitry 800 determines whether the location is in (e.g., satisfies) the guardian boundary. For example, the access determination circuitry 840 can determine that the location data 874 associated with the first client 102 indicates and/or identifies that the first client 102 is within and/or included in (e.g., satisfies) the CCGB 134 of FIG. 1. In some examples, the access determination circuitry 840 examines the location data 874 to determine location coordinates of the first client 102 and determine whether the location coordinates satisfy (e.g., are included in) a geographic area defined by the CCGB 134 of FIG. 1. In some such examples, if the location coordinates satisfy the guardian boundary, the access determination circuitry 840 determines that first client 102 is within and/or included in the CCGB 134.

If, at block 1506, the VRLS management circuitry 800 determines that the location is not in the guardian boundary, the example machine-readable instructions and/or the example operations 1500 of FIG. 15 conclude. Otherwise, control proceeds to block 1508.

At block 1508, the VRLS management circuitry 800 at least one of executes or instantiates an instance of a virtual reality live stream application. For example, the VRLS engagement circuitry 860 (FIG. 8) can at least one of execute or instantiate the VR cast 130 of FIG. 1 of which the first client 102 can engage with and/or participate in. After execution or instantiation of an instance of a virtual reality live stream application at block 1508, the example machine-readable instructions and/or the example operations 1500 of FIG. 15 conclude. In some examples, the example machine-readable instructions and/or the example operations 1500 of FIG. 15 are repeatedly executed and/or instantiated by the VRLS management circuitry 800 so that the VRLS management circuitry 800 can determine whether one or more clients are with respective guardian boundaries throughout a VR live stream.

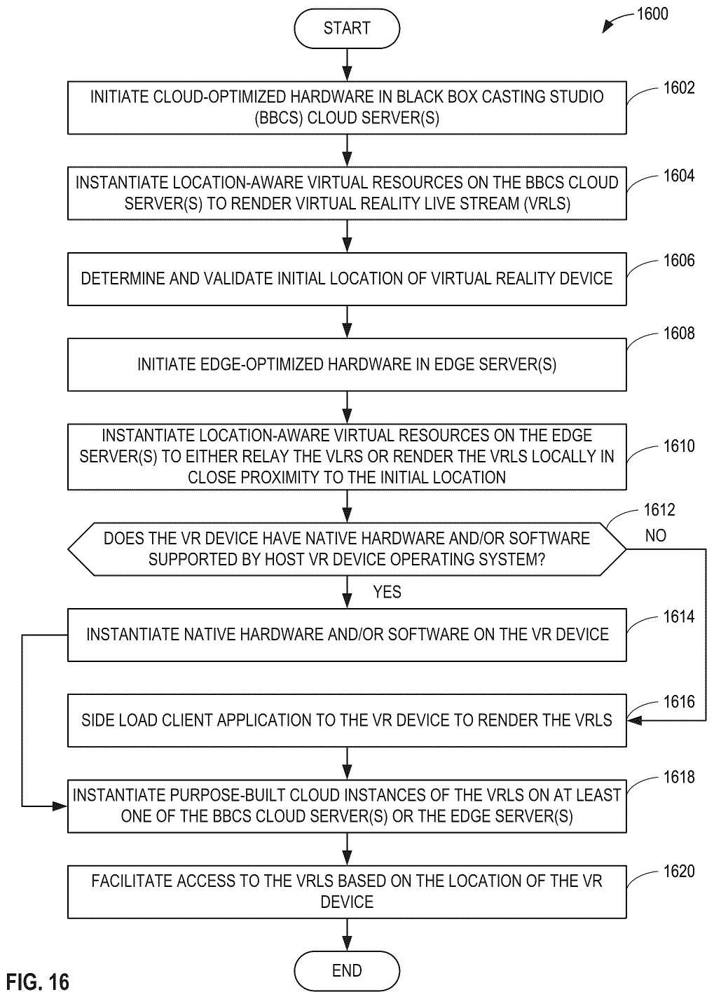

FIG. 16 is a flowchart representative of example machine-readable instructions and/or example operations 1600 that may be executed and/or instantiated by processor circuitry to instantiate hardware and/or software for virtual reality live streaming. The example machine-readable instructions and/or the example operations 1600 of FIG. 16 begin at block 1602, at which the VRLS management circuitry 800 initiates cloud-optimized hardware in black box casting studio (BBCS) cloud server(s). For example, the resource instantiation circuitry 820 (FIG. 8) can power, enable, and/or initiate cloud-optimized CPUs, FPGAs, network interface circuitry, etc., in the cloud server 120 of FIG. 1.

At block 1604, the VRLS management circuitry 800 instantiates location-aware virtual resources on the BBCS cloud server(s) to render a virtual reality live stream (VRLS). For example, the resource instantiation circuitry 820 can spin up, instantiate, etc., a VM, a container, etc., corresponding to a purpose-built cloud instance of the VRLS.

At block 1606, the VRLS management circuitry 800 determines and validates an initial location of a virtual reality device. For example, the location determination circuitry 830 (FIG. 8) can determine a location of the first client 102 and validate the location based on the location being within the CCGB 134.

At block 1608, the VRLS management circuitry 800 initiates edge-optimized hardware in edge server(s). For example, the resource instantiation circuitry 820 can power, enable, and/or initiate edge-optimized CPUs, FPGAs, network interface circuitry, etc., in the edge server 108 of FIG. 1.

At block 1610, the VRLS management circuitry 800 instantiates location-aware virtual resources on the edge server(s) to either relay the VRLS or render the VRLS locally in close proximity to the initial location. For example, the resource instantiation circuitry 820 can spin up and/or instantiate virtual resources on the edge server 118 to relay and/or render the VR cast 130 to the first client 102. In some examples, the edge server 118 is in close proximity (e.g., same postal code, same city, etc.) to the first client 102 to reduce latency and improve performance of the rendering and/or relaying of the VR cast 130.

At block 1612, the VRLS management circuitry 800 determines whether the VR device has native hardware and/or software supported by a host VR device operating system. For example, the resource instantiation circuitry 820 can determine whether the first client 102 has hardware and/or software that is native and/or otherwise developed for use on a VR device corresponding to the first client 102.

If, at block 1612, the VRLS management circuitry 800 determines that the VR device has native hardware and/or software, control proceeds to block 1614. At block 1614, the VRLS management circuitry 800 instantiates native hardware and/or software on the VR device. For example, the resource instantiation circuitry 820 can instantiate hardware and/or software of the first client 102 that is native and/or otherwise developed for use on a particular platform or device. In response to instantiating the native hardware and/or software on the VR device at block 1614, control proceeds to block 1618.

If, at block 1612, the VRLS management circuitry 800 determines that the VR device does not have native hardware and/or software, control proceeds to block 1616. At block 1616, the VRLS management circuitry 800 side loads a client application to the VR device to render the VRLS. For example, the interface circuitry 810 (FIG. 8) can receive the client application from a hardware device (e.g., a Secure Digital (SD) card, a USB device, or other type of storage). In response to side loading the client application to the VR device to render the VRLS at block 1616, control proceeds to block 1618.

At block 1618, the VRLS management circuitry 800 instantiates purpose-built cloud instances of the VRLS on at least one of the BBCS cloud server(s) or the edge server(s). For example, the resource instantiation circuitry 820 can instantiate purpose-built cloud instances of the VR cast 130 on at least one of the edge server 118 or the cloud server 120 of FIG. 1.

At block 1620, the VRLS management circuitry 800 facilitates access to the VRLS based on the location of the VR device. For example, the location determination circuitry 830 can determine a location of the first client 102. In some examples, the access determination circuitry 840 (FIG. 8) can grant (e.g., periodically grant or re-check the authorization of the first client 102) access of the first client 102 to the VR cast 130 based on the location of the first client 102. In response to facilitating access to the VRLS based on the location of the VR device at block 1620, the example machine-readable instructions and/or the example operations 1600 of FIG. 16 conclude.

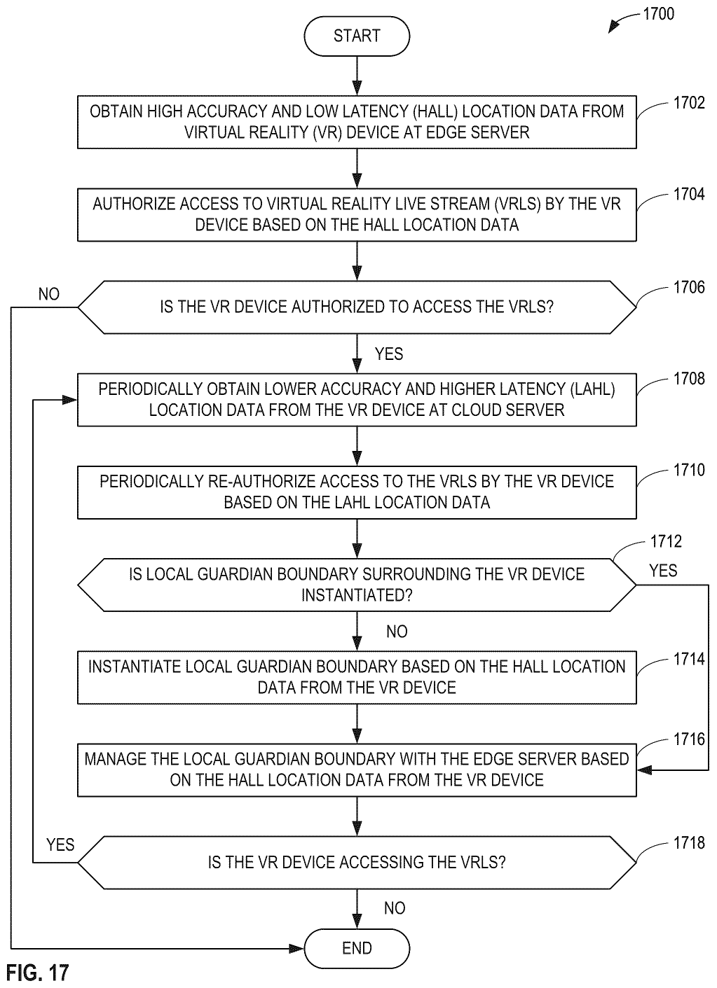

FIG. 17 is a flowchart representative of example machine-readable instructions and/or example operations 1700 that may be executed and/or instantiated by processor circuitry to effectuate multi-tier location authorization for virtual reality live streaming. The example machine-readable instructions and/or the example operations 1700 of FIG. 17 begin at block 1702, at which the VRLS management circuitry 800 obtains high accuracy and low latency (HALL) location data from a virtual reality (VR) device at an edge server. For example, the interface circuitry 810 (FIG. 8) can receive TDOA with RTT data and/or AOA data associated with the first client 302 of FIG. 3 from the cellular network 306 of FIG. 3.

At block 1704, the VRLS management circuitry 800 authorizes access to a virtual reality live stream (VRLS) by the VR device based on the HALL location data. For example, the access determination circuitry 840 (FIG. 8) can authorize and/or otherwise grant access to the VRLS by the first client 302 based on the HALL location data associated with the first client 302.

At block 1706, the VRLS management circuitry 800 determines whether the VR device is authorized to access the VRLS. If, at block 1706, the VRLS management circuitry 1800 determines that the VR device is not authorized to access the VRLS, the example machine-readable instructions and/or the example operations 1700 of FIG. 17 conclude. Otherwise, control proceeds to block 1708.

At block 1708, the VRLS management circuitry 800 periodically obtains lower accuracy and higher latency (LAHL) location data from the VR device at a cloud server. For example, after an initial authorization and/or location determination of the first client 302, the access determination circuitry 840 can offload and/or transfer authorization determinations to the cloud server 310 to free bandwidth of the MEC network 308 for other workloads, such as HALL positioning data to continuously update a location/position of the first client 302 within a LCGB associated with the first client 302.

At block 1710, the VRLS management circuitry 800 periodically re-authorizes access to the VRLS by the VR device based on the LAHL location data. For example, the access determination circuitry 840 can periodically re-authorize access to the VRLS by the first client 302 based on UL-TDOA with RTT data at the cloud server 310.

At block 1712, the VRLS management circuitry 800 determines whether a local guardian boundary surrounding the VR device is instantiated. For example, the VRLS engagement circuitry 860 (FIG. 8) can determine whether the LCGB 136 of FIG. 1 is configured, set up, and/or otherwise instantiated for the first client 102 of FIG. 1, the first client 302 of FIG. 3, etc.

If, at block 1712, the VRLS management circuitry 800 determines that a local guardian boundary surrounding the VR device is instantiated, control proceeds to block 1716. Otherwise, control proceeds to block 1714. At block 1714, the VRLS management circuitry 800 instantiates a local guardian boundary based on the HALL location data from the VR device. For example, the VRLS engagement circuitry 860 can instantiate the LCGB 136 of FIG. 1, the local guardian boundaries 614, 616 of FIG. 6, etc.

At block 1716, the VRLS management circuitry 800 manages the local guardian boundary with the edge server based on the HALL location data from the VR device. For example, the VRLS engagement circuitry 860 can determine whether the first client 102 has left, re-entered, or remained within the LCGB 136 associated with the first client 102 based on the HALL location result using location and positioning techniques (e.g., UL-TDOA with RTT or AOA location approaches). In some examples, the location determination circuitry 830 (FIG. 8) may utilize AR/VR device L1 UL-SRS and/or DL-PRS to support positioning algorithms or techniques based on the levels of accuracy, coverage, and interference avoidance at that instance or moment in time.

At block 1718, the VRLS management circuitry 800 determines whether the VR device is accessing the VRLS. If, at block 1718, the VRLS management circuitry 800 determines that the VR device is accessing the VRLS, control returns to block 1708. Otherwise the example machine-readable instructions and/or the example operations 1700 of FIG. 17 conclude.

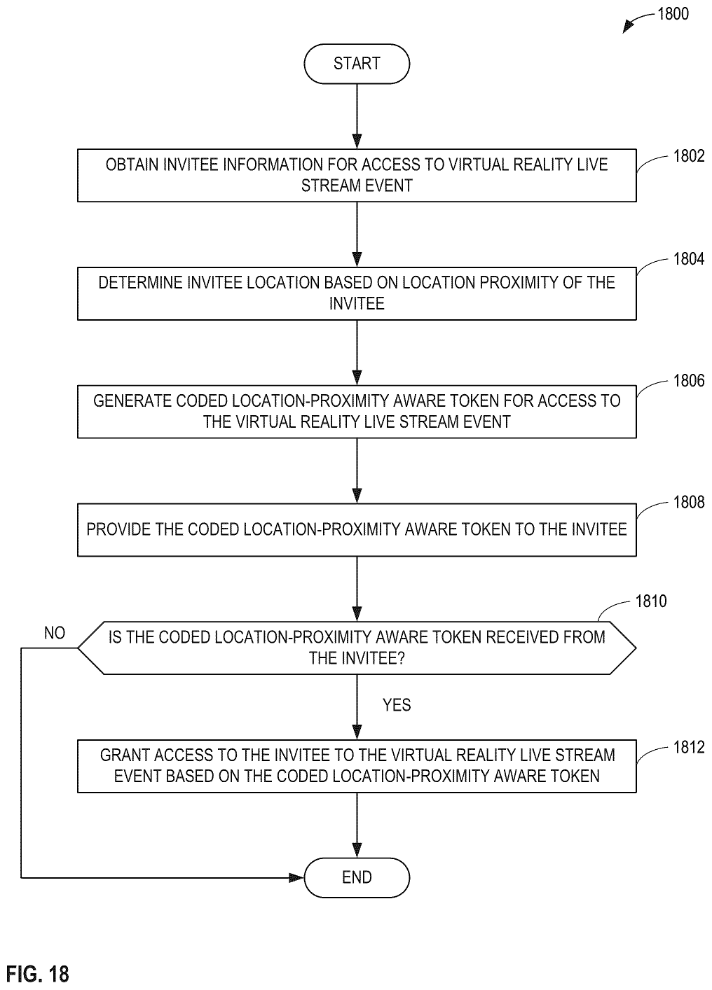

FIG. 18 is a flowchart representative of example machine-readable instructions and/or example operations 1800 that may be executed and/or instantiated by processor circuitry to effectuate access to a virtual reality live stream event. The example machine-readable instructions and/or the example operations 1800 of FIG. 18 begin at block 1802, at which the VRLS management circuitry 800 obtains invitee information for access to a virtual reality live stream. For example, the access determination circuitry 840 (FIG. 8) can obtain one of the VR profile(s) 876 (FIG. 8) from the first client 302 of FIG. 3.

At block 1804, the VRLS management circuitry 800 determines an invitee location based on a location proximity of the invitee. For example, the interface circuitry 810 (FIG. 8) can obtain location data associated with the first client 302 of FIG. 3 from the cellular network 306 of FIG. 3. The location determination circuitry 830 (FIG. 8) can determine the location of the first client 302 based on the location data. The resource instantiation circuitry 820 (FIG. 8) can identify one or more edge servers in location proximity the first client 302.

At block 1806, the VRLS management circuitry 800 generates a coded location-proximity aware token for access to the virtual reality live stream event. For example, the access determination circuitry 840 (FIG. 8) can generate a first set of the credentials 878 (FIG. 8) for use by the first client 302 to access the virtual reality live stream event.

At block 1808, the VRLS management circuitry 800 provides the coded location-proximity aware token to the invitee. For example, the interface circuitry 810 can transmit the first set of the credentials 878 to the first client 302 via a network.

At block 1810, the VRLS management circuitry 800 determines whether the coded location-proximity aware token received from the invitee. For example, at or after a start time of the VRLS event, the interface circuitry 810 can determine whether the first set of the credentials 878 have been received from the first client 302.

If, at block 1810, the VRLS management circuitry 800 determines that the coded location-proximity aware token is not received from the invitee, the example machine-readable instructions and/or the example operations 1800 conclude. Otherwise, control proceeds to block 1812. At block 1812, the VRLS management circuitry 800 grants access to the invitee to the virtual reality live stream event based on the coded location-proximity aware token. For example, the access determination circuitry 840 can authorize the first client 302 for access to the virtual reality live stream event after a determination that the location of the first client 302 is within a CCGB of the VRLS event, such as the CCGB 134 of FIG. 1. For example, the first set of the credentials 878 can include an indication that the first client 302 is to access the VRLS event within and/or at the confines of the CCGB 134.

After granting access to the invitee to the virtual reality live stream event based on the coded location-proximity aware token at block 1812, the example machine-readable instructions and/or the example operations 1800 conclude. In some examples, the example machine-readable instructions and/or the example operations 1800 of FIG. 18 are repeatedly executed and/or instantiated by the VRLS management circuitry 800 so that the VRLS management circuitry 800 can determine whether respective coded location-proximity aware tokens have been received from one or more invitees a VR live stream.

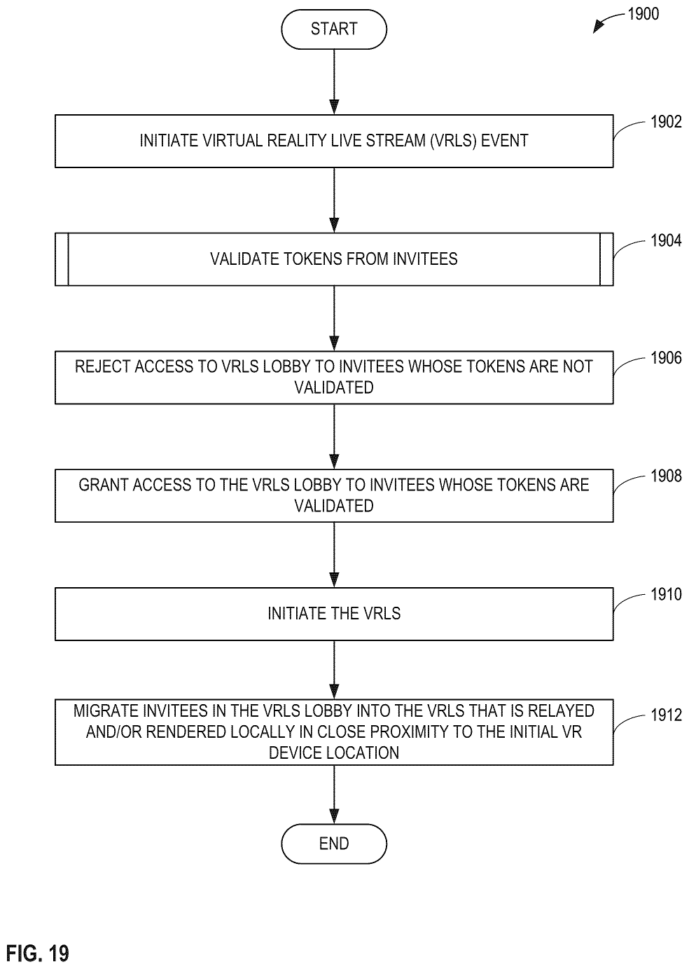

FIG. 19 is a flowchart representative of example machine-readable instructions and/or example operations 1900 that may be executed and/or instantiated by processor circuitry to initiate a virtual reality live stream event. The example machine-readable instructions and/or the example operations 1900 of FIG. 19 begin at block 1902, at which the VRLS management circuitry 800 initiates a virtual reality live stream (VRLS) event. For example, the VRLS engagement circuitry 860 (FIG. 8) can instantiate a purpose-built cloud instance of the VR cast 130 of FIG. 1.

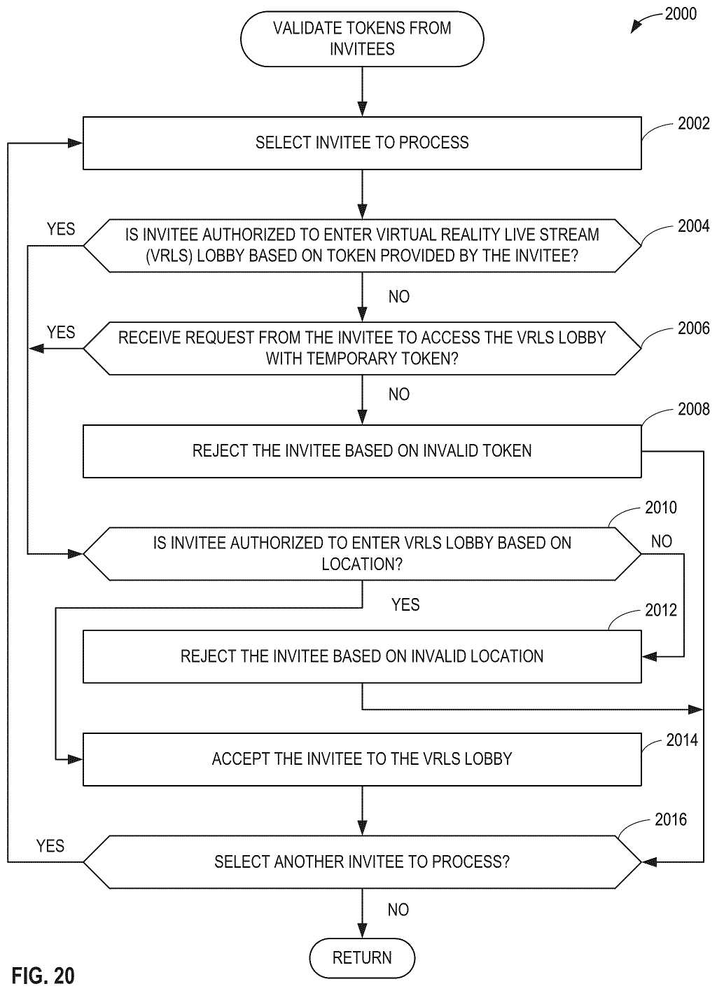

At block 1904, the VRLS management circuitry 800 validates tokens from invitees. For example, the access determination circuitry 840 (FIG. 8) can validate cryptographically and/or electronically signed datums associated with one(s) of the clients 102, 104, 106, 108, 110, 112, 114, 116 of FIG. 1 who intend or desire to join the VRLS. In some examples, the access determination circuitry 840 (FIG. 8) validates a plurality of tokens from a plurality of invitees in parallel (e.g., as a multi-threaded task). An example process that may be executed and/or instantiated by processor circuitry to implement block 1904 is described below in connection with FIG. 20.

At block 1906, the VRLS management circuitry 800 rejects access to a VRLS lobby to invitees whose tokens are not validated. For example, the access determination circuitry 840 may not validate tokens from the third client 102, the fourth client 108, and the fifth client 110 of FIG. 1. In some examples, the VRLS event management circuitry 850 (FIG. 8) can reject access by the third client 106, the fourth client 108, and the fifth client 110 of FIG. 1 to the VRLS lobby of the VRLS.

At block 1908, the VRLS management circuitry 800 grants access to the VRLS lobby to invitees whose tokens are validated. For example, the access determination circuitry 840 may validate tokens from the first client 102 and the second client 104 of FIG. 1. In some examples, the VRLS event management circuitry 850 can grant access by the first client 102 and the second client 104 of FIG. 1 to the VRLS lobby of the VRLS.

At block 1910, the VRLS management circuitry 800 initiates the VRLS. For example, the VRLS engagement circuitry 860 can execute and/or instantiate the purpose-built cloud instances of the VR cast 130 of FIG. 1 based on location data associated with the first client 102 and the second client 104 (e.g., the clients that were granted access to the VRLS). In additional or alternative examples, the VRLS engagement circuitry 860 selects one or more resources of the edge network 118 and/or one or more resources of the cloud network 120 at which to execute and/or instantiate the purpose-built cloud instance of the VR cast 130 based on location data associated with the first client 102 and the second client 104. For example, the VRLS engagement circuitry 860 selects one or more resources of the edge network 118 and/or one or more resources of the cloud network 120 that are at a location (e.g., an edge node, a datacenter, etc.) that reduces (e.g., minimizes) the respective distances between the one or more resources of the edge network 118 and/or the one or more resources of the cloud network 120 and each of the first client 102 and the second client 104. In this manner, compute resources executing and/or instantiating the purpose-built cloud instance of the VR cast 130 are distributed across the edge network 118 and/or the cloud network 120 serviced by the public/private network provider such that the compute resources are in close proximity to the first client 102 and the second client 104 (e.g., in as close proximity as possible given the locations of the first client 102 and the second client 104). As such, latency associated with accessing the VR cast 130 with the first client 102 and the second client 104 is reduced by rendering the VR cast 130 in close proximity to the first client 102 and the second client 104.

At block 1912, the VRLS management circuitry 800 migrates invitees in the VRLS lobby into the VRLS that is relayed and/or rendered locally in close proximity to the initial VR device location. For example, the VRLS engagement circuitry 860 can migrate, transition, and/or move the invitees in the VRLS lobby into the VRLS. In some examples, the edge server 118 of FIG. 1 can render and/or relay the VRLS locally in close proximity to the initial location of the first client 102, the second client 104, etc. After the migration of the invitees in the VRLS lobby into the VRLS at block 1912, the example machine-readable instructions and/or the example operations 1900 conclude.

FIG. 20 is a flowchart representative of example machine-readable instructions and/or example operations 2000 that may be executed and/or instantiated by processor circuitry to validate tokens from invitees. The example machine-readable instructions and/or the example operations 2000 of FIG. 20 may be executed and/or instantiated by processor circuitry to implement block 1904 of FIG. 19. As described above, in some examples, the example machine-readable instructions and/or the example operations 2000 of FIG. 20 may be executed and/or instantiated by processor circuitry in parallel (e.g., as a multi-threaded task). The example machine-readable instructions and/or the example operations 2000 of FIG. 20 begin at block 2002, at which the VRLS management circuitry 800 selects an invitee to process. For example, the access determination circuitry 840 (FIG. 8) can select a first invitee corresponding to the first client 102 of FIG. 1 to process.

At block 2004, the VRLS management circuitry 800 determines whether the invitee is authorized to enter a virtual reality live stream (VRLS) lobby based on a token provided by the invitee. For example, the access determination circuitry 840 can determine that the token is valid or invalid (e.g., based on a comparison of information in the token with respect to expected or predetermined information, such as the credentials 878 of FIG. 8). For example, credentials associated with an invitee can include a token (e.g., a virtual and/or cryptographic token, an authorization token to gain access to a VRLS event, a cryptographically or electronically signed datum, etc.) indicating a CCGB and/or an LCGB corresponding to the VRLS event. In such examples, the access determination circuitry 840 can obtain tokens associated with invitees to the VRLS event and look up location data that corresponds to and/or is associated with the token. For example, the access determination circuitry 840 can determine that the location data corresponds to a CCGB corresponding to the VRLS event.

If, at block 2004, the VRLS management circuitry 800 determines that the invitee is not authorized to enter the VRLS lobby based on the token provided by the invitee, control proceeds to block 2006. At block 2006, the VRLS management circuitry 800 determines whether a request is received from the invitee to access the VRLS lobby with a temporary token. For example, the VRLS event management circuitry 850 (FIG. 8) can issue a temporary token to the first invitee prior to, at, or after the starting of the VRLS.

If, at block 2006, the VRLS management circuitry 800 determines that a request is received from the invitee to access the VRLS lobby with a temporary token, control proceeds to block 2010. Otherwise, control proceeds to block 2008. At block 2008, the VRLS management circuitry 800 rejects the invitee based on an invalid token. For example, the VRLS event management circuitry 850 can identify the first invitee as to be denied entry to the VRLS. In some examples, the VRLS event management circuitry 850 can block the first invitee and/or place the first invitee on a block or deny entry list. After rejecting the invitee based on an invalid token at block 2006, control proceeds to block 2016.

If, at block 2004, the VRLS management circuitry 1400 determines that the invitee is authorized to enter the VRLS lobby based on the token provided by the invitee, control proceeds to block 2010. At block 2010, the VRLS management circuitry 800 determines whether the invitee is authorized to enter the VRLS lobby based on location. For example, the access determination circuitry 840 can determine whether the first client 102 is within the CCGB 134, the LCGB 136 associated with the first client 102, etc., and/or any combination(s) thereof, based on location data associated with the first client 102 of FIG. 1.

If, at block 2010, the VRLS management circuitry 800 determines that the invitee is not authorized to enter the VRLS lobby based on location (e.g., the first client 102 is outside of the CCGB 134, the LCGB 136 associated with the first client 102, etc., and/or any combination(s) thereof), control proceeds to block 2012. At block 2012, the VRLS management circuitry 800 rejects the invitee based on an invalid location. For example, the VRLS event management circuitry 850 can identify the first invitee as to be denied entry to the VRLS. In some examples, the VRLS event management circuitry 850 can block the first invitee and/or place the first invitee on a block or deny entry list. After rejecting the invitee based on an invalid location at block 2012, control proceeds to block 2016.

If, at block 2010, the VRLS management circuitry 800 determines that the invitee is authorized to enter the VRLS lobby based on location (e.g., the first client 102 is within the CCGB 134, the LCGB 136 associated with the first client 102, etc., and/or any combination(s) thereof), control proceeds to block 2014. At block 2014, the VRLS management circuitry 800 accepts the invitee to the VRLS lobby. For example, the VRLS event management circuitry 850 can identify the first invitee as to be granted entry to the VRLS. In some examples, the VRLS event management circuitry 850 can place the first invitee on an approved or valid entry list. In the example of FIG. 20, the VRLS management circuitry 800 continually executes and/or instantiates blocks 2010, 2012, and 2014 of the machine-readable instructions and/or the operations 2000 to iteratively monitor the location of invitees to the VRLS event. For example, at a first time, an invitee may be within the CCGB associated with the invitee and at a second time, the invitee may be outside of the CCGB associated with the invitee or vice versa. In such examples, if an invitee travels outside of an approved area (e.g., the CCGB, the LCGB associated with the invitee, etc., and/or any combination(s) thereof) during the VRLS event, the VRLS management circuitry 800 disconnects the invitee from the VRLS event (e.g., rejects the invitee from the VRLS event based on invalid location). Additionally or alternatively, an entity hosting the VRLS event (e.g., a theater production, a sporting event, etc.) may restrict invitees based on geographic location of the invitees (e.g., as determined by the licensing rights held by the entity hosting the theater production, the sporting event, etc.). In such examples, the VRLS management circuitry 800 disconnects invitees in non-permitted geographic locations such that the entity hosting the VRLS event can provide telemetry data to a copyright holder (e.g., a copyright holder of the theater production, the sporting event, etc.) indicating that only invitees within permitted geographic locations attended the VRLS event.

After accepting the invitee to the VRLS lobby at block 2014, control proceeds to block 2016. At block 2016, the VRLS management circuitry 800 determines whether to select another invitee to process. If, at block 2016, the VRLS management circuitry 800 determines to select another invitee to process, control returns to block 2002, otherwise the example machine-readable instructions and/or the example operations 2000 conclude. For example, the machine-readable instructions and/or the operations 2000 can return to block 1906 of FIG. 19 to reject access to a VRLS lobby to invitees whose tokens are not validated.

FIG. 21 is a block diagram of an example of components that may be present in an IoT device 2150 for implementing the techniques disclosed herein. In some examples, the IoT device 2150 may implement the VRLS management circuitry 800 of FIG. 8. The IoT device 2150 may include any combinations of the components shown in the example or referenced in the disclosure above. The components may be implemented as ICs, portions thereof, discrete electronic devices, or other modules, logic, hardware, software, firmware, or a combination thereof adapted in the IoT device 2150, or as components otherwise incorporated within a chassis of a larger system. Additionally, the block diagram of FIG. 21 is intended to depict a high-level view of components of the IoT device 2150. However, some of the components shown may be omitted, additional components may be present, and different arrangement of the components shown may occur in other implementations.

The IoT device 2150 may include processor circuitry in the form of, for example, a processor 2152, which may be a microprocessor, a multi-core processor, a multithreaded processor, an ultra-low voltage processor, an embedded processor, or other known processing elements. The processor 2152 may be a part of a system on a chip (SoC) in which the processor 2152 and other components are formed into a single integrated circuit, or a single package, such as the Edison™ or Galileo™ SoC boards from Intel. As an example, the processor 2152 may include an Intel® Architecture Core™ based processor, such as a Quark™, an Atom™, an i3, an i5, an i7, or an MCU-class processor, or another such processor available from Intel® Corporation, Santa Clara, CA. However, any number other processors may be used, such as available from Advanced Micro Devices, Inc. (AMD) of Sunnyvale, CA, a MIPS-based design from MIPS Technologies, Inc. of Sunnyvale, CA, an ARM-based design licensed from ARM Holdings, Ltd. or customer thereof, or their licensees or adopters. The processors may include units such as an A5-A14 or M1-MX processor from Apple® Inc., a Snapdragon™ processor from Qualcomm® Technologies, Inc., or an OMAP™ processor from Texas Instruments, Inc.

The processor 2152 may communicate with a system memory 2154 over an interconnect 2156 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 2158 may also couple to the processor 2152 via the interconnect 2156. In an example the storage 2158 may be implemented via a solid state disk drive (SSDD). Other devices that may be used for the storage 2158 include flash memory cards, such as SD cards, microSD cards, xD picture cards, and the like, and USB flash drives. In low power implementations, the storage 2158 may be on-die memory or registers associated with the processor 2152. However, in some examples, the storage 2158 may be implemented using a micro hard disk drive (HDD). Further, any number of new technologies may be used for the storage 2158 in addition to, or instead of, the technologies described, such resistance change memories, phase change memories, holographic memories, or chemical memories, among others.

The components may communicate over the interconnect 2156. The interconnect 2156 may include any number of technologies, including industry standard architecture (ISA), extended ISA (EISA), peripheral component interconnect (PCI), peripheral component interconnect extended (PCIx), PCI express (PCIe), or any number of other technologies. The interconnect 2156 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 2162, 2166, 2168, or 2170. Accordingly, in various examples, applicable means for communicating (e.g., receiving, transmitting, etc.) may be embodied by such communications circuitry.

The interconnect 2156 may couple the processor 2152 to a mesh transceiver 2162, for communications with other mesh devices 2164. The mesh transceiver 2162 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 2164. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 2162 may communicate using multiple standards or radios for communications at different range. For example, the IoT device 2150 may communicate with close devices, e.g., within about 10 meters, using a local transceiver based on BLE, or another low power radio, to save power. More distant mesh devices 2164, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 2166 may be included to communicate with devices or services in the cloud 2100 via local or wide area network protocols. The wireless network transceiver 2166 may be a LPWA transceiver that follows the IEEE 802.15.4, or IEEE 802.15.4g standards, among others. The IoT device 2150 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 2162 and wireless network transceiver 2166, as described herein. For example, the radio transceivers 2162 and 2166 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 2162 and 2166 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It may be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 2166, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 2168 may be included to provide a wired communication to the cloud 2100 or to other devices, such as the mesh devices 2164. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 2168 may be included to allow connect to a second network, for example, a NIC 2168 providing communications to the cloud over Ethernet, and a second NIC 2168 providing communications to other devices over another type of network.

The interconnect 2156 may couple the processor 2152 to an external interface 2170 that is used to connect external devices or subsystems. The external devices may include sensors 2172, such as accelerometers, level sensors, flow sensors, optical light sensors, camera sensors, temperature sensors, a global positioning system (GPS) sensors, pressure sensors, barometric pressure sensors, and the like. The external interface 2170 further may be used to connect the IoT device 2150 to actuators 2174, such as power switches, valve actuators, an audible sound generator, a visual warning device, and the like.

In some optional examples, various input/output (I/O) devices may be present within, or connected to, the IoT device 2150. For example, a display or other output device 2184 may be included to show information, such as sensor readings or actuator position. An input device 2186, such as a touch screen or keypad may be included to accept input. An output device 2186 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 2150.

A battery 2176 may power the IoT device 2150, although in examples in which the IoT device 2150 is mounted in a fixed location, it may have a power supply coupled to an electrical grid. The battery 2176 may be a lithium ion battery, or a metal-air battery, such as a zinc-air battery, an aluminum-air battery, a lithium-air battery, and the like.

A battery monitor/charger 2178 may be included in the IoT device 2150 to track the state of charge (SoCh) of the battery 2176. The battery monitor/charger 2178 may be used to monitor other parameters of the battery 2176 to provide failure predictions, such as the state of health (SoH) and the state of function (SoF) of the battery 2176. The battery monitor/charger 2178 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 2178 may communicate the information on the battery 2176 to the processor 2152 over the interconnect 2156. The battery monitor/charger 2178 may also include an analog-to-digital (ADC) convertor that allows the processor 2152 to directly monitor the voltage of the battery 2176 or the current flow from the battery 2176. The battery parameters may be used to determine actions that the IoT device 2150 may perform, such as transmission frequency, mesh network operation, sensing frequency, and the like.

A power block 2180, or other power supply coupled to a grid, may be coupled with the battery monitor/charger 2178 to charge the battery 2176. In some examples, the power block 2180 may be replaced with a wireless power receiver to obtain the power wirelessly, for example, through a loop antenna in the IoT device 2150. A wireless battery charging circuit, such as an LTC4020 chip from Linear Technologies of Milpitas, CA, among others, may be included in the battery monitor/charger 2178. The specific charging circuits chosen depends on the size of the battery 2176, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2158 may include instructions 2182 in the form of software, firmware, or hardware commands to implement the techniques disclosed herein. Although such instructions 2182 are shown as code blocks included in the memory 2154 and the storage 2158, it may be understood that any of the code blocks may be replaced with hardwired circuits, for example, built into an application specific integrated circuit (ASIC).

In an example, the instructions 2182 provided via the memory 2154, the storage 2158, or the processor 2152 may be embodied as a non-transitory, machine-readable medium 2160 including code to direct the processor 2152 to perform electronic operations in the IoT device 2150. The processor 2152 may access the non-transitory, machine-readable medium 2160 over the interconnect 2156. For instance, the non-transitory, machine-readable medium 2160 may be embodied by devices described for the storage 2158 of FIG. 21 or may include specific storage units such as optical disks, flash drives, or any number of other hardware devices. The non-transitory, machine-readable medium 2160 may include instructions to direct the processor 2152 to perform a specific sequence or flow of actions, for example, as described with respect to the flowchart(s) and block diagram(s) of operations and functionality described above.

Also in a specific example, the instructions 2182 on the processor 2152 (separately, or in combination with the instructions 2182 of the machine-readable medium 2160) may configure execution or operation of a trusted execution environment (TEE) 2190. In an example, the TEE 2190 operates as a protected area accessible to the processor 2152 for secure execution of instructions and secure access to data. Various implementations of the TEE 2190, and an accompanying secure area in the processor 2152 or the memory 2154 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 2150 through the TEE 2190 and the processor 2152.

FIG. 22 is a block diagram of an example processor platform 2200 structured to execute and/or instantiate the example machine-readable instructions and/or the example operations of FIGS. 15, 16, 17, 18, 19, and/or 20 to implement the VRLS management circuitry 800 of FIG. 8. The processor platform 2200 can be, for example, a server (e.g., a computer server, an edge server, a cloud server, etc.), a personal computer, a workstation, a self-learning machine (e.g., a neural network), a mobile device (e.g., a cell phone, a smart phone, a tablet such as an iPad™), an Internet appliance, a gaming console, a headset (e.g., an augmented reality (AR) headset, a virtual reality (VR) headset, etc.) or other wearable device, or any other type of computing device.

The processor platform 2200 of the illustrated example includes processor circuitry 2212. The processor circuitry 2212 of the illustrated example is hardware. For example, the processor circuitry 2212 can be implemented by one or more integrated circuits, logic circuits, FPGAs, microprocessors, CPUs, GPUs, DSPs, and/or microcontrollers from any desired family or manufacturer. The processor circuitry 2212 may be implemented by one or more semiconductor based (e.g., silicon based) devices. In this example, the processor circuitry 2212 implements the resource instantiation circuitry 820 (identified by RES INSTANT CIRCUITRY), the location determination circuitry 830 (identified by LOCATION DETER CIRCUITRY), the access determination circuitry 840 (identified by ACCESS DETER CIRCUITRY), the VRLS event management circuitry 850 (identified by VRLS EVENT MGMT CIRCUITRY), and the VRLS engagement circuitry 860 (identified by VRLS ENGAGE CIRCUITRY) of FIG. 8.

The processor circuitry 2112 of the illustrated example includes a local memory 2113 (e.g., a cache, registers, etc.). The processor circuitry 2112 of the illustrated example is in communication with a main memory including a volatile memory 2114 and a non-volatile memory 2116 by a bus 2118. In some examples, the bus 2118 may implement the bus 880 of FIG. 8. The volatile memory 2214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2216 may be implemented by flash memory and/or any other desired type of memory device. Access to the main memory 2214, 2216 of the illustrated example is controlled by a memory controller 2217.

The processor platform 2200 of the illustrated example also includes interface circuitry 2220. In this example, the interface circuitry 2220 implements the interface circuitry 810 of FIG. 8. The interface circuitry 2220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2222 are connected to the interface circuitry 2220. The input device(s) 2222 permit(s) a user to enter data and/or commands into the processor circuitry 2212. The input device(s) 2222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 2224 are also connected to the interface circuitry 2220 of the illustrated example. The output device(s) 2224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2220 of the illustrated example, thus, typically includes a graphics driver card, a graphics driver chip, and/or graphics processor circuitry such as a GPU.

The interface circuitry 2220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 2200 of the illustrated example also includes one or more mass storage devices 2228 to store software and/or data. Examples of such mass storage devices 2228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 2228 implement the datastore 870, the ML model 872, the location data 874, the VR profile(s) 876, and the credentials 878 of FIG. 8.

The machine executable instructions 2232, which may be implemented by the machine-readable instructions of FIGS. 15, 16, 17, 18, 19, and/or 20, may be stored in the mass storage device 2228, in the volatile memory 2214, in the non-volatile memory 2216, and/or on a removable non-transitory computer-readable storage medium such as a CD or DVD.

The processor platform 2200 of the illustrated example of FIG. 22 includes example acceleration circuitry 2234, which includes an example graphics processing unit (GPU) 2240, an example vision processing unit (VPU) 2242, and an example neural network processor 2244. In this example, the GPU 2240, the VPU 2242, and the neural network processor 2244 are in communication with different hardware of the processor platform 2200, such as the volatile memory 2214, the non-volatile memory 2216, etc., via the bus 2218. In this example, the neural network processor 2244 may be implemented by one or more integrated circuits, logic circuits, microprocessors, GPUs, DSPs, or controllers from any desired family or manufacturer that can be used to execute an AI model, such as a neural network, which may be implemented by the machine learning model 872. In some examples, one or more of the resource instantiation circuitry 820, the location determination circuitry 830, the access determination circuitry 840, the VRLS event management circuitry 850, and/or the VRLS engagement circuitry 860 can be implemented in or with at least one of the GPU 2240, the VPU 2242, or the neural network processor 2244 instead of or in addition to the processor circuitry 2212.

FIG. 23 is a block diagram of an example implementation of the processor 2152 of FIG. 21 and/or the processor circuitry 2212 of FIG. 22. In this example, the processor 2152 of FIG. 21 and/or the processor circuitry 2212 of FIG. 22 is implemented by a general purpose microprocessor 2300. The general purpose microprocessor circuitry 2300 executes some or all of the machine-readable instructions of the flowcharts of FIGS. 15-20 to effectively instantiate the VRLS management circuitry 800 of FIG. 8 as logic circuits to perform the operations corresponding to those machine-readable instructions. In some such examples, the VRLS management circuitry 800 of FIG. 8 is instantiated by the hardware circuits of the microprocessor 2300 in combination with the instructions. For example, the microprocessor 2300 may implement multi-core hardware circuitry such as a CPU, a DSP, a GPU, an XPU, etc. Although it may include any number of example cores 2302 (e.g., 1 core), the microprocessor 2300 of this example is a multi-core semiconductor device including N cores. The cores 2302 of the microprocessor 2300 may operate independently or may cooperate to execute machine-readable instructions. For example, machine code corresponding to a firmware program, an embedded software program, or a software program may be executed by one of the cores 2302 or may be executed by multiple ones of the cores 2302 at the same or different times. In some examples, the machine code corresponding to the firmware program, the embedded software program, or the software program is split into threads and executed in parallel by two or more of the cores 2302. The software program may correspond to a portion or all of the machine-readable instructions and/or operations represented by the flowcharts of FIGS. 15-20.

The cores 2302 may communicate by a first example bus 2304. In some examples, the first bus 2304 may implement a communication bus to effectuate communication associated with one(s) of the cores 2302. For example, the first bus 2304 may implement at least one of an Inter-Integrated Circuit (I2C) bus, a Serial Peripheral Interface (SPI) bus, a PCI bus, or a PCIe bus. Additionally or alternatively, the first bus 2304 may implement any other type of computing or electrical bus. The cores 2302 may obtain data, instructions, and/or signals from one or more external devices by example interface circuitry 2306. The cores 2302 may output data, instructions, and/or signals to the one or more external devices by the interface circuitry 2306. Although the cores 2302 of this example include example local memory 2320 (e.g., Level 1 (L1) cache that may be split into an L1 data cache and an L1 instruction cache), the microprocessor 2300 also includes example shared memory 2310 that may be shared by the cores (e.g., Level 2 (L2 cache)) for high-speed access to data and/or instructions. Data and/or instructions may be transferred (e.g., shared) by writing to and/or reading from the shared memory 2310. The local memory 2320 of each of the cores 2302 and the shared memory 2310 may be part of a hierarchy of storage devices including multiple levels of cache memory and the main memory (e.g., the main memory 2214, 2216 of FIG. 22). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2302 may be referred to as a CPU, DSP, GPU, etc., or any other type of hardware circuitry. Each core 2302 includes control unit circuitry 2314, arithmetic and logic (AL) circuitry (sometimes referred to as an ALU) 2316, a plurality of registers 2318, the L1 cache 2320, and a second example bus 2322. Other structures may be present. For example, each core 2302 may include vector unit circuitry, single instruction multiple data (SIMD) unit circuitry, load/store unit (LSU) circuitry, branch/jump unit circuitry, floating-point unit (FPU) circuitry, etc. The control unit circuitry 2314 includes semiconductor-based circuits structured to control (e.g., coordinate) data movement within the corresponding core 2302. The AL circuitry 2316 includes semiconductor-based circuits structured to perform one or more mathematic and/or logic operations on the data within the corresponding core 2302. The AL circuitry 2316 of some examples performs integer based operations. In other examples, the AL circuitry 2316 also performs floating point operations. In yet other examples, the AL circuitry 2316 may include first AL circuitry that performs integer based operations and second AL circuitry that performs floating point operations. In some examples, the AL circuitry 2316 may be referred to as an Arithmetic Logic Unit (ALU). The registers 2318 are semiconductor-based structures to store data and/or instructions such as results of one or more of the operations performed by the AL circuitry 2316 of the corresponding core 2302. For example, the registers 2318 may include vector register(s), SIMD register(s), general purpose register(s), flag register(s), segment register(s), machine specific register(s), instruction pointer register(s), control register(s), debug register(s), memory management register(s), machine check register(s), etc. The registers 2318 may be arranged in a bank as shown in FIG. 23. Alternatively, the registers 2318 may be organized in any other arrangement, format, or structure including distributed throughout the core 2302 to shorten access time. The second bus 2322 may implement at least one of an I2C bus, a SPI bus, a PCI bus, or a PCIe bus

Each core 2302 and/or, more generally, the microprocessor 2300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 24 is a block diagram of another example implementation of the processor 2152 of FIG. 21 and/or the processor circuitry 2212 of FIG. 22. In this example, the processor 2152 of FIG. 21 and/or the processor circuitry 2212 is implemented by FPGA circuitry 2400. The FPGA circuitry 2400 can be used, for example, to perform operations that could otherwise be performed by the example microprocessor 2300 of FIG. 23 executing corresponding machine-readable instructions. However, once configured, the FPGA circuitry 2400 instantiates the machine-readable instructions in hardware and, thus, can often execute the operations faster than they could be performed by a general purpose microprocessor executing the corresponding software.

More specifically, in contrast to the microprocessor 2300 of FIG. 23 described above (which is a general purpose device that may be programmed to execute some or all of the machine-readable instructions represented by the flowcharts of FIGS. 15-20 but whose interconnections and logic circuitry are fixed once fabricated), the FPGA circuitry 2400 of the example of FIG. 24 includes interconnections and logic circuitry that may be configured and/or interconnected in different ways after fabrication to instantiate, for example, some or all of the machine-readable instructions represented by the flowcharts of FIGS. 15-20. In particular, the FPGA 2400 may be thought of as an array of logic gates, interconnections, and switches. The switches can be programmed to change how the logic gates are interconnected by the interconnections, effectively forming one or more dedicated logic circuits (unless and until the FPGA circuitry 2400 is reprogrammed). The configured logic circuits enable the logic gates to cooperate in different ways to perform different operations on data received by input circuitry. Those operations may correspond to some or all of the software represented by the flowcharts of FIGS. 15-20. As such, the FPGA circuitry 2400 may be structured to effectively instantiate some or all of the machine-readable instructions of the flowcharts of FIGS. 15-20 as dedicated logic circuits to perform the operations corresponding to those software instructions in a dedicated manner analogous to an ASIC. Therefore, the FPGA circuitry 2400 may perform the operations corresponding to the some or all of the machine-readable instructions of FIGS. 15-20 faster than the general purpose microprocessor can execute the same.

In the example of FIG. 24, the FPGA circuitry 2400 is structured to be programmed (and/or reprogrammed one or more times) by an end user by a hardware description language (HDL) such as Verilog. The FPGA circuitry 2400 of FIG. 24, includes example input/output (I/O) circuitry 2402 to obtain and/or output data to/from example configuration circuitry 2404 and/or external hardware (e.g., external hardware circuitry) 2406. For example, the configuration circuitry 2404 may implement interface circuitry that may obtain machine-readable instructions to configure the FPGA circuitry 2400, or portion(s) thereof. In some such examples, the configuration circuitry 2404 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 2406 may implement the microprocessor 2300 of FIG. 23. The FPGA circuitry 2400 also includes an array of example logic gate circuitry 2408, a plurality of example configurable interconnections 2410, and example storage circuitry 2412. The logic gate circuitry 2408 and interconnections 2410 are configurable to instantiate one or more operations that may correspond to at least some of the machine-readable instructions of FIGS. 15-20 and/or other desired operations. The logic gate circuitry 2408 shown in FIG. 24 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2408 to enable configuration of the electrical structures and/or the logic gates to form circuits to perform desired operations. The logic gate circuitry 2408 may include other electrical structures such as look-up tables (LUTs), registers (e.g., flip-flops or latches), multiplexers, etc.

The interconnections 2410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2408 to program desired logic circuits.

The storage circuitry 2412 of the illustrated example is structured to store result(s) of the one or more of the operations performed by corresponding logic gates. The storage circuitry 2412 may be implemented by registers or the like. In the illustrated example, the storage circuitry 2412 is distributed amongst the logic gate circuitry 2408 to facilitate access and increase execution speed.

The example FPGA circuitry 2400 of FIG. 24 also includes example Dedicated Operations Circuitry 2414. In this example, the Dedicated Operations Circuitry 2414 includes special purpose circuitry 2416 that may be invoked to implement commonly used functions to avoid the need to program those functions in the field. Examples of such special purpose circuitry 2416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2400 may also include example general purpose programmable circuitry 2418 such as an example CPU 2420 and/or an example DSP 2422. Other general purpose programmable circuitry 2418 may additionally or alternatively be present such as a GPU, an XPU, etc., that can be programmed to perform other operations.

Although FIGS. 23 and 24 illustrate two example implementations of the processor 2152 of FIG. 21 and/or the processor circuitry 2212 of FIG. 22, many other approaches are contemplated. For example, as mentioned above, modern FPGA circuitry may include an on-board CPU, such as one or more of the example CPU 2420 of FIG. 24. Therefore, the processor 2152 of FIG. 21 and/or the processor circuitry 2212 of FIG. 22 may additionally be implemented by combining the example microprocessor 2300 of FIG. 23 and the example FPGA circuitry 2400 of FIG. 24. In some such hybrid examples, a first portion of the machine-readable instructions represented by the flowcharts of FIGS. 15-20 may be executed by one or more of the cores 2302 of FIG. 23, a second portion of the machine-readable instructions represented by the flowcharts of FIGS. 15-20 may be executed by the FPGA circuitry 2400 of FIG. 24, and/or a third portion of the machine-readable instructions represented by the flowcharts of FIGS. 15-20 may be executed by an ASIC. It should be understood that some or all of the VRLS management circuitry 800 of FIG. 8 may, thus, be instantiated at the same or different times. Some or all of the VRLS management circuitry 800 of FIG. 8 may be instantiated, for example, in one or more threads executing concurrently and/or in series. Moreover, in some examples, some or all of the VRLS management circuitry 800 of FIG. 8 may implement one or more virtual machines and/or containers executing on the microprocessor.

In some examples, the processor 2152 of FIG. 21 and/or the processor circuitry 2212 of FIG. 22 may be in one or more packages. For example, the processor circuitry 2300 of FIG. 23 and/or the FPGA circuitry 2400 of FIG. 24 may be in one or more packages. In some examples, an XPU may be implemented by the processor 2152 of FIG. 21 and/or the processor circuitry 2212 of FIG. 22, which may be in one or more packages. For example, the XPU may include a CPU in one package, a DSP in another package, a GPU in yet another package, and an FPGA in still yet another package.

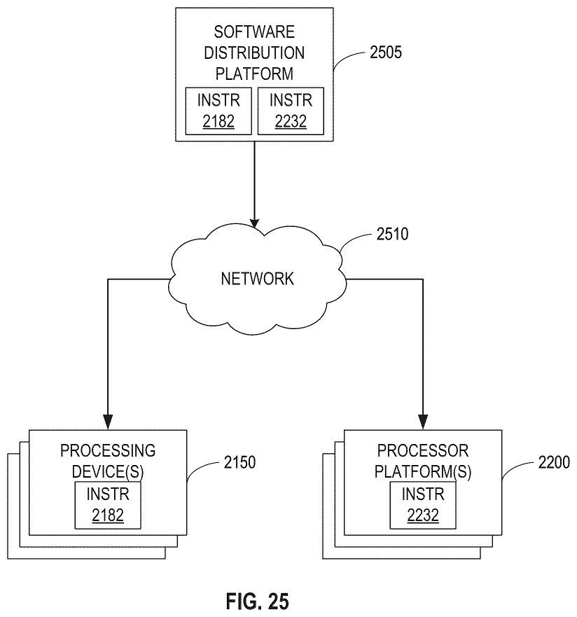

A block diagram illustrating an example software distribution platform 2505 to distribute software such as the example machine-readable instructions 2182 of FIG. 21 and/or the example machine-readable instructions 2232 of FIG. 22 to hardware devices owned and/or operated by third parties is illustrated in FIG. 25. The example software distribution platform 2505 may be implemented by any computer server, data facility, cloud service, etc., capable of storing and transmitting software to other computing devices. The third parties may be customers of the entity owning and/or operating the software distribution platform 2505. For example, the entity that owns and/or operates the software distribution platform 2505 may be a developer, a seller, and/or a licensor of software such as the example machine-readable instructions 2182 of FIG. 21 and/or the example machine-readable instructions 2232 of FIG. 22. The third parties may be consumers, users, retailers, OEMs, etc., who purchase and/or license the software for use and/or re-sale and/or sub-licensing. In the illustrated example, the software distribution platform 2505 includes one or more servers and one or more storage devices. The storage devices store the example machine-readable instructions 2182 of FIG. 21 and/or the example machine-readable instructions 2232 of FIG. 22, which may correspond to the example machine-readable instructions 1500, 1600, 1700, 1800, 1900, 2000 of FIGS. 15-20, as described above. The one or more servers of the example software distribution platform 2505 are in communication with a network 2510, which may correspond to any one or more of the Internet and/or any of the example networks 204, 206, 207, 218, 306, 408, 504, 606, 910, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the example machine-readable instructions 2182 of FIG. 21 and/or the example machine-readable instructions 2232 of FIG. 22 from the software distribution platform 2505. For example, the software, which may correspond to the example machine-readable instructions 2182 of FIG. 21, may be downloaded to the example edge/IoT processing device 2150 of FIG. 21, which is to execute the machine-readable instructions 2182 to implement the VRLS management circuitry 800 of FIG. 8. In some examples, the software, which may correspond to the example machine-readable instructions 2232 of FIG. 22, may be downloaded to the example processor platform 2200 of FIG. 22, which is to execute the machine-readable instructions 2232 to implement the VRLS management circuitry 800 of FIG. 8. In some examples, one or more servers of the software distribution platform 2505 periodically offer, transmit, and/or force updates to the software (e.g., the example machine-readable instructions 2182 of FIG. 21 and/or the example machine-readable instructions 2232 of FIG. 22) to ensure improvements, patches, updates, etc., are distributed and applied to the software at the end user devices.

From the foregoing, it will be appreciated that example systems, methods, apparatus, and articles of manufacture have been disclosed that effectuate location-aware live VR casting. Disclosed systems, methods, apparatus, and articles of manufacture improve the efficiency of using a computing and/or electronic device by utilizing high accuracy and low latency location data to determine a location of an AR/VR device. Disclosed systems, methods, apparatus, and articles of manufacture improve the efficiency of using a computing and/or electronic device by offloading authorization determinations from an edge server to a cloud server to enable the edge server to execute location-aware compute workloads, such as high accuracy and low latency location and/or position determinations of an AR/VR device. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for location-aware virtual reality are disclosed herein. Further examples and combinations thereof include the following:

Example 1 includes a method for virtual reality (VR) streaming, the method comprising determining a first location of a first VR device and a second location of a second VR device, the first location based on first location data associated with the first VR device, the second location based on second location data associated with the second VR device, identifying a preset guardian boundary corresponding to a VR live stream based on at least one of first credentials associated with the first VR device or second credentials associated with the second VR device, and after a determination that the first location and the second location satisfy the preset guardian boundary, at least one of executing or instantiating an instance of a VR live stream application associated with the VR live steam based on the first location and the second location, the first VR device and the second VR device to be associated with the VR live stream application.

Example 2 includes the method of example 1, further including associating the first VR device and the VR live stream application based on a user engaging with the first VR live stream application via the first VR device, the user associated with the first VR device.

Example 3 includes the method of any of examples 1 or 2, wherein the preset guardian boundary corresponds to a virtual boundary within which the first VR device and the second VR device are authorized to access the VR live stream.

Example 4 includes the method of any of examples 1, 2, or 3, wherein a cloud server is to perform the at least one of the executing or the instantiating of the instance of the VR live stream application, and further including transmitting the VR live stream associated with the VR live stream application from the cloud server to the first VR device and the second VR device to cause the first VR device and the second VR device to render the VR live stream.

Example 5 includes the method of any of examples 1, 2, or 3, wherein an edge server associated with the first location data and the second location data is to perform the at least one of the executing or the instantiating of the instance of the VR live stream application, and further including transmitting the VR live stream associated with the VR live stream application from the edge server to the first VR device and the second VR device to cause the first VR device and the second VR device to render the VR live stream.

Example 6 includes the method of any of examples 1, 2, 3, or 4, wherein the determination is a first determination, the instance is a first instance, and further including, after a second determination that a latency associated with transmission of the VR live stream associated with the VR live stream application from a cloud server to the first VR device satisfies a threshold identifying an edge server associated with the first location, at least one of executing or instantiating a second instance of the VR live stream application on the edge server, and transmitting the VR live stream from the edge server to the first VR device.

Example 7 includes the method of any of examples 1, 2, 3, 4, 5, or 6, wherein a data publisher is associated with the VR live stream application and a platform of the first VR device.

Example 8 includes the method of any of examples 1, 2, 3, 4, 5, or 6, wherein a first data publisher is associated with the VR live stream application and a second data publisher is associated with a platform of the first VR device, the first data publisher different from the second data publisher.

Example 9 includes the method of any of examples 1, 2, 3, 4, 5, 6, 7, or 8, further including rendering the VR live stream application on the first VR device, the VR live stream application including a virtual representation of an entirety of a body of a user associated with the first VR device.

Example 10 includes the method of any of examples 1, 2, 3, 4, 5, 6, 7, 8, or 9, wherein the first location data is determined at a first time, the determination is a first determination, and further including determining third location data associated with the first VR device at a second time after the first time, and after a second determination that the first VR device exited the preset guardian boundary based on the third location data, disconnect the first VR device from the VR live stream application.

Example 11 includes the method of example 10, further including determining fourth location data associated with the first VR device at a third time after the second time, and after a third determination that the first VR device reentered the preset guardian boundary based on the fourth location data, reconnecting the first VR device to the VR live stream application.

Example 12 includes the method of any of examples 10 or 11, wherein the first location data is determined by an edge server and the third location data is determined by a cloud server, the edge server to be closer in location proximity to the first VR device than the cloud server.

Example 13 includes the method of any of examples 1, 2, 3, 4, 5, 6, 7, 8, 9, 10, 11, or 12, wherein the first location data is time-difference-of-arrival data associated with data transmission between the first VR device and a wireless base station.

Example 14 includes the method of any of examples 1, 2, 3, 4, 5, 6, 7, 8, 9, 10, 11, or 12, wherein the first location data is round-trip-time data associated with data transmission between the first VR device and a wireless base station.

Example 15 includes the method of any of examples 1, 2, 3, 4, 5, 6, 7, 8, 9, 10, 11, or 12, wherein the first location data is angle-of-arrival data associated with data transmission between the first VR device and a wireless base station.

Example 16 includes the method of any of examples 1, 2, 3, 4, 5, 6, 7, 8, 9, 10, 11, 12, 13, 14, or 15, wherein the first credentials are associated with a virtual token.

Example 17 includes the method of any of examples 1, 2, 3, 4, 5, 6, 7, 8, 9, 10, 11, 12, 13, 14, 15, or 16, wherein the first credentials are associated with a ticket for entry to the VR live stream, the VR live stream to be rendered by the VR live stream application.

Example 18 includes the method of any of examples 1, 2, 3, 4, 5, 6, 7, 8, 9, 10, 11, 12, 13, 14, 15, 16, or 17, wherein the determination is a first determination, and further including denying access of the first VR device to the VR live stream application after a second determination that the first location does not satisfy the preset guardian boundary.

Example 19 includes the method of any of examples 1, 2, 3, 4, 5, 6, 7, 8, 9, 10, 11, 12, 13, 14, 15, 16, 17, or 18, further including obtaining guardian boundary data representative of the preset guardian boundary from a user associated with the first VR device, generating a virtual token based on data associating the first credentials and the guardian boundary data, and granting access of the first VR device to the VR live stream application based on the virtual token.

Example 20 includes the method of any of examples 1, 2, 3, 4, 5, 6, 7, 8, 9, 10, 11, 12, 13, 14, 15, 16, 17, 18, or 19, wherein the determination is a first determination, and further including after a second determination that the first VR device is not associated with a first virtual token for access to the VR live stream and a third determination that the VR live stream started, issuing a second virtual token for the access to the VR live stream, and granting access of the first VR device to the VR live stream based on the second virtual token.

Example 21 is at least one computer-readable medium comprising instructions to perform the method of any of Examples 1-20.

Example 22 is an apparatus comprising one or more virtual reality live stream managers to perform the method of any of Examples 1-20.

Example 23 is an apparatus comprising virtual reality live stream management circuitry to perform the method of any of Examples 1-20.

Example 24 is an apparatus comprising processor circuitry to perform the method of any of Examples 1-20.

Example 25 is an apparatus comprising programmable circuitry to perform the method of any of Examples 1-20.

Example 26 is an apparatus comprising edge server processor circuitry to perform the method of any of Examples 1-20.

Example 27 is an apparatus comprising edge cloud processor circuitry to perform the method of any of Examples 1-20.

Example 28 is an apparatus comprising edge node processor circuitry to perform the method of any of Examples 1-20.

Example 29 is an apparatus comprising one or more edge gateways to perform the method of any of Examples 1-20.

Example 30 is an apparatus comprising edge gateway processor circuitry to perform the method of any of Examples 1-20.

Example 31 is an apparatus comprising one or more edge switches to perform the method of any of Examples 1-20.

Example 32 is edge switch circuitry to perform the method of any of Examples 1-20.

Example 33 is an apparatus comprising at least one of one or more edge gateways or one or more edge switches to perform the method of any of Examples 1-20.

Example 34 is an XPU to perform the method of any of Examples 1-20.

Example 35 is an Infrastructure Processor Unit to perform the method of any of Examples 1-20.

Example 36 is an augmented reality headset to perform the method of any of Examples 1-20.

Example 37 is a virtual reality headset to perform the method of any of Examples 1-20.

Example 38 is an apparatus comprising accelerator circuitry to perform the method of any of Examples 1-20.

Example 39 is an apparatus comprising one or more graphics processor units to perform the method of any of Examples 1-20.

Example 40 is an apparatus comprising Artificial Intelligence processor circuitry to perform the method of any of Examples 1-20.

Example 41 is an apparatus comprising machine learning processor circuitry to perform the method of any of Examples 1-20.

Example 42 is an apparatus comprising neural network processor circuitry to perform the method of any of Examples 1-20.

Example 43 is an apparatus comprising digital signal processor circuitry to perform the method of any of Examples 1-20.

Example 44 is an apparatus comprising general purpose processor circuitry to perform the method of any of Examples 1-20.

Example 45 is an apparatus comprising network interface circuitry to perform the method of any of Examples 1-20.

Example 46 is an apparatus comprising radio unit circuitry to perform the method of any of Examples 1-20.

Example 47 is an apparatus comprising remote radio unit circuitry to perform the method of any of Examples 1-20.

Example 48 is an apparatus comprising radio access network circuitry to perform the method of any of Examples 1-20.

Example 49 is an apparatus comprising distributed unit circuitry to perform the method of any of Examples 1-20.

Example 50 is an apparatus comprising central or centralized unit circuitry to perform the method of any of Examples 1-20.

Example 51 is an apparatus comprising core server circuitry to perform the method of any of Examples 1-20.

Example 52 is an apparatus comprising satellite circuitry to perform the method of any of Examples 1-20.

Example 53 is a system comprising at least one of one more geosynchronous satellites or one or more low-earth orbit satellites to perform the method of any of Examples 1-20.

Example 54 is an apparatus comprising one or more base stations to perform the method of any of Examples 1-20.

Example 55 is an apparatus comprising base station circuitry to perform the method of any of Examples 1-20.

Example 56 is an apparatus comprising user equipment circuitry to perform the method of any of Examples 1-20.

Example 57 is an apparatus comprising one or more Internet-of-Things devices to perform the method of any of Examples 1-20.

Example 58 is an apparatus comprising one or more fog devices to perform the method of any of Examples 1-20.

Example 59 is an apparatus comprising a software distribution platform to distribute machine-readable instructions that, when executed by processor circuitry, cause the processor circuitry to perform the method of any of Examples 1-20.

Example 60 is an apparatus comprising an autonomous vehicle to perform the method of any of Examples 1-20.

Example 61 is an apparatus comprising a robot to perform the method of any of Examples 1-20.

Example 62 is an apparatus comprising processor circuitry to execute and/or instantiate instructions to implement a virtual radio access network protocol to perform the method of any of Examples 1-20.

Example 63 is an Application Programming Interface defining functions, methods, variables, data structures, and/or protocols to perform the method of any of Examples 1-20.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1.-62. (canceled)

63. An apparatus comprising:
interface circuitry to access first location data associated with a first virtual reality (VR) device and second location data associated with a second VR device;
machine-readable instructions; and
programmable circuitry to utilize the machine-readable instructions to:
determine a first location of the first VR device and a second location of the second VR device, the first location based on the first location data, the second location based on the second location data;
identify a preset guardian boundary corresponding to a VR live stream based on at least one of first credentials associated with the first VR device or second credentials associated with the second VR device; and
after a determination that the first location and the second location satisfy the preset guardian boundary, at least one of executing or instantiating an instance of a VR live stream application associated with the VR live steam based on the first location and the second location, the first VR device and the second VR device to be associated with the VR live stream application.

64. The apparatus of claim 63, wherein the programmable circuitry is to associate the first VR device and the VR live stream application based on a user engaging with the VR live stream application via the first VR device, the user associated with the first VR device.

65. The apparatus of claim 63, wherein the preset guardian boundary corresponds to a virtual boundary within which the first VR device and the second VR device are authorized to access the VR live stream.

66. The apparatus of claim 63, wherein:
the programmable circuitry is included in a cloud server; and
the interface circuitry is to transmit the VR live stream associated with the VR live stream application from the cloud server to the first VR device and the second VR device to cause the first VR device and the second VR device to render the VR live stream.

67. The apparatus of claim 63, wherein:
the programmable circuitry is included in an edge server associated with the first location data and the second location data; and
the interface circuitry is to transmit the VR live stream associated with the VR live stream application from the edge server to the first VR device and the second VR device to cause the first VR device and the second VR device to render the VR live stream.

68. The apparatus of claim 63, wherein the first location is determined at a first time, the determination is a first determination, and the programmable circuitry is to:
determine a third location of the first VR device at a second time after the first time; and
after a second determination that the first VR device exited the preset guardian boundary based on the third location, disconnect the first VR device from the VR live stream application.

69. The apparatus of claim 63, wherein the determination is a first determination, and the programmable circuitry is to:
after a second determination that the first VR device is not associated with a first virtual token for access to the VR live stream and a third determination that the VR live stream started, issue a second virtual token for the access to the VR live stream; and
grant access of the first VR device to the VR live stream based on the second virtual token.

70. A non-transitory computer readable medium comprising instruction to cause programmable circuitry to at least:
determine a first location of a first virtual reality (VR) device and a second location of a second VR device, the first location based on first location data associated with the first VR device, the second location based on second location data associated with the second VR device;
identify a preset guardian boundary corresponding to a VR live stream based on at least one of first credentials associated with the first VR device or second credentials associated with the second VR device; and
after a determination that the first location and the second location satisfy the preset guardian boundary, at least one of executing or instantiating an instance of a VR live stream application associated with the VR live steam based on the first location and the second location, the first VR device and the second VR device to be associated with the VR live stream application.

71. The computer readable medium of claim 70, wherein the instructions cause the programmable circuitry to associate the first VR device and the VR live stream application based on a user engaging with the VR live stream application via the first VR device, the user associated with the first VR device.

72. The computer readable medium of claim 70, wherein the preset guardian boundary corresponds to a virtual boundary within which the first VR device and the second VR device are authorized to access the VR live stream.

73. The computer readable medium of claim 70, wherein the programmable circuitry is included in a cloud server, and the instructions cause the programmable circuitry to cause transmission of the VR live stream associated with the VR live stream application from the cloud server to the first VR device and the second VR device to cause the first VR device and the second VR device to render the VR live stream.

74. The computer readable medium of claim 70, wherein the programmable circuitry is included in an edge server associated with the first location data and the second location data, and the instructions cause the programmable circuitry to cause transmission of the VR live stream associated with the VR live stream application from the edge server to the first VR device and the second VR device to cause the first VR device and the second VR device to render the VR live stream.

75. The computer readable medium of claim 70, wherein the first location is determined at a first time, the determination is a first determination, and the instructions cause the programmable circuitry to:
determine a third location of the first VR device at a second time after the first time; and
after a second determination that the first VR device exited the preset guardian boundary based on the third location, disconnect the first VR device from the VR live stream application.

76. The computer readable medium of claim 70, wherein the determination is a first determination, and the instructions cause the programmable circuitry to:
after a second determination that the first VR device is not associated with a first virtual token for access to the VR live stream and a third determination that the VR live stream started, issue a second virtual token for the access to the VR live stream; and
grant access of the first VR device to the VR live stream based on the second virtual token.

77. A method for virtual reality (VR) streaming, the method comprising:
determining, by executing an instruction with programmable circuitry, a first location of a first VR device and a second location of a second VR device, the first location based on first location data associated with the first VR device, the second location based on second location data associated with the second VR device;
identifying, by executing an instruction with the programmable circuitry, a preset guardian boundary corresponding to a VR live stream based on at least one of first credentials associated with the first VR device or second credentials associated with the second VR device; and
after a determination that the first location and the second location satisfy the preset guardian boundary, at least one of executing or instantiating an instance of a VR live stream application associated with the VR live steam based on the first location and the second location, the first VR device and the second VR device to be associated with the VR live stream application.

78. The method of claim 77, further including associating the first VR device and the VR live stream application based on a user engaging with the VR live stream application via the first VR device, the user associated with the first VR device.

79. The method of claim 77, wherein the preset guardian boundary corresponds to a virtual boundary within which the first VR device and the second VR device are authorized to access the VR live stream.

80. The method of claim 77, wherein a cloud server is to perform the at least one of the executing or the instantiating of the instance of the VR live stream application, and further including transmitting the VR live stream associated with the VR live stream application from the cloud server to the first VR device and the second VR device to cause the first VR device and the second VR device to render the VR live stream.

81. The method of claim 77, wherein an edge server associated with the first location data and the second location data is to perform the at least one of the executing or the instantiating of the instance of the VR live stream application, and further including transmitting the VR live stream associated with the VR live stream application from the edge server to the first VR device and the second VR device to cause the first VR device and the second VR device to render the VR live stream.

82. The method of claim 77, wherein the first location is determined at a first time, the determination is a first determination, and further including:
determining a third location of the first VR device at a second time after the first time; and
after a second determination that the first VR device exited the preset guardian boundary based on the third location, disconnecting the first VR device from the VR live stream application.
